(19) United States
(12) Patent Application Publication
(10) Pub. No.: US 2022/0402664 A1
(43) Pub. Date: Dec. 22, 2022

(54) Dispense Apparatus

(71) Applicant: Anheuser-Busch InBev sa/nv, Brussels (BE)

(72) Inventors: Lieven Frans Sylvia Dirx, Oud-Turnhout (BE); David Anthony Mason, Leicester (GB); Marc Erich Sillince, Ringwood (GB)

(21) Appl. No.: 17/350,814

(22) Filed: Jun. 17, 2021

(51) Int. Cl. B65D 47/38; B67D 3/00; B65D 51/22

(52) U.S. Cl. CPC B65D 47/38; B67D 3/0038; B65D 51/222; B65D 2251/0093; B65D 2251/0025; B65D 2251/0028

(57) ABSTRACT

According to certain embodiments, a connector for dispensing a liquid from a container comprises a main body connectable to the container and a subassembly being movable relative to the main body between an inactivated position and an activated position. The subassembly comprises inner and outer hollow piercing members. When the main body is connected to the container and the subassembly is moved from the inactivated position to the activated position, the inner hollow piercing member is arranged to pierce a seal of an inner cavity of the container, and the outer piercing member is arranged to pierce a seal of an outer cavity of the container.

### FIELD

The invention disclosed herein relates to a connector for the dispensing of liquids from a container and to an arrangement for dispensing beverage from a container. The connector acts to preserve the condition of the liquid during use of the container, for example, during and between dispenses of the liquid. The arrangement for dispensing beverage acts to promote cleanliness of the arrangement after liquid has been dispensed from the container.

### BACKGROUND

Dispensing of liquid, such as beverages like wine or beer, is increasingly desired at home. An appliance may be used to dispense liquid from a container. In such cases there is a need to preserve the liquid (e.g. beverage) in between dispenses, particularly when used in the home, where a container may be used for several dispenses over a number of days. Exposure to air can degrade the condition of such beverages and cause them to spoil quickly. Currently available systems do not provide a straightforward way of i) transporting a liquid in a container before use while minimizing its exposure to air, ii) opening the container so liquid can be dispensed whilst deterring air from reaching the liquid within the container, and iii) deterring air from reaching the liquid within the container should the container be removed from an appliance after the container has been opened and dispensing from the container has been commenced. A beverage can be contaminated by air, reducing its shelf life by altering it in a way that impacts its taste, contaminates it, or spoils it. Air can encourage bacteria and/or yeast growth, often leading to the production of acetic acid. Thus, the beverage has a limited shelf life and, once open, the user has to either drink the beverage over a short period or dispose of it lest the beverage become spoiled once it is exposed to more air upon opening.

In addition, some types of containers (and associated appliances) make use of a ‘bottle in a bottle’ structure. Currently available systems do not provide a straightforward way of i) transporting a bottle in a bottle container before use without the outer bottle being open to air, ii) opening the container so liquid in the inner bottle can be dispensed, including opening the outer bottle to atmosphere or connecting the outer bottle to a supply of pressurised fluid, and iii) maintaining the outer bottle open to atmosphere should the container be removed from an appliance after the container has been opened and dispensing from the container has been commenced. Known liquid dispensing systems also have further issues, for example, some systems operate such that more than a trivial amount of beverage is left behind in the dispensing system, outside of the container, after a dispensing operation has completed, due to limits of the system's dispensing ability. Any beverage left behind in the dispensing system, outside of the container, will be exposed to air and can therefore contaminate the dispensing system. It may also assume the temperature of the dispensing system it is in contact with and can impact the temperature of the next serving dispensed. In extreme cases, the beverage may dry and cause the dispensing system to become clogged or to operate with a reduced flow rate.

The present invention seeks to ameliorate these problems by providing a connector and beverage dispensing arrangement that can provide dispensing of a liquid from a container and deter ingress of air into the container and/or minimise the amount of liquid which remains in the beverage dispensing arrangement after dispensing operations.

### SUMMARY

According to a first aspect of the present invention, there is provided a beverage dispense connector for dispensing a beverage from a container. The connector may comprise a main body including a connection portion for connecting the main body to the container and a subassembly being movable relative to the main body between an inactivated position to an activated position. The subassembly may comprise inner and outer hollow piercing members wherein, when the main body is connected to the container via the connection portion, and when the subassembly is moved from the inactivated position to the activated position, the inner hollow piercing member may be arranged to pierce a seal of an inner cavity of the container, and, the outer piercing member may be arranged to pierce a seal of an outer cavity of the container. The piercing may be essentially simultaneous in some embodiments.

In some embodiments, the piercing members may be hollow needles. In other embodiments, the hollow piercing members may be a conduit with one or more sharp appendages to puncture a seal.

In other embodiments, the piercing members may not be hollow. Instead, the piercing member may comprise a retractable member, preferably with a sharp tip, that may puncture the seal and then be retracted within a conduit to allow fluid flow within the conduit. In other words, there may be space between the retractable piercing member and a conduit to allow fluid flow around the piercing member. In some cases, the piercing member may not retract but still be a solid piercing member within a conduit.

The use of a subassembly with inner and outer piercing members, which pierce the seals of the inner and outer cavities when the subassembly is moved to the activated position, provides a straightforward way of providing a beverage container in which both the inner and outer cavities are sealed during transport and then can be opened by the user. This is particularly the case when the connector is mounted to the container when the container is supplied to the user—no separate apparatus is required to open the inner and outer cavities.

The movement of the subassembly between the inactivated position to the activated position may be a linear movement. In other embodiments, the movement of the subassembly between the inactivated position to the activated position may be another type of movement, for example a rotational movement.

The connector may comprise a locking mechanism operable to lock the subassembly in the activated position once it has been moved from the inactivated position to the activated position. In some embodiments, one or both of the inner and outer piercing members may remain in fluid communication with the inner and outer cavities, respectively, after piercing the seals. In some cases, one or both piercing members may remain in the same position they were in upon completion of the piercing operation. In other cases, the piercing member may be further extended or retracted with respect to a fluid passageway leading to the interior of the container.

In embodiments with a locking mechanism, the locking mechanism may provide several benefits. First, once the seal of the beverage containing inner cavity has been broken, maintaining the inner piercing member in fluid communication with the interior of the inner cavity (corresponding to the activated position of the subassembly) may deter air ingress into the inner cavity via the opening in the seal of the inner cavity created by the piercing action of the inner piercing member. Secondly, maintaining the outer piercing member in fluid communication with the outer cavity (corresponding to the activated position of the subassembly) may ensure that the outer cavity of the container remains open to atmosphere. This ensures that any changes in volume of the inner cavity can be accommodated without pressure build up within the container. In some embodiments, the outer container may not be open to atmosphere but instead subject to controlled pressure levels, for example by including one or more pressure relief valves.

In some embodiments, the subassembly may be moved manually from the inactivated position to the activated position. In other embodiments, an appliance into which the container is inserted may cause the movement of the subassembly from the inactivated position to the activated position. In some embodiments, the locking mechanism may cause the subassembly to remain in the activated position even when the container is removed from an appliance to which it is connected. In other embodiments, removal of the container from the appliance may deactivate the subassembly.

As one example, the locking mechanism may comprise a latch arrangement; wherein the subassembly comprises one of i) a latch receiving portion configured, as the subassembly moves from the inactivated position to the activated position, to receive a latch arm of the main body or container; ii) or a latch arm configured, as the subassembly moves from the inactivated position to the activated position, to be received in a latch arm receiving portion of the main body or container.

In some embodiments, the inner hollow piercing member may define or be coupled to a beverage outflow conduit, suitable for conveying a beverage contained in the inner cavity of the container. A valve may be positioned between the inner cavity of the container and a dispensing end of a dispensing conduit. In some embodiments, the valve may be within the container—for example within a neck of the container. In some embodiments, the valve may be in the connector adjacent to the inlet end of a beverage outflow conduit.

In some embodiments, the valve may be positioned between the beverage outflow conduit and a dispensing end of a dispensing conduit. In other embodiments, the valve may be adjacent to the outlet end of a beverage outflow conduit. Some embodiments may have multiple valves in multiple locations. In some embodiments, the valve may be configured to selectively permit or substantially prevent fluid flow between the inner cavity of the container and the dispensing conduit.

The provision of a valve in the beverage flow path permits the flow of beverage out of the container to be controlled once the seal of the inner cavity has been pierced. In addition, in some embodiments, the provision of a valve in the beverage flow path with the valve closed, may deter or prevent air from entering the inner cavity via the beverage flow path once the seal of the inner cavity has been pierced.

In some embodiments, the valve may comprise a valve chamber and a valve member movable within the valve chamber. The valve chamber may adjoin a beverage outflow conduit fluidly connected to the inner cavity of the container and the dispensing conduit (which may be made up of one more pieces), and the valve member may be movable between: i) a closed position in which fluid flow from the beverage outflow conduit to the dispensing conduit via the valve chamber is substantially or completely prevented, and ii) an open position in which fluid flow from the beverage outflow conduit to the dispensing conduit via the valve chamber is permitted.

In some embodiments, the movement of the valve member between the closed position and the open position may be linear. In other embodiments, the movement of the valve member between the closed position and the open position may be another type of appropriate movement, for example a rotational movement.

In some embodiments, the valve may further comprise an air inlet wherein, when the valve substantially prevents fluid flow between the inner cavity of the container and the dispensing conduit, then the air inlet may be open allowing air into the dispensing conduit. When the valve permits fluid flow between the inner cavity of the container and the dispensing conduit, then the air inlet may be blocked preventing the beverage from entering the air inlet.

In such embodiments, allowing air into the dispensing conduit when the valve is closed (such that the valve substantially prevents fluid flow between the inner cavity of the container and the dispensing conduit) means that the dispensing conduit when the valve is closed includes a vent formed by the air inlet such that liquid in the dispensing conduit can drain out of the dispensing conduit without the suction effect of an unvented dispensing conduit preventing this.

Blocking the air inlet when the valve is open (such that the valve permits fluid flow between the inner cavity of the container and the dispensing conduit) deters or substantially prevents beverage from flowing out of the air inlet, which is undesirable, as any such beverage won't flow to the outlet of the dispensing conduit where it is intended to flow. In addition, blocking of the air inlet deters or substantially prevents the beverage in the inner cavity of the container from being exposed to potentially contaminating air via the air inlet.

The air inlet may adjoin the valve chamber, and wherein, when the valve member is in the closed position, the air inlet may be open allowing air into the dispensing conduit, and, when the valve member is in the closed position, the air inlet may be blocked by the valve member preventing beverage from entering the air inlet.

In some embodiments, the valve member may be biased towards the closed position and actuatable to the open position by application of an external force.

Biasing the valve member to the closed position may deter or substantially prevent, in the rest state of the valve, (a) beverage from being dispensed by the valve and (b) potentially contaminating air from coming into contact with beverage in the container.

In some embodiments, the valve member may be actuatable to the open position and the subassembly may be movable to the actuated position separately.

The seal piercing operations and beverage dispensing operations can be carried out separately.

The main body may form part of a housing that houses the subassembly. The housing may house the valve.

Locating the subassembly and the valve in the same housing (i.e. so that they are not remote from one another) means that a user (or appliance) can operate the subassembly and valve at the same place. That is to say, the user does not have to operate the subassembly when in a first place and then move to a second place, remote to the first place, to operate the valve.

The dispensing conduit may comprise: i) an inlet end adjoining the valve and arranged to receive fluid from the valve; and ii) an outlet end. At least a portion of the dispensing conduit may be movable between first and second configurations whereby a height of the outlet end relative to the inlet end may be greater in the second configuration than the first.

In such embodiments, the movement of at least a portion of the dispensing conduit between first and second configurations may be a pivoting movement. In some embodiments, movement of at least a portion of the dispensing conduit between first and second configurations may help facilitate the usage of the connector (and an attached container) with an appliance. For example, in the first configuration at least a portion of the dispensing conduit may be retracted. That is to say, in the first configuration, at least a portion of the dispensing conduit generally runs alongside the container to which the connector is mounted. This may enable the container and connector to have a relatively small form factor whilst the container and connector are being transported and/or stored. The position and orientation of the dispensing conduit, whereby at least a portion of it runs alongside the container may mean that the dispensing conduit protrudes as little as possible from the container and is therefore relatively protected from impacts and/or from catching on things. By further way of example, in the second configuration at least a portion of the dispensing conduit may be in a deployed configuration. In the deployed configuration at least a portion of the dispensing conduit may project substantially laterally from the container. By projecting laterally from the container, the spacing between the outlet of the dispensing conduit and the container is increased. This may mean, particularly when the connector and container are used in combination with an appliance, that there is more space to place a vessel (glass, cup etc.) adjacent the container (and appliance) so that liquid can be dispensed via the dispensing conduit from the outlet into the vessel.

In some embodiments, the outer hollow piercing member may define a gas inflow conduit within suitable for providing gas to the outer cavity of the container. In other embodiments, the outer piercing member may or may not be hollow. The outer piercing member may be a solid member that is retractable (or not retractable) within a conduit. In some embodiments, the piercing member may be joined to a conduit suitable for providing gas to the outer cavity of the container.

In bottle in a bottle type containers (also sometimes referred to as bag in bottle containers) it may be advantageous to provide a gas to the outer cavity—this may enable the volume of the outer cavity to change and the volume of the inner cavity to change in response, for example when liquid is dispensed from the inner cavity. In addition, or alternatively, it may enable pressurised fluid (e.g. gas) to be provided to the outer cavity. This may enable the pressure of the liquid in the inner cavity to be increased in order to facilitate easier/faster dispensing of a beverage.

According to an aspect of the present invention, there is provided a beverage dispense arrangement for selectively dispensing beverage from a container. The arrangement may comprise: i) a beverage outflow conduit configured to receive and dispense beverage from the container to a location outside of the container; ii) a dispensing conduit configured to dispense beverage, the dispensing conduit may have an outlet configured to dispense beverage from the beverage dispense arrangement; and iii) a valve may be positioned between the beverage outflow conduit and the dispensing conduit. The valve may comprise a valve chamber, and a valve member which may be movable within the valve chamber, the valve chamber fluidly connected to the beverage outflow conduit and the dispensing conduit. The valve member may be movable between: i) a closed position in which fluid flow from the beverage outflow conduit to the dispensing conduit via the valve chamber is substantially or completely prevented, and ii) an open position in which fluid flow from the beverage outflow conduit to the dispensing conduit via the valve chamber is permitted. The valve may further comprise an air inlet adjoining the valve chamber, and wherein, when the valve member is in the closed position, then the air inlet is open allowing air into the dispensing conduit, and, when the valve member is in the open position, the air inlet is blocked by the valve member preventing beverage from entering the air inlet.

In some embodiments, allowing air into the dispensing conduit when the valve member is in the closed position means that the dispensing conduit, when the valve is closed, has a vent formed by the air inlet such that liquid in the dispensing conduit can drain out of the dispensing conduit without the suction effect of an unvented dispensing conduit preventing or substantially deterring this.

In some embodiments, the beverage dispense arrangement may further comprise a housing which houses some or all of the beverage outflow conduit, some or all of the dispensing conduit and the valve.

Locating some or all of the beverage outflow conduit, some or all of the dispensing conduit and the valve in the same housing (i.e. so that they are not remote from one another) means that a user (or appliance) can operate the valve whilst being located at the same place as the beverage outflow conduit and the dispensing conduit. This means the beverage dispense arrangement can be relatively compact.

In some embodiments, the dispensing conduit may comprise a portion located between the valve and an outlet of the dispensing conduit, said portion, in use, being located at a greater height than the outlet, such that when the valve member is in the closed position and air is permitted into the dispensing conduit via the air inlet, beverage in the dispense conduit flows out of the outlet in response to gravity.

In other words, in such embodiments, the weight of the beverage will cause some or all of it remaining in the dispense conduit to drain out of the dispense channel via the outlet.

In use of such an embodiment, the outlet may be the lowest portion of the dispensing conduit such that, when the valve member is in the closed position and air is permitted into the dispensing conduit via the air inlet, substantially all the beverage in the dispensing conduit flows out of outlet in response to gravity.

In some embodiments, a siphon effect may contribute to substantially all of the beverage in the dispensing conduit flowing out of the outlet once the valve is closed and fluid flow from the container to the dispensing conduit has ceased. This is particularly helpful in situations in which, in use, the valve is located at a lesser height than the maximum height of any portion of the dispensing conduit—due to the siphon effect, even the portion of the dispensing conduit between the valve and the part of the dispensing conduit which has the maximum height may be drained of beverage partially or completely via the outlet when the valve member is in the closed position.

According to another aspect of the present invention, there is provided a kit of parts comprising a container having inner and outer cavities, each having a sealed opening; and a connector according to any of aspects described above, wherein the main body of the connector may be connected the container.

The kit of parts may comprise a container having a beverage containing cavity and a beverage dispense arrangement according to any of beverage dispense arrangements described above, wherein the beverage dispense arrangement may be mounted to the container such that the beverage outflow conduit may be placeable in fluid flow communication with a beverage containing cavity of the container.

Certain embodiments of the present disclosure provide one or more technical advantages. Certain embodiments provide a connector and beverage dispensing arrangement that can provide dispensing of a liquid from a container and deter ingress of air into the container and/or minimise the amount of liquid which remains in the beverage dispensing arrangement after dispensing operations.

Certain embodiments provide an appliance having a user interface that conveys status information associated with the appliance. The status information may be more informative than information available via existing devices and thus may improve user experience. Examples of status information include temperature information, pressure information, information indicating whether a bottle has been installed or removed, information indicating how full the bottle is, dispense information, information about the contents of the bottle, information indicating whether the appliance is open/closed or unlocked/locked, and/or current values of configuration settings.

Certain embodiments include an indicia with the bottle, such as an RFID tag, a bar code, or a QR code, or other indicia. In certain embodiments, the appliance reads the indicia associated with a bottle installed in the appliance in order to obtain information about the bottle and/or the contents. The information may be used to facilitate functionality of the appliance, such as controlling temperature based on a recommended temperature indicated by the indicia, or displaying information about the bottle or its contents to a user via a user interface.

Certain embodiments connect the appliance to a network, such as the Internet. The network connectivity may facilitate communication with a service and/or with a user device (either directly or via the service). The network connectivity may facilitate communicating status information from the appliance to the service and/or the user device, communicating current configuration settings from the appliance to the service and/or the user device, providing the appliance with updated configuration settings from the service and/or the user device, troubleshooting malfunctions of the appliance, tracking dispense information, and so on. In certain embodiments, tracking dispense information, such as information indicating which product the appliance dispensed, when the appliance dispensed the product, and/or whether the user liked the product, may be used by the service to recommend to the user when to order additional products and which products to order.

Certain embodiments provide a cooling/heating process that allows for maintaining a bottle at a configured temperature. Certain embodiments customize the temperature setting based on the contents of the bottle. For example, the temperature setting to be used for a particular bottle may be determined from information obtained from a service via a network, information configured by a user via a user interface of the appliance or via a user device connected to the network, or information read from an indicia associated with the bottle.

Certain embodiments include a support assembly that facilitates hanging a bottle within the appliance such that the bottle need not stand on its base. Hanging the bottle within the appliance may simplify dispensing liquid from the bottle because an actuator can be arranged in a manner that does not need to take into consideration stacked tolerances that would otherwise be present if the bottle were to stand on its base.

Certain embodiments may include all, some, or none of the above-described advantages. Other advantages associated with certain embodiments may be understood by those of ordinary skill in the art.

Where appropriate, any of the optional features described above in relation to one aspect of the invention may be applied to another aspect of the invention.

### BRIEF DESCRIPTION OF DRAWINGS

Embodiments according to the present invention will now be described, by way of example only, and with reference to the accompanying drawings, in which:

FIG. 1 shows a cross sectional view of a connector in accordance with an embodiment of the invention;

FIG. 2 shows a perspective view of a subassembly which forms part of the connector shown in FIG. 1;

FIG. 3 shows a cross sectional schematic view of a container to which a connector in accordance with the invention can be mounted;

FIGS. 4 to 6 show cross sectional views of the connector shown in FIG. 1 in different configurations;

FIGS. 7A and B show cross sectional views of the valve of the connector shown in FIG. 1, in closed and open configurations, respectively;

FIGS. 8 and 9 show cross sectional views of the connector, with a dispense conduit shown in first and second configurations, respectively;

FIGS. 10 A and B show a cross section of the connector rotated 90 degrees relative to the orientation shown in FIG. 1-9, FIG. 10A shows the subassembly in an inactivated position and FIG. 10B shows the subassembly in an activated position;

FIG. 11 shows an exploded perspective view of the connector assembly shown in FIG. 1;

FIGS. 12A, B and C show depictions of a dispense assembly in accordance with an embodiment of the invention including the container, connector and appliance;

FIGS. 13A and B depict a support assembly that holds the container within the appliance, in accordance with an embodiment of the invention;

FIG. 14 depicts a cooling system of the appliance in accordance with an embodiment of the invention;

FIG. 15 depicts user features of the appliance in accordance with an embodiment of the invention;

FIGS. 16A, B, and C depict an indicator indicating a temperature associated with the appliance, in accordance with an embodiment of the invention;

FIGS. 17A, B, and C depict an indicator describing contents of a container inserted in the appliance, in accordance with an embodiment of the invention;

FIGS. 18A, B, and C depict an indicator indicating fullness of a container inserted in the appliance, in accordance with an embodiment of the invention;

FIG. 19 depicts a system in accordance with an embodiment of the invention;

FIG. 20 depict an apparatus in accordance with an embodiment of the invention;

FIGS. 21-25 depict examples of information presented via a graphical user interface of a user device, in accordance with embodiments of the invention.

FIG. 26 depicts an example of dispense valve activation, in accordance with embodiments of the invention.

FIGS. 27A and B depict examples of valve components when the container is loaded in the appliance, in accordance with embodiments of the invention.

### DETAILED DESCRIPTION

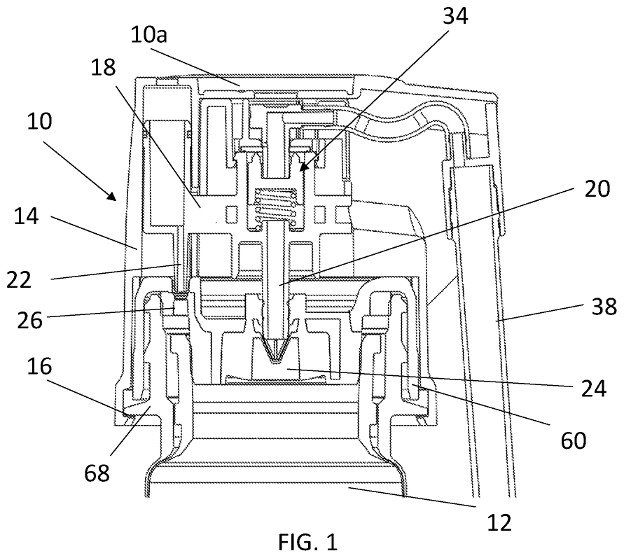

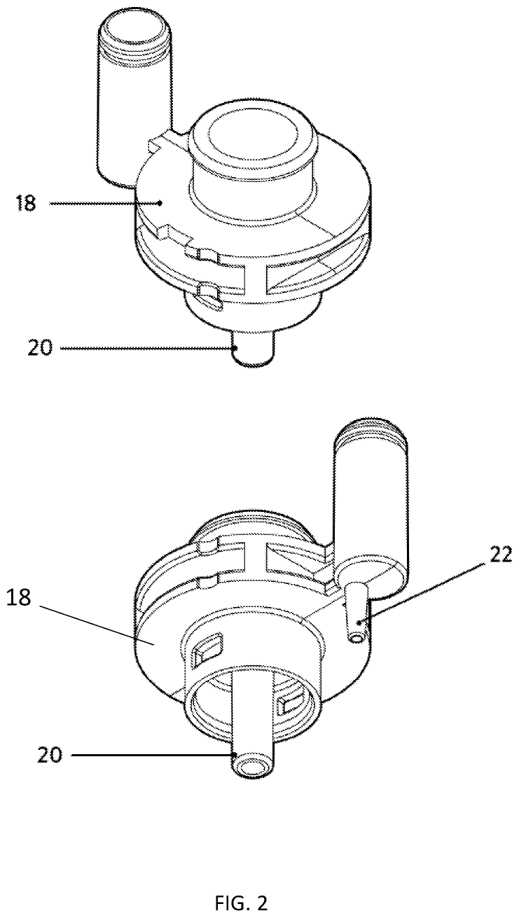

FIG. 1 shows a cross section of an example connector 10 affixed to a container 12. The connector 10 is connected to the top of the container 12. The connector 10 comprises a main body 14. Main body 14 may include a connection portion 16 for connecting the main body 14 to the container 12. Connector 10 may comprise a subassembly 18. The subassembly 18 may be partially or completely contained within the main body 14 of the connector 10. As illustrated, the subassembly 18 is completely contained within the main body 14 of the connector 10. In some embodiments, the main body 14 forms part of a housing that houses the subassembly 18. The subassembly 18 may be movable relative to the main body 14. Alternatively, in some embodiments, the subassembly 18 may remain stationary relative to the main body 14 and the main body 14 may move relative to container 12. In the illustrated embodiment, subassembly 18 comprises an inner hollow piercing member 20 and an outer hollow piercing member 22, shown in FIG. 2. The hollow piercing members 20 and 22 are substantially open-cylinder shaped (or tubular) and protrude from the subassembly 18. The hollow piercing members may be described as needles. That is to say, they may be designed to pierce something, for example, a seal.

In certain embodiments, a hollow piercing member 20, 22 may be rounded (as opposed to sharp) and the seal may be cone-shaped such that the hollow piercing member 20, 22 stretches open the cone, pushing the sides of the cone outward, when the hollow piercing member 20, 22 pushes down on the cone. Using the rounded shape for the hollow piercing member 20, 22 and the cone shape for the seal may reduce or prevent clogging of the hollow piercing member 20, 22. In other embodiments, the edges of one or both hollow piercing members may have a pointed tip analogous to certain cannulas used for medical applications. In other embodiments, the edges of one or both hollow piercing members may have a serrated edge to facilitate piercing. In some embodiments, as an alternative to the hollow piercing members 20 and 22, a solid piercing member within a conduit may be employed. For example, a piercing member could be made up of a retractable (or non-retractable) solid needle within a conduit. In some embodiments, the needle could protrude beyond the end of the conduit when extended to pierce the container 12 and then retract within the conduit after piercing. If the needle has a diameter small enough compared to the diameter of the conduit, it does not substantially impede the flow of gasses or liquids through the conduit even with the piercing member present.

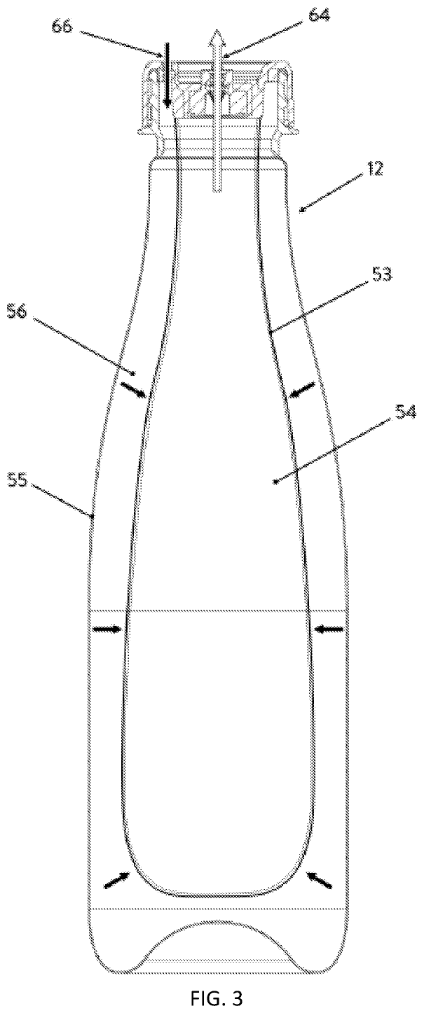

In some embodiments, the container 12 takes the form of a “bottle-in-bottle” or “bag-in-bottle” arrangement, illustrated in FIG. 3. As shown, an internal bottle 53 defines an inner cavity 54 which is compressible and an external bottle 55. The external bottle may be generally rigid. In some embodiments the external bottle is rigid when in use only and is flexible when not in use. The space between the internal and external bottles defines an outer cavity 56. It will be understood that although the term bottle is used herein, any suitable receptacle is intended. The inner cavity 54 may be suitable for holding a liquid. In general, a liquid may refer to a flowable substance. Certain liquids may be relatively free flowing, having a consistency like that of water or oil, and other liquids may be more viscous. In certain embodiments, the liquid may comprise another liquid (such as in an emulsion) and/or particulate (such as in a semiliquid, a slurry, a suspension, etc.).) Examples of a liquid include a beverage, such as wine (including without limitation sparkling wine), beer, carbonated beverages, water, juices, sweetened beverages, fruit juices, etc., or a non-beverage liquid, such as ketchup, mayonnaise, sauce, pudding, lotion, cream, unguent, oil, toothpaste, etc. The outer cavity 56 can be expanded by blowing (pumping) air or another suitable gas (or mixture of gases) into the outer cavity 56 via opening 66 (hereafter referred to as the outer opening 66) thereby causing the inner cavity 54 to compress. Other suitable gases include, for example, CO₂. When air or another suitable gas/mixture of gases is blown into the outer cavity 56, then the external bottle 55 may become substantially rigid and pressurized to a pressure above atmospheric pressure where the bottle 55 is located. Thus, when the outlet of the inner cavity (hereafter referred to as the inner opening 64) is open, fluid exits the inner cavity 54 due to the pressure acting on it from outer cavity 56 when outer cavity 56 is pressurized.

Alternatively, suction may be applied to the inner cavity in order to remove the contained beverage. In such an embodiment, the opening 66 may enable air from the atmosphere to pass into the outer cavity to enable the outer cavity to expand (when the inner cavity reduces in size).

In other embodiments (not explicitly shown), the container 12 could be a single cavity container containing liquids. In such an embodiment, gas could be supplied into the interior of the container 12 through connector 10 so as to increase the pressure inside the container. The increased pressure inside of the container 12 may force liquid into a conduit extending inside of container 12 and having an inlet preferably near the bottom of the container. Alternatively, the increased pressure could simply force liquid through an opening in the connector 10.

As shown in FIG. 1, in some embodiments the container 12 comprises a closure 60. The closure 60 may provide a seal 26 to the outer cavity 56. The closure 60 may also provide a seal 24 to the inner cavity 54 of the container 12. In the embodiment shown the main body 14 comprises a connection portion 16 for connecting to the container 12 via a Saturn ring 68. Numerous methods could be used to connect main body 14 to closure 12, including without limitation tabs connecting to a flange, a tear strip (which may facilitate dis-assembly, e.g., for recycling), or a screw ring. When the connection portion 16 is connected to the container 12 the connector 10 sits over and encloses the closure 60. The connector may have a gasket or other seal to seal the space between the interior of connector 10 and closure 60. The connection portion 16 comprises, in the illustrated embodiment, a circular flange configured to snap fit over the Saturn ring 68.

In embodiments where container 12 has a single cavity, the closure 60 may provide a seal to that single cavity. The same closure 60 may be used with such embodiments or a different closure could be used without departing from the scope of the invention.

In some embodiments, closure 60 may be made up of multiple pieces. For example, a center piece might screw into a threaded annular outer piece such that the center piece seals the inner cavity 54 and the outer piece seals the outer cavity 56.

It will be appreciated that, although in the present embodiment the connection portion is connected to the outer bottle of the container, in other embodiments the connection portion may be connected to the closure of the container.

It will also be understood that, although the present embodiment includes a closure 60 which is a separate piece which is mounted to the outer bottle of the container, in other embodiments the container 12 could be adapted to provide a seal 26 to the outer cavity 56 and a seal 24 to the inner cavity 54 of container 12 without the need for a separate closure 60. For example, the inner and outer seals may be integral with the inner and outer bottles respectively. Also, while in this embodiment, fluid passages for inner cavity 54 and outer cavity 56 pass through the top of container 12, one or multiple fluid passages for inner cavity 54 and outer cavity 56, could, alternatively or additionally, be provided through the walls of internal bottle 53 and/or external bottle 55 without departing from the scope of the invention. Such passages, could, for example, pass through the walls of the neck portion of internal bottle 53 and/or external bottle 55.

Alternatively, the seals 24 and 26 may be provided on the connector 10. In such arrangements the connector 10 may be connectable directly to the container 12, without employing a separate closure.

In the present embodiment the inner seal is provided along a central axis of the generally disk-shaped closure, but could be provide at any convenient location on closure 60 or connector 10. The outer seal 26 is typically provided radially spaced from the inner seal 24. In some embodiments, the seals could be at an equal radial distance from the center of container 12 where conduits within closure 60 lead to the different cavities within container 12. In other words, there could be a conduit within closure 60 that leads from outside closure 60 to inner cavity 54 and a separate conduit within closure 60 that leads from outside closure 60 to outer cavity 56. In this embodiment, the subassembly 18 of the connector 10 is aligned with closure. In particular, the inner and outer piercing members of the subassembly may be aligned with the seals of the inner and outer cavities. The correct rotational alignment between the outer piercing member of the connector and the seal of the outer cavity which forms part of the closure is facilitated by a poka yoke rib and groove arrangement (not shown) on the connector 10 and closure 60. In the present embodiment the rib is provided on (an inner surface of) the connector and the groove is provided on (an outer surface of) the closure. In other embodiments this may be the other way around.

In other embodiments, connector 10 may connect to container 12 via a screw-on connection. In certain embodiments, container 12 may include a ring that encircles a portion of container 12 to which connector 10 connects. The ring acts as a seal and may be made of rubber or other material that can be pierced by a piercing member. In the embodiment, the piercing member pierces any portion of the ring such that connector 10 may attach to container 12 in any orientation.

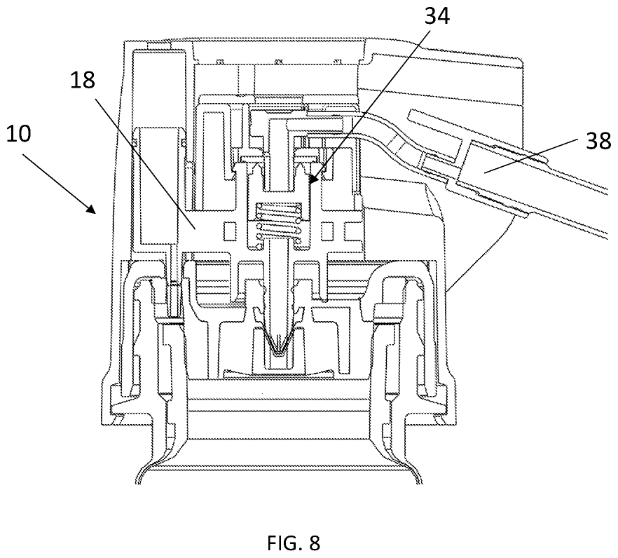

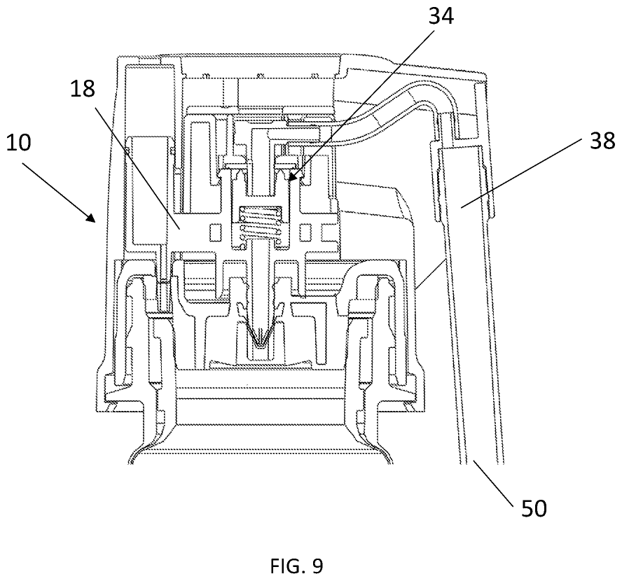

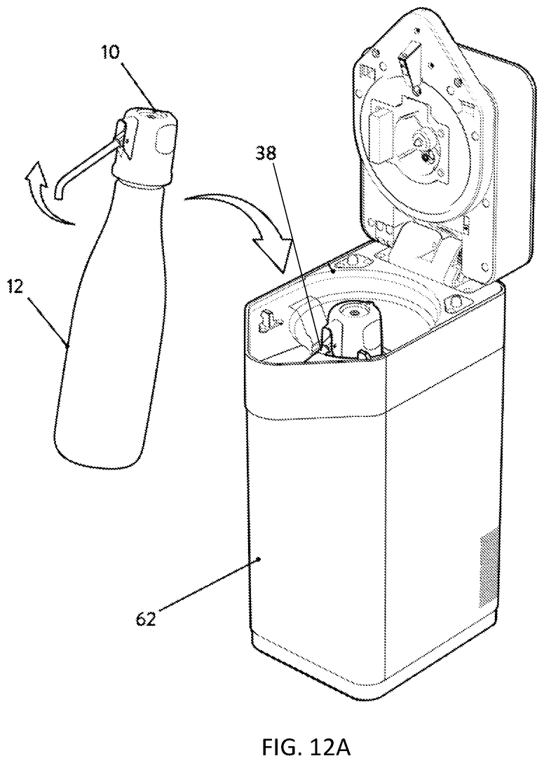

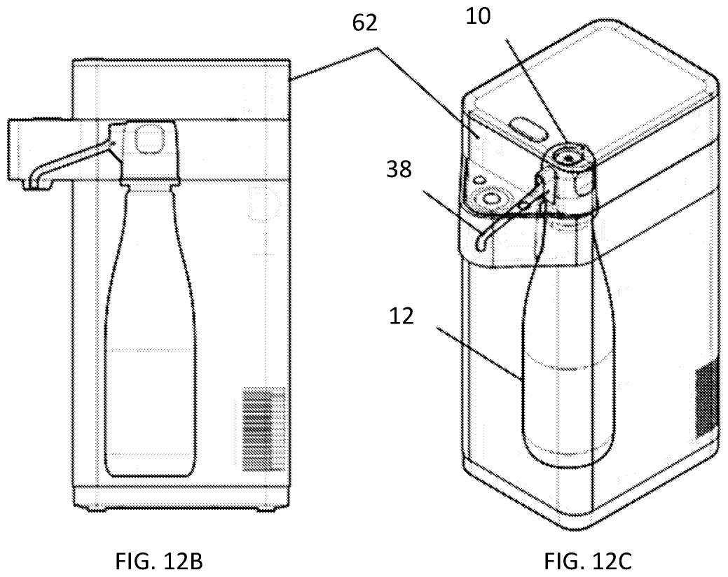

Operation of the connector 10 to allow dispensing of a liquid from the inner cavity 54 of the container 12 is hereafter described in relation to FIGS. 1 to 9. The container 12 having the connector 10 mounted to it may be insertable into or otherwise connectable to an appliance 62, shown in FIGS. 12A, B and C. The appliance 62 may be suitable for standing on a surface, for example a countertop.

When the container 12 and mounted connector 10 are initially provided to a user, the subassembly 18 of the connector 10 may be desirably in the inactivated configuration such that the seals of the inner and outer cavities (54/56) are intact. In this way, leaking of beverage from the inner cavity of the container is deterred or preferably prevented entirely. In some examples of container 10, the outer cavity 56 may contain a small amount of lubricant. This lubricant may help to facilitate the separation of the inner bottle 53 from the outer bottle 55 as the inner bottle 53 contracts due to liquid being dispensed from the inner cavity 54. In such examples of container 10, the fact that the seal of the outer cavity 56 is intact when the container is initially provided to a user means that leaking of the lubricant from the outer cavity during transport of the container is deterred or preferably prevented entirely.

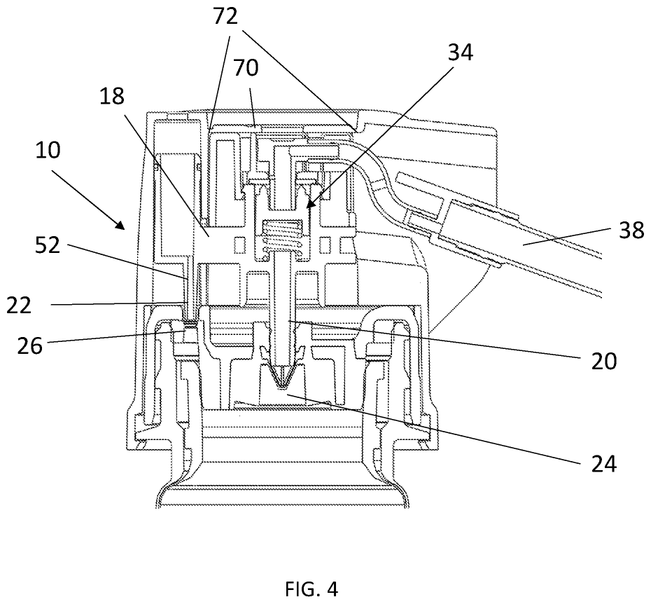

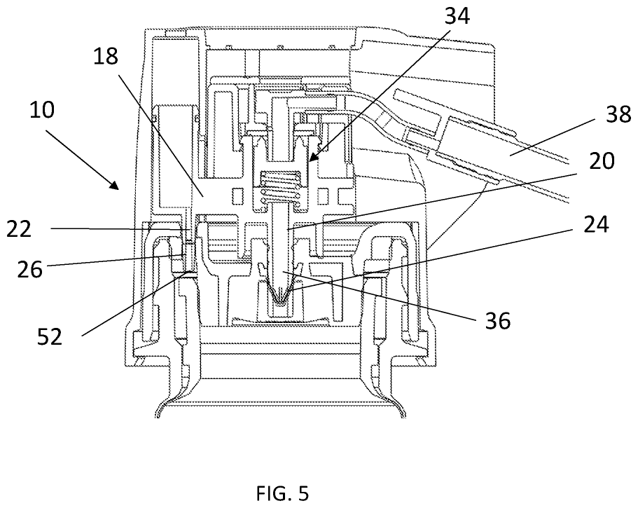

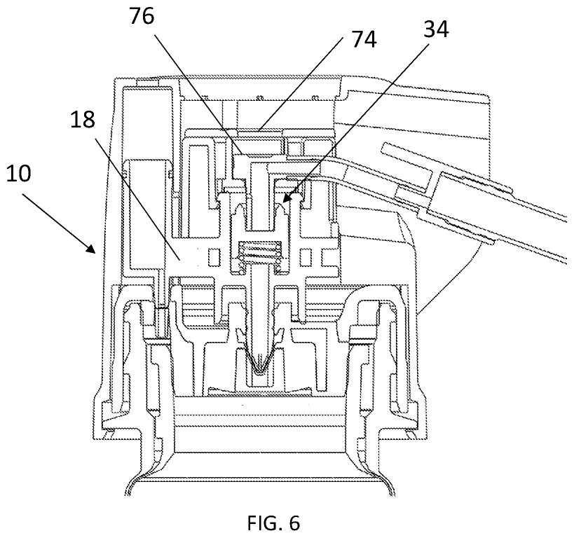

As mentioned previously, the subassembly 18 may be movable relative to the main body 14 on application of an external force. (Or, alternatively, the subassembly 18 and main body 14 may move together with connector 10). In use of the illustrated embodiment, an upper surface 10a of the connector 10 is engaged by a plunger (not shown) of a lid of the appliance 62 when the lid is closed thereby applying the external force required to move the subassembly 18. In some embodiments instead of a plunger the subassembly 18 can be actuated by other known means, for example by a pin or connecting rod, by hand, by finger, etc. It will be appreciated that the actuation can be manually initiated by the movement of the lid or by other known means. For example, the plunger can be moved using an appropriate actuator, such as a motor, after closure of the lid. Engagement of the subassembly 18 in the illustrated embodiment means it moves from an inactivated position (shown in FIGS. 1 and 4) to an activated position (shown in FIGS. 5 and 6). Movement of the subassembly 18 between the inactivated position to the activated position is a linear movement in this embodiment. In use, the linear movement of the subassembly 18 is in a generally axial direction of the container 18 to which the connector 10 is connected. Upon actuation of the subassembly 18 the hollow piercing members 20 and 22 move and pierce the two sealed 24, 26 openings to the inner and outer cavities 54, 56 of the container 12. This can occur essentially simultaneously or at slightly different times. If it is desired for the piercing members to pierce the openings at different times, the piercing members can be made of different lengths such that one pierces before the other, or the piercing members may be actuated by separate actuators (such as a first actuator that moves piercing member 20 and a second actuator that moves piercing member 22).

As shown in FIG. 5, in the illustrated embodiment, the outer hollow piercing member 22 pierces the outer cavity seal 26. The outer hollow piercing member 22 may define a gas inflow conduit 52 within, suitable for conveying gas to the outer cavity 56 of the container 12. In some embodiments, the outer hollow piercing member 22 may be removed after piercing and a conduit may be connected to create a fluid flow path to convey gas to outer cavity 56. In the illustrated embodiment, the connector 10 is configured to provide gas, such as air or CO₂, into the outer cavity 56 via the pierced outer cavity seal 26. The gas is supplied from an external source or the atmosphere. In some embodiments there is a pump in the connector 10 or a pump external to the connector (e.g. in the appliance) to provide gas under pressure to the outer cavity. In an embodiment the pump and or gas supply may be provided in the appliance 62. In other embodiments, gas may be supplied from a pressurized tank or other source of pressurized gas. When gas is pumped into the outer cavity pressure builds up between the inner and outer bottles in the container 12.

In some embodiments the upper surface 10a of the connector 10 is provided by a break-away disc 70 at the top of the connector 10. This disc 70 prevents unintended breaching of the inner cavity seal 24 for example during transport or by improper manipulation when inserting the container 12 and connector into the appliance 62. The disc comprises a central portion joined to the main body 14 by frangible arms 72. As already discussed, when the lid of the appliance 62 is closed, a plunger (not shown) of the appliance will push the central portion of the disc 70 breaking the frangible arms 72 of the disc 70 as the subassembly 18 is moved from the inactivated configuration to the activated configuration. The frangible arms 72 thus prevent actuation of the subassembly 18 until a force exceeding a pre-selected threshold is applied.

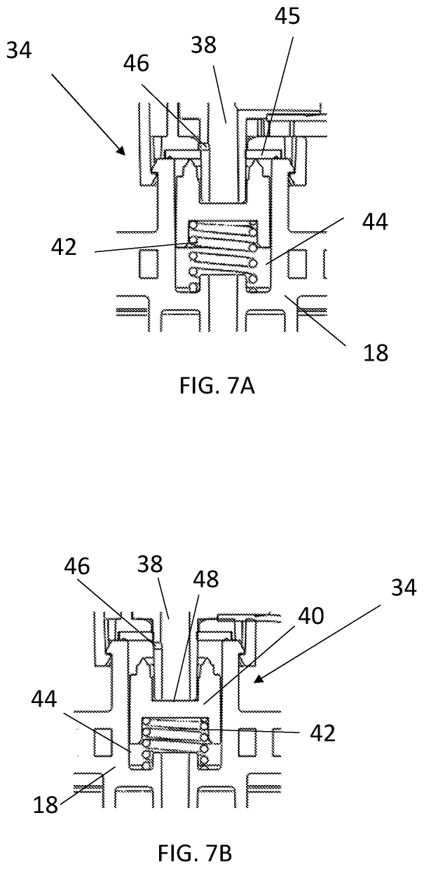

The inner hollow piercing member 22 defines a beverage outflow conduit 36 within, that is suitable for conveying a beverage contained in the inner cavity 54 of the container 12 to a dispensing conduit 38. The connector 10 further comprises a valve 34 positioned between the beverage outflow conduit 36 and the dispensing conduit 38. The valve may be directly connected to the outflow conduit 36 and/or dispensing conduit 38 or may be fluidly coupled to each through other structure creating a flow path. The valve 34 may be configured to selectively permit or substantially prevent fluid flow between the beverage outflow conduit 36 and the dispensing conduit 38, as shown in more detail in FIGS. 7A and B (FIG. 7A shows the closed configuration of the valve, corresponding to a closed position of the valve member; FIG. 7B shows the open configuration of the valve, corresponding to an open position of the valve member). In some embodiments the valve 34 is configured to allow the flow rate to gradually transition from off to on (i.e. closed to open) and vice versa. In other embodiments the valve 34 is configured such that the transition from off to on and vice versa is generally a step function.

The valve 34 ensures that, even once the inner cavity seal 24 is breached, ingress of air into the inner cavity 54 is prevented and beverage flowing to the dispensing conduit 38 via the inner opening 64 is also prevented. The dispensing conduit 38 extends from the valve to a dispensing outlet 50. The dispensing conduit 38 comprises an inlet 48 adjoining the valve 34 and arranged to receive fluid from the valve 34, and a dispensing conduit outlet 50. Note that in some embodiments, outflow conduit 36 may be integrally formed with or constitute part of valve 34.

The dispensing conduit 38 is movable between first and second configurations as shown in FIG. 1 and FIG. 4, respectively. The height of the dispensing conduit outlet 50 relative to the inlet is adjustable in the illustrated embodiment.

In an embodiment, shown in FIG. 7, the valve 34 comprises a biasing member 42 which biases the valve 34 towards the closed position and is actuatable to the open position by application of an external force which overcomes the biasing force of the biasing member 42. Thus, the valve 34 shown is spring loaded so when no force is applied it is closed. The appliance 62 may include or control an actuator (not shown) which actuates the valve 34 by moving the biasing member 42 away from a valve seal 45 and thereby opening the valve 34. With the valve 34 open, the beverage within the inner cavity 54 is permitted to flow through the inner opening 64 via the beverage outflow conduit 36 to the dispensing conduit 38. The dispensing conduit 38 has an outlet 50 where a user can place a receptacle (or vessel) to receive the dispensed beverage.

In more detail, valve 34 comprises a valve chamber 44 and a valve member 40 movable within the valve chamber 44, the valve chamber 44 adjoining the beverage outflow conduit 36 and the dispensing conduit 38, and the valve member 40 movable between: i) a closed position in which fluid flow from the beverage outflow conduit 36 to the dispensing conduit 38 via the valve chamber 44 is substantially or completely prevented, and ii) an open position in which fluid flow from the inner cavity 54 (in the illustrated embodiment via beverage outflow conduit 36) to the dispensing conduit 38 via the valve chamber 44 is permitted. The movement of the valve member 40 between the closed position and the open position is linear in the illustrated embodiment. Alternatively, the valve member may undergo rotary movement or some other type of movement to move between the closed and open positions. In a further alternative embodiment, the connector 10 may comprise a pump in place of or in addition to a valve, the pump configured to permit or block fluid flow from the inner cavity 54 to the dispensing conduit 38. Alternatively, a pump within or controlled by a dispensing device may be configured to permit or block fluid flow from the inner cavity 54 to the dispensing conduit 38.

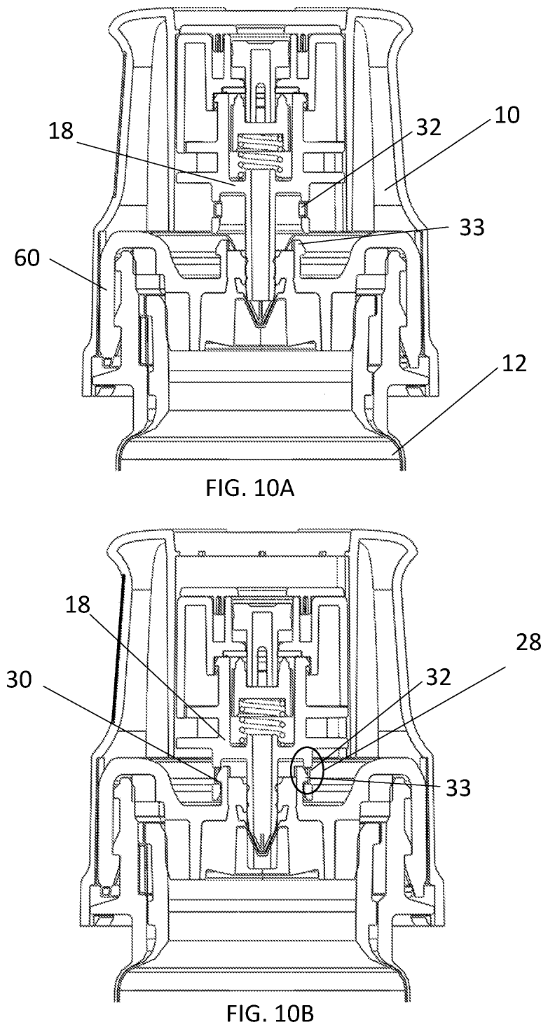

FIG. 10 shows the connector 10 of the previous figures rotated by 90 degrees. As shown the connector 12 further comprises a locking mechanism 28 operable to lock the subassembly 18 in the activated position once it has been moved from the inactivated (FIG. 10A) position to the activated position (shown in FIG. 10B). In some embodiments the locking mechanism 28 comprises a latch arrangement 30 which maintains the subassembly 18 in its activated position once closure of the appliance lid has moved the subassembly 18 (shown in FIG. 10B). This means that if the appliance lid is opened, to remove the container 12 and connector 10, the subassembly 18 may remain in the activated position. This ensures that:

i) the outer cavity seal 26 is kept open to ensure that air can move into and out of the outer cavity 56 freely. This prevents the build-up of positive or negative pressure between the bottles of the container 12, for example due to changes in temperature or ambient pressure; and

ii) the inner hollow piercing member 20 remains within the inner opening 64 to deter or prevent the ingress of air or egress of beverage via the inner opening 64.

In the present embodiment the locking mechanism 28 of the connector takes the form of a latch arrangement 30. The subassembly 18 is provided with a latch receiving portion 32 configured, as the subassembly 18 moves from the inactivated position (e.g. FIG. 10A) to the activated position (e.g. FIG. 10B), to receive a latch arm 33 of the container 12. In the present embodiment the latch receiving portion 32 takes the form of a recess which forms part of the subassembly 18 and the latch arm 33 forms part of the closure 60 of the container 12. It will be understood that in other intended embodiments the latch arm 33 and the latch arm receiving portion 32 swap positions, i.e. the latch arm 33 forms part of the subassembly 18 or main body of the connector 10 and the latch arm receiving portion 32 forms part of the container 12 or closure 60 of the container 12. The latch arm 33 and latch arm receiving portion 32 could also be formed as a generally annular protrusion and a complementary generally annular recess, respectively.

Whilst, in the present embodiment the subassembly is provided with a latch receiving portion and the closure of the container includes a latch arm, in other embodiments the subassembly 18 is provided with a latch arm configured, as the subassembly moves from the inactivated position to the activated position, to be received by a latch receiving portion of the main body or container.

In other embodiments, the subassembly 18 may remain stationary relative to the main body 14. As an example, in certain embodiments, rather than moving the subassembly 18 to create activation, activation may be created by sliding the whole connector 10 down and latching connector 10, for example, using tabs of container 12.

The use of the locking arrangement to maintain the subassembly in the activated position once the subassembly has been moved from the inactivated position to the activated position means that, should the lid of the appliance be opened and the container removed from the appliance (for example for the container to be stored in a fridge), the subassembly may remain in the activated position. This may be beneficial as it maintains the seal between the piercing members of the subassembly and the openings of the inner and outer cavities. This may keep the inner cavity 54 from being contaminated by the ingress of air, whilst simultaneously keeping the opening to the second cavity 56 open so that the pressure of the gas within the outer cavity can remain equalised with that of atmosphere.

The valve 34 is operated separately to the subassembly 18 in the illustrated embodiment. That is to say, in use, the subassembly may be moved from the inactivated position to the activated position. Subsequently, the valve can be actuated, by moving the valve member between its open and closed positions.

The connector 10 may further comprise a siphoning means for emptying the dispensing conduit 38 between uses. In an embodiment, the siphoning means comprises an air inlet 46 provided in the valve chamber 44, see FIG. 7. When the valve 34 substantially prevents or prevents fluid flow between the beverage outflow conduit 36 and the dispensing conduit 38 then the air inlet 46 is open allowing air into the dispensing conduit 38, and when the valve 34 permits fluid flow between the beverage outflow conduit 36 and the dispensing conduit 38, then the air inlet 46 is blocked deterring or completely preventing the beverage from entering the air inlet 46.

Thus, in the illustrated embodiment, the valve 34 is arranged such that, when it is in the closed position, air is permitted into the dispensing conduit 38 at the valve 34. As shown in FIG. 7 the air inlet 46 adjoins the valve chamber 34. When the valve member 40 is in the closed position, the air inlet 46 is open allowing air into the dispensing conduit 38, and, when the valve member 40 is in the closed position the air inlet 46 is blocked by the valve member 40 deterring or preventing beverage from entering the air inlet 46.

In use, the outlet may be the lowest portion of the dispensing conduit 38 such that, when the valve 34 is in the closed position and air is permitted into the dispensing conduit 38 via the air inlet 46, substantially all the beverage in the dispensing conduit 38 flows out of outlet in response to gravity.

The fact that the outlet may be the lowest portion of the dispensing conduit, means that should the fluid flow path along the dispensing conduit be non-linear between the valve and the outlet—for example, if the dispensing conduit has a generally inverted J-shaped profile—then, even if the valve is not located at the highest part of the dispense channel (i.e. there is a portion of the dispensing conduit which is at a greater height than that of the valve), nearly all or the entirety of the dispensing conduit will be evacuated of liquid.

This is due to the siphoning effect ensuring that gravity draws liquid within the dispensing conduit 38 out at the dispensing conduit outlet 50. In this way, cleanliness of the dispensing conduit 38 and dispensing conduit outlet 50 is maintained.

Various valve design options may be available for venting of the dispense tube after dispensing cycle has been completed, depending on the embodiment. A slot design in the dispense insert may be suited to certain embodiments, such as when the valve is operated quickly. For embodiments where the valve can be moved to the open position more slowly, there may be a risk of creating a bypass that can result in a leak path for liquid to pass through the opening created before the valve is fully open and before the venting slot is buried under the seal. To overcome this, certain embodiments design the air inlet as a series of cross holes in the valve stem. To prevent bypass, the diameter of each cross hole should be smaller than the seal thickness of the valve.

In some embodiments, where the main body 14 forms part of a housing that houses the subassembly 18 as discussed above, the housing also houses the valve 34. The housing houses all or a portion of the beverage outflow conduit 36 and all or a portion of the dispensing conduit 38.

The use of a valve including an air inlet as part of connector for use with a bottle in a bottle container has been described above. However, a valve of the type described above, which includes an air inlet, may form part of a beverage dispense arrangement for use with any type of beverage containing container.

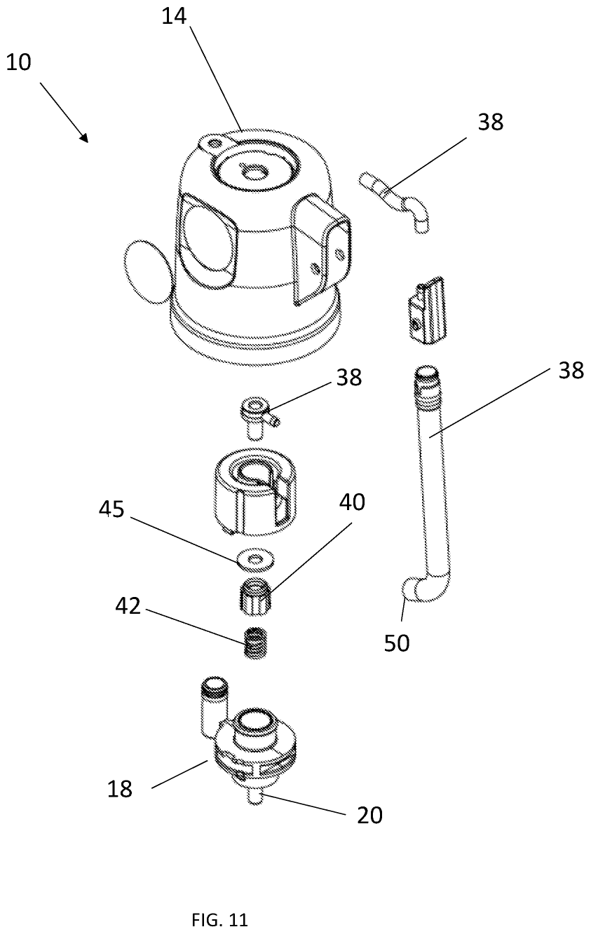

As shown in FIG. 11, in some embodiments the dispensing conduit 38 comprises a number of separate pieces, including an insert for abutting the valve 34, a flexible tube for fitting within the connector main body 14 and an elongate tube providing the dispensing conduit outlet 50.

During dispensing in the illustrated embodiment, air pressure between the bottles is increased and, in use, air is pumped to the outer cavity such that the inner bottle is held at substantially constant pressure. In some embodiments the air pressure between the bottles is maintained at approximately 24.65 psi (1.7 bar). Without the pressure within the outer cavity or the use of a pump to pump the beverage out of the inner cavity, the beverage will not be forced from the inner cavity 54 when the valve is in the open configuration. In other words, it is the difference in pressure between outer cavity 56 and ambient (atmosphere) drives flow of the beverage through the dispensing conduit 38. At each consecutive dispense air is pumped into the outer cavity 56. There will often be a hysteresis effect resulting in a small loss of pressure over time, but the range of pressure may be generally maintained at between 23-24.65 psi (1.6-1.75 bar).

As discussed previously, the inner cavity 54 of the container 12 is compressible such that it will collapse as the beverage is dispensed; allowing the majority of the beverage to be dispensed while the container is in an upright position. The neck portion of the inner cavity 54 may be stiffer than the main portion. A stiffer neck portion provides for the connection between the inner bottle and the outer bottle and, if used, the closure 60.

The dispensing by the dispensing arrangement described can be free-pour or a pre-set volume. The valve 34 may be actuated by an actuator (which moves between actuated and non-actuated states) via a mechanical connection (not shown) to the appliance 62. The mechanical connection may take the form of a prong (not shown) of the appliance, which passes through an opening 74 in the top of the connector in order to contact an actuation surface 76 of the valve and thereby actuate the valve (see FIG. 6). In this way, for a free-pour, a user can operate the appliance to thereby operate the valve for the desired dispensing volume. For dispensing of a pre-set volume of beverage, the dispensed volume of beverage may be calculated as a function of time for which the beverage flows out of the container. In other embodiments the volume of beverage dispensed is determined and/or controlled using a flow meter or other known means. In this way, the valve 34 is actuated for the calculated time period by the appliance in order to dispense the desired volume of beverage. After dispensing, the actuator of the appliance acting on the valve 34 will return to its non-actuated state to enable the spring-biased valve 34 to shut.

Modifications may be made to the above-described embodiments without departing from the scope of the present disclosure. Certain embodiments position the valve in the container and include a mechanical mechanism in the subassembly that engages the valve. Certain embodiments position the valve (or a second valve) at the outlet end of the connector. Certain embodiments control the valve electronically in order to control dispensing liquid from the container. Certain embodiments use a single-cavity container (e.g., as an alternative to a “bottle-in-bottle” or “bag-in-bottle” arrangement).

FIGS. 12A, B and C show depictions of a dispense assembly in accordance with an embodiment of the invention. As illustrated, the dispense assembly includes the container 12, connector 10, and appliance 62. FIG. 12A illustrates appliance 62 with the lid open so that container 12 may be placed within appliance 62. FIGS. 12B and C illustrate appliance 62 with the lid closed and the dispensing conduit 38 positioned so that contents of container 12 may be dispensed via an aperture of appliance 62. Certain embodiments include a gasket around the lid. The gasket seals the chamber containing container 12, for example, to help keep cool air used to chill container 12 within the chamber. Certain embodiments pressurize container 12 upon installing container 12 in appliance 62. After closing the lid, appliance 62 starts to pressurize container 12 to a pressure set point. Pressurizing container 12 may take a relatively short time for a new bottle, such as a few seconds. Pressurizing container 12 may take longer for a bottle that is already partly empty. In some embodiments, pressurization of container 12 may not take place until a later time—e.g. when a consumer desires to dispense a serving of a liquid. In certain embodiments, container 12 automatically depressurizes when opening the lid of appliance 62 (when container 12 is empty or when swapping a partially empty container 12). The air escapes automatically out of the chamber (between the two layers) of the bottle. In other embodiments, pressure may be manually released from the outer container. Depressurizing container 12 prevents a build-up of pressure so that the bottle can be stored in a hot environment, such as laid in the sun, without pressure building to a level that may damage container 12.

Certain embodiments further include one or more safe failure mechanisms that release pressure when container 12 is subject to high internal pressures, for example, due to high temperatures or impact. Different safe failure mechanisms can be included to address different types or different levels of internal pressure. One or more safe failure mechanisms may release pressure via a controlled venting mechanism inside the closure. Certain embodiments may include a first mode of pressure release that occurs when the internal pressure of container 12 exceeds a first threshold, and a second mode of pressure release that occurs when the internal pressure of container 12 exceeds a second threshold (higher than the first threshold). In certain embodiments, the first mode may be reversible (e.g., venting can be stopped once sufficient pressure has been released) and the second mode may be irreversible. In certain embodiments, the first mode of pressure release responds by doming. Due to the increasing internal pressure, a central part of the closure deforms a bit. It starts to bulge, due to the inner sealing temporarily losing contact with the inner preform. The internal pressure can then escape. The inner sealing may resume contact with the inner preform once sufficient pressure has escaped such that the doming releases. In certain embodiments, the second mode of pressure release responds by shifting. When the internal pressure gets too high and the pressure cannot sufficiently escape via doming, the closure may shift upward. The shift may be asymmetrical (e.g., one side of the closure may shift upward) or symmetrical. The shift upward causes snaps, hooks, tabs, or similar mechanism to lose contact with a contact surface, such as a lower snap fit ring. The closure moves upward to allow internal pressure to escape. In some embodiments, the closure moves upward over a limited height (e.g., to facilitate venting via certain locations where an inner and outer sealing lose contact with the bottle walls).

In certain embodiments, appliance 62 obtains an identifier associated with the container 12. For simplicity, the identifier associated with the container 12 may be referred to as the container ID. As examples, appliance 62 may obtain the container ID by reading a Radio Frequency Identification (RFID), a bar code, a Quick Response (QR) code, or other indicia associated with container 12. Or, appliance 62 may obtain the container ID from a user that enters the identifier manually via a user interface of appliance 62 or via a user device that communicates with appliance 62 over a network. Appliance 62 uses the container ID to determine information about the contents of container 12, such as a type of wine contained in container 12, properties associated with the wine, an expiration date of the wine, and so on.

In certain embodiments, container ID may be used to provide information to the user via a user interface associated with the appliance 62. In some cases, the user interface could be an electronic display and/or one or more lights such as LEDs. In some cases, the LEDs may be able to change color. In other cases, the user interface could be present on a computer, a phone, a tablet or other electronic device that communicates with the appliance 62 via a wire, wireless, and/or network connection. Information that may be provided to the user in response to the container ID may include the color of the wine, the manufacturer of the wine, the brand name of the wine, the type of wine (e.g. chardonnay), the vintage of the wine, the geographical location the grapes were grown, the recommended storage temperature of the wine recommended by the manufacturer, the expiration date of the wine, nutrition information for the wine, contact information for the manufacturer, food suggestions to with the wine, and rating information from one or more authorities that provide ratings for wine. This information can be provided via any of the user interface options discussed herein. In some embodiments, the container ID may also be associated with a manufacturing location, a manufacturing date, a lot number, etc. for purposes of tracing products in the event of a product recall. Other examples of information that may be associated with a container ID are discussed in connection with Table 1 below.

In certain embodiments, appliance 62 may use the information determined based on the container ID to determine settings to apply. For example, suppose the settings indicate to cool white wine to a temperature of 10° C. and to cool red wine to a temperature of 15° C. Appliance 62 may use the container ID to determine that container 12 contains white wine. Based on this determination, appliance 62 may cool the wine to 10° C. (the setting for white wine). The temperature setting could be a default setting for the color of wine, a default setting for the type of wine (e.g. chardonnay), a setting associated with the container ID recommended by the manufacturer, a setting chosen by the user of appliance 62 for the color of the wine, a setting chosen by the user for the type of wine, or a setting chosen by the user for the particular brand of wine.

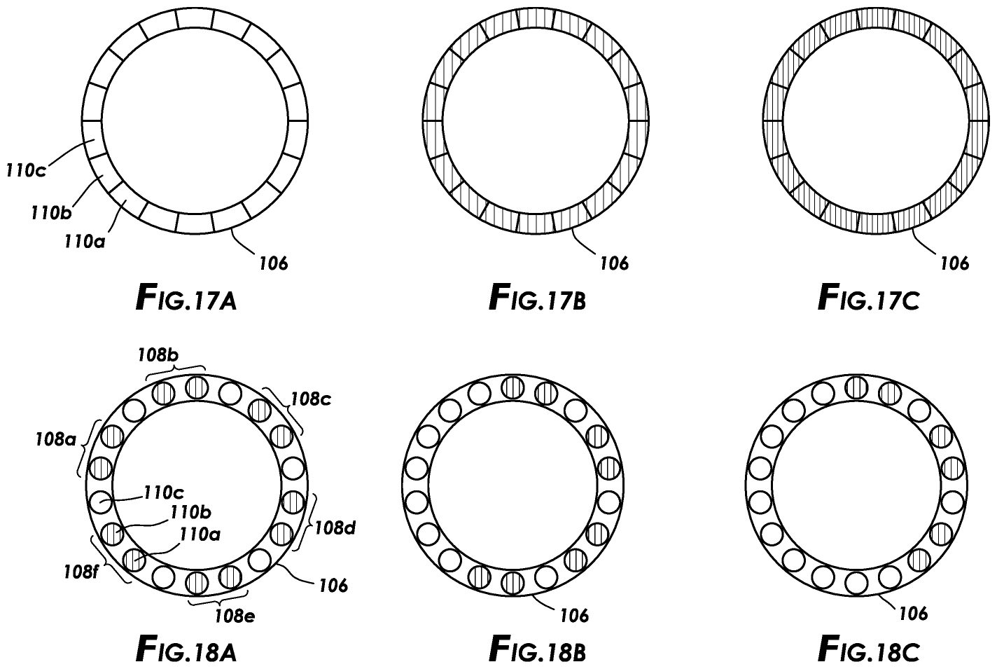

In certain embodiments, appliance 62 may use the information determined based on the container ID to indicate the information to the user. For example, appliance 62 may determine a type of wine contained in container 12 (such as white wine, rosé wine, or red wine) based on the container ID. As further described below with respect to FIGS. 17A-C, appliance 62 may display an indicator 106 that can be color-coded white for white wine, pink for rosé wine, or red for red wine.

In certain embodiments, the container ID may be used to keep track of a fullness level of container 12. As an example, appliance 62 may determine a fullness level of container 12, such as full, half-full, empty, etc. Fullness information may be stored so as to be associated with the container ID. In an embodiment where the container ID is associated with an RFID tag, the fullness information may be stored on the RFID tag. As an example, the user may insert a full container 12 of white wine in appliance 62, dispense some of the wine from container 12, such as half of the wine, and remove the half-full container 12 from appliance 62, for example, to store the white wine in the user's refrigerator while the user uses appliance 62 to dispense red wine. Appliance 62 updates the RFID tag associated with container 12 containing the white wine to indicate the fullness information. The RFID tag may be updated at any suitable time, such as at regular time intervals (e.g., every 90 seconds), in response to the user dispensing the white wine (e.g., in response to detecting a change in fullness level), or in response to the user pressing a release button (e.g., to store the fullness level immediately prior to releasing container 12 from appliance 62). When the user is ready to resume drinking the white wine, the user may insert the half-full container 12 of white wine in appliance 62, and appliance 62 may read the RFID tag associated with container 12 to determine that container 12 is half-full.

In an embodiment, fullness information may be determined (within a suitable tolerance) based on the elapsed pour time (e.g., how long appliance 62 has run a pump that dispenses liquid from container 12). For example, appliance 62 may comprise one or more pressure sensors and may monitor and control pressure based on pressure sensed by the pressure sensors. In an embodiment, appliance 62 controls an internal pressure of container 12 to approximately 1.7 bar gauge pressure when dispensing fluid from container 12. Gauge pressure is zero-referenced against ambient air pressure. Thus, gauge pressure is determined by subtracting atmospheric pressure from absolute pressure, where absolute pressure is measured with reference to an absolute (and theoretical) vacuum. As a result, an ordinary pressure gauge reading of zero does not mean there is no pressure; it simply means there is no pressure in excess of the local atmospheric pressure. By controlling the pressure, appliance 62 may control the flow rate at which appliance 62 dispenses liquid from container 12.

In an embodiment, by controlling the pump to apply consistent pressure (e.g., squeeze) container 12 the flow rate may be kept substantially constant (within a suitable tolerance). The amount of fluid dispensed may then be determined based on multiplying the flow rate (e.g., fluid dispensed per second) by the amount of dispense time (e.g., in seconds). The fullness of container 12 may then be determined by subtracting the amount of fluid dispensed from the amount of fluid that was in the container prior to dispensing. When a new (full) container 12 is inserted in appliance 62, appliance 62 may determine the amount of wine contained. In an embodiment, appliance 62 determines the amount of wine in a full container 12 based on the container ID (the container ID may be associated with information indicating the amount of wine in a full container 12, e.g., based on information from the manufacturer). In another embodiment, appliance 62 determines the amount of wine in a full container 12 based on a default value (e.g., in embodiments where appliance 62 is configured to work with containers 12 containing a standard amount of wine).

Suppose that container 12 contains 600 ml of wine when full, and suppose that appliance 62 determines that the user has dispensed 200 ml of wine. Appliance 62 may update the RFID tag to indicate that container 12 has 400 ml remaining (or that the container is ⅔ full) based on subtracting the dispensed amount (200 ml) from the initial amount (600 ml). Suppose the user later dispenses an additional 100 ml of wine. Appliance 62 may update the RFID tag to indicate that container 12 has 300 ml remaining (or that the container is ½ full) based on subtracting the additional dispensed amount (100 ml) from the previous amount (400 ml). In this manner, RFID tag may store fullness information based on a cumulative amount of dispense time. Other embodiments may determine fullness information in any other suitable manner, such as based on a flow meter measurement or a scale measurement (in other words—by measuring the weight of the container).

Although the previous example describes using an RFID tag to store fullness information, other options are possible. As one example, fullness information may be stored in memory of appliance 62. As another example, fullness information may be stored in connection with a user account, such as an account that the user registers with a service and accesses via a network using a user device. In other examples, the fullness information may be stored on a user device used to control appliance 62.

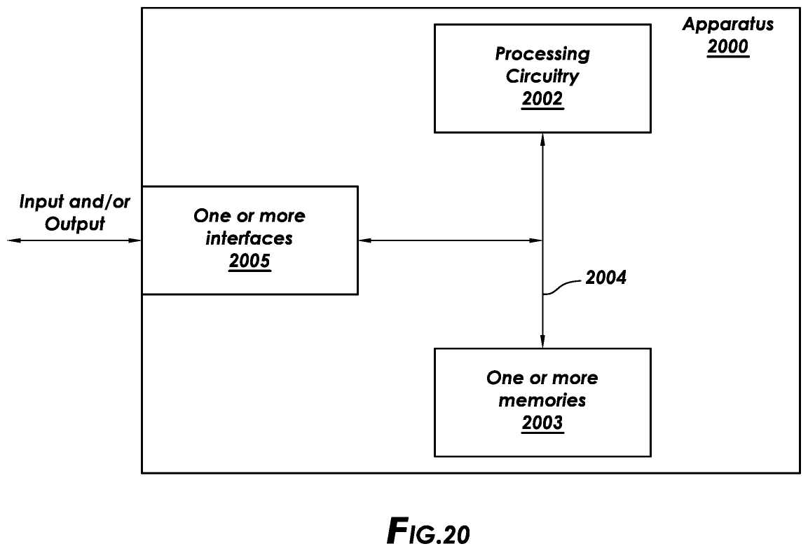

In certain embodiments, appliance 62 may use the information determined based on the container ID to facilitate tracking user consumption habits and preferences. The user consumption habits and preferences can be provided to a service 1910 (further described below with respect to FIG. 19) that can recommend when to purchase more wine (e.g., in response to appliance 62 indicating that the user is running low on a particular type of wine) and/or a type of wine to purchase (e.g., the user's consumption habits may indicate types of wines that the user enjoys).

Table 1 provides an example of information that may be stored using an RFID tag or other storage associated with container 12. Certain embodiments may include each type of information described in Table 1. Certain embodiments may omit certain types of information described in Table 1 and/or add other types of information. In certain embodiments, each piece of information may be set to a default value, for example, during a manufacturing, filling, or provisioning process associated with closure 60 or container 12. When container 12 is inserted in appliance 62, appliance 62 may use the default values, for example, until appliance 62 is able to connect to a network (e.g., the Internet) to obtain updated information. Once connected to the network, appliance 62 may obtain updated information from service 1910, the winery that filled container 12 with wine, and/or other suitable information source. If appliance 62 loses its connection with the network, appliance 62 can use the last available values stored on the RFID tag. If appliance 62 re-establishes its connection with the network, appliance 62 can check for updated information.

TABLE 1

| | Example source | |
|---|---|---|
| Information | of information | Description |
| Radio Frequency | Cloud/ | Uniquely identifies the container. |
| Identifier - Unique | Winery | |
| Identifier (RFID UID) | | |
| Closure ID | Closure | Identifies the source of the closure. |
| | Manufacturer | |
| Batch Fill ID | Cloud/ | Provides a way to link the container to |
| | Winery | filling line data from the winery. |
| Filling date | Cloud/ | Marks the date that the winery filled the |
| | Winery | container, which can be used for |
| | | calculations. |
| Product Type | Cloud/ | Indicates the product type, for example: |
| | service 1910 | 01 −> White wine; |
| | (e.g., | 02 −> Red wine. |
| | eCommerce | Certain embodiments may provide |
| | manager | more detailed product information (e.g., |
| | 1918) | label, region, varietal, vintage, etc.). |
| | | Appliance 62 can use this information |
| | | from the RFID tag to determine the |
| | | product type, for example, when there |
| | | is no Internet connection. |
| Temp | Cloud/ | Indicates a recommended temperature |
| | service 1910 | for the wine. |
| | (e.g., | Appliance 62 can use this information |
| | eCommerce | from the RFID tag to set the target |
| | manager | temperature, for example, when there |
| | 1918) | is no Internet connection. |
| Pressure level | Cloud/ | Indicates a recommended pressure for |
| | service 1910 | the wine. |
| | (e.g., | Appliance 62 can use this information |
| | eCommerce | from the RFID tag to set the pressure, |
| | manager | for example, when there is no Internet |
| | 1918) | connection. |
| Product Expiry | Cloud/ | Indicates an expiration date of the |
| | service 1910 | wine. Appliance 62 can use this |
| | (e.g., | information to indicate that the wine |
| | eCommerce | has passed its expiration date. This |
| | manager | can be determined before or after the |
| | 1918) | first dispense. Certain embodiments |
| | | calculate this date based on the filling |
| | | date and shelf-life of a closed container |
| | | (e.g., “best before” information |
| | | obtained from the winery, service 1910, |
| | | or the cloud). Other embodiments |
| | | obtain the expiration date itself from the |
| | | winery, service 1910, or the cloud |
| | | (without having to perform the |
| | | calculation). |
| Wine Staleness Date | Cloud/ | Appliance 62 can use this information |
| | Winery | to indicate that the wine has gone stale |
| | | (if beyond the wine staleness date) or a |
| | | date when the wine will go stale. |
| | | Certain embodiments determine how to |
| | | calculate this date based on whether |
| | | the calculation is run before first |
| | | connection or after first connection. |
| | | Before first connection, the calculation |
| | | may be based on a multiplying WSDL |
| | | (described below) by a factor, such as |
| | | 2. After first connection, the calculation |
| | | may be based on the date of first |
| | | connection plus WSDL. |
| Bottle Aver | Static | This information indicates whether any |
| | | wine has been dispensed from the |
| | | container. For example, the Bottle |
| | | Aver may be set to “00” to indicate |
| | | “closed” (not dispensed), and to “01” to |
| | | indicate “open” (already dispensed). |
| Wine Volume | Static −> | How much wine is left in the bottle, for |
| | calculated | example, in milliliters. |
| | | Appliance 62 can use the wine volume |
| | | information to remember how much |
| | | wine is left in the bottle if the user |
| | | removes a non-finished bottle from the |
| | | appliance 62. For example, the user |
| | | might remove the non-finished bottle |
| | | and store it in the user's refrigerator |
| | | while the user uses appliance 62 with a |
| | | different bottle/different type of wine. |
| | | If the user later puts the non-finished |
| | | bottled back in appliance 62, then |
| | | appliance 62 can continue to count- |
| | | down as the user dispenses more |
| | | wine. In this manner, appliance 62 can |
| | | predict when the bottle will be empty. |
| Dispenses | Static −> | How many dispense actions have been |
| Made | calculated | made. |
| | | If the user removes a non-finished |
| | | bottle and later places the non-finished |
| | | bottle back in appliance 62, the |
| | | dispenses made information can be |
| | | used to continue counting from where it |
| | | left off. |
| Product Type ID | Calculated | Product identifier used for eCommerce. |
| WSDL | Cloud/ | Used for calculating wine staleness |
| | service 1910 | date, for example, when no Internet is |
| | (e.g., | available. Certain embodiments may |
| | eCommerce | determine WSDL based on a |
| | manager | recommended shelf-life for an open |
| | 1918) | bottle. |

Where an RFID is used for the container ID, appliance 62 may obtain one or more pieces of information directly from the RFID. In some embodiments, appliance 62 may use the container ID information from the RFID to obtain additional information from Service 1910. In other embodiments, one or more user interfaces on a phone, computer, tablet, etc. may convey information to the user regarding the particular container based upon the container ID supplied by appliance 62 to Service 1910. Such information may or may not be provided by the Service 1910 to the appliance 62. Information associated with a container ID can similarly be obtained if the indicia on the bottle is a barcode, QR code, or other indicia. In some embodiments, appliance 62 will have a memory containing information that can be associated with a container ID (for example when the container ID is akin to a vehicle identification number that identifies things like the manufacturer, etc. because the number has codes representing certain information). In other embodiments, appliance 62 may retrieve information from Service 1910 using the container ID read from the indicia. Also, service 1910 may provide certain information to a user interface associated with the container ID read from the indicia via a phone, tablet, computer, etc. whether or not such information is provided to appliance 62.

Certain embodiments may use one or more of the identifiers (e.g., RFID UID, closure ID, batch fill ID, filling date, product type ID, and/or other identifier) to determine whether the manufacturer or winery has recalled a particular product. For example, appliance 62 may obtain one or more identifiers associated with a recall, determine whether a recall applies based on whether any of the identifiers stored on the RFID tag match any of the identifiers associated with the recall, and alert the user if a recall applies.

Certain embodiments may use one or more of the identifiers (e.g., RFID UID, a unique closure ID, and/or other unique identifier) to prevent counterfeiting. For example, if the RFID tag is missing expected identifiers, uses unexpected values for the identifiers, or uses identifiers associated with a bottle that appliance 62 determines was previously empty (indicating that the bottle was unexpectedly refilled or counterfeited), appliance 62 may be configured to alert the user and/or to not dispense wine from the bottle. Appliance 62 may determine that a particular bottle was previously empty by communicating with service 1910.

Certain embodiments may store one or more of the types of information described above in memory of appliance 62 (in addition to, or as an alternative to, storing the information on an RFID tag). As an example, in certain embodiments, appliance 62 may determine when a container 12 is inserted in appliance 62, for example, based on reading a container ID. Appliance 62 may store the container ID in memory of appliance 62. Appliance 62 may also store one or more of the types of information described above so as to be associated with the container ID. If the container 12 is removed and later re-inserted in appliance 62, appliance 62 may retrieve the information associated with container 12 from appliance 62's memory.

FIGS. 13A and B depict a support assembly that facilitates holding the container in place within appliance 62, in accordance with an embodiment of the invention. In particular, FIG. 13A illustrates an example with the support assembly disengaged, such as when the user is in the process of placing container 12 in appliance 62. FIG. 13B illustrates an example with the support assembly engaged, such as when the user has completed the process of placing container 12 in appliance 62.

For purposes of explanation, the figures depict appliance 62 as defining a chamber adapted to hold container 12. The chamber is defined in part by a plurality of outer walls, including a first outer wall 1310a and a second outer wall 1310b. A vertical axis 1312 extends through the center of the chamber. In certain embodiments, the support assembly comprises a first support 1302a and a second support 1302b. First support 1302a is depicted proximate the first outer wall 1310a (first support 1302a and first outer wall 1310a are depicted on the left side of the figure). Second support 1302b is depicted proximate the second outer wall 1310b (second support 1302b and second outer wall 1310b are depicted on the right side of the figure). First support 1302a is adapted to move relative to a first fulcrum 1304a, and second support 1302b is adapted to move relative to a second fulcrum 1304b. First support 1302a includes a first lower flange 1306a and a first upper flange 1308a. Second support 1302b includes a second lower flange 1306b and a second upper flange 1308b.

In general, the support assembly depicted in FIGS. 13A and 13B provide a retractable ledge that can support container 12 and facilitate suspension of container 12 inside of appliance 62. For example, flanges 1306a, 1306b, 1308a, and 1308b facilitate releasing container 12 when the support assembly is disengaged (as in FIG. 13A, which shows the ledge retracted) and holding container 12 in place when the support assembly is engaged (as in FIG. 13B, which shows the ledge positioned to hold container 12). As shown, in FIG. 13A, inserting container 12 into appliance 62 places downward pressure on lower flanges 1306a and 1306b. This pressure causes first support 1302a to move about its fulcrum 1304a such that first lower flange 1306a generally moves outward and first upper flange 1308a generally moves inward, as shown in FIG. 13B. In other words, when going from FIG. 13A to FIG. 13B, the first lower flange 1306a moves toward the first outer wall 1310a and away from central axis 1312, while the first upper flange 1308a moves away from first outer wall 1310a and toward central axis 1312. Similarly, the downward pressure applied to the second lower flange 1306b in FIG. 13A causes second support 1302b to move about its fulcrum 1304b such that second lower flange 1306b generally moves outward and second upper flange 1308b generally moves inward, as shown in FIG. 13B. In other words, when going from FIG. 13A to FIG. 13B, the second lower flange 1306b moves toward the second outer wall 1310b and away from the central axis 1312, while the second upper flange 1308b moves away from the second outer wall 1310b and toward central axis 1312. In FIG. 13B, lower flanges 1306a and 1306b contact a lower portion of container 12 to help hold container 12 in place, and upper flanges 1308a and 1308b grab the neck of container 12 and/or the base of connector 10 to support container 12.

In certain embodiments, upper flanges 1308a and 1308b may comprise one or more tabs 1314. Tabs 1314 may facilitate gripping container 12 and/or connector 10.

In certain embodiments, the support assembly facilitates hanging container 12 within appliance 62 such that container 12 need not stand on its base. Hanging container 12 within appliance 62 may facilitate dispensing liquid from container 12. For example, if container 12 were to stand on its base, stacked tolerances would need to be taken into consideration to address changes to the size of container 12 in response to pressure changes applied by appliance 62. By contrast, when hanging the container 12, the distance between an activation plunger of appliance 62 and connector 10 stays constant (the distance does not change if container 12 does not quite conform to a specified size or if container 12 changes size due to pressure changes applied by appliance 62). In certain embodiments container 12 (or its connector 10) comprises a protrusion that is sturdy/rigid enough to support the weight of container 12, and the support assembly of appliance 62 contacts the protrusion to provide a stable platform for suspending container 12. Thus, depressing the activation plunger of appliance 62 allows for liquid to be dispensed without dislodging container 12 from the support assembly. In the embodiment shown in FIG. 13B, the bottom of connector 10 protrudes away from the container 12 so as to create a lip (such as a ring around the bottom of connector 10) that can be used to suspend container 12. Alternatively, container 12 could be formed with a flange (such as a flange that protrudes from the neck of container 12) to support container 12 when hanging container 12 inside of appliance 62.

Other embodiments may include other types of support structures (other than supports 1302a and/or 1302b) in order to suspend container 12 within appliance 62. In certain embodiments, the support structure may comprise another type of retractable ledge that can support container 12 and facilitate suspension of container 12 inside of appliance 62. Examples include a solenoid, one or more spring-loaded tabs, or levers that extend and retract the ledge. Although the example in FIGS. 13A-B depict the ledge as comprising two opposing semi-circular shaped members, other embodiments may use other ledge shapes (which may comprise one or more members) without departing from the scope of the invention. In certain embodiments, the ledge may have an outer extending wall, or multiple sections of wall, above the ledge that help to engage the bottle and keep it in position.

In other embodiments, the support structure may be stationary without departing from the scope of the invention. For example, in certain embodiments, appliance 62 may comprise a slot or fork structure that container 12 slides into in order to be suspended within the chamber. For example, appliance 62 may include a front door or side door that a user may open and laterally slide container 12 into the slot or fork structure. In certain embodiments, the front door or side door may be hinged at the bottom of appliance 62 and may partially open (e.g., open to 45 degrees) so that container 12 may be inserted in a slant position and slid into the support assembly by closing the front door or side door. Other embodiments may comprise any other suitable support structure adapted to suspend a pressurized container 12 from a connector 19 that supports the weight of container 12, wherein suspending container 12 from the support structure facilitates dispensing liquid from the container 12.

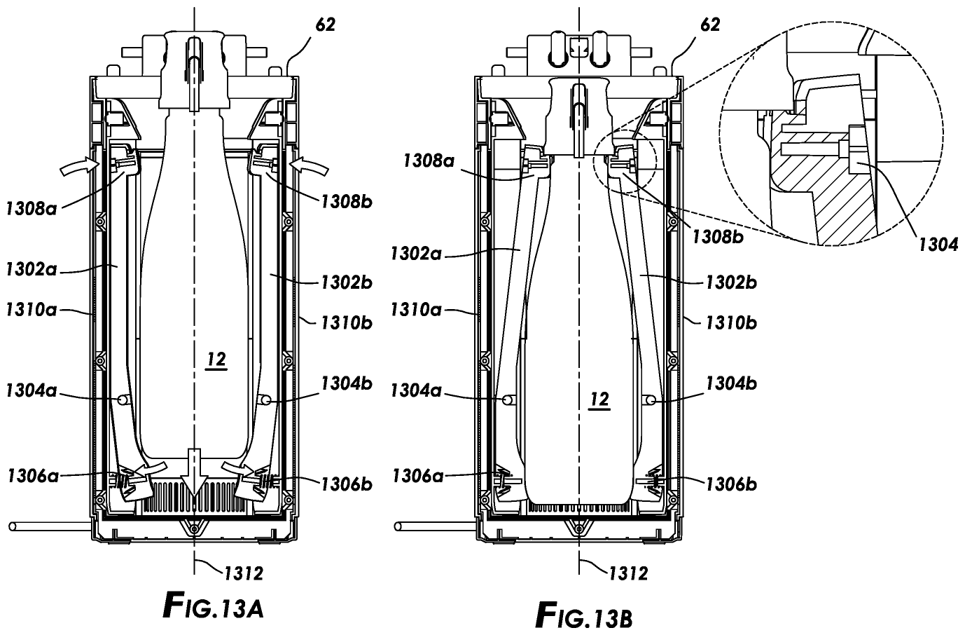

FIG. 14 depicts a cooling system of the appliance 62 in accordance with an embodiment of the invention. In certain embodiments, appliance 62 comprises a cooling element 1402 that facilitates heat exchange between a cold element 1403 (e.g., cold block and/or cold plate) and container 12 (through surface contact with container 12 and/or by cooling the surrounding air within the chamber of appliance 62 that is adapted to hold container 12). As an example, cooling element 1402 may comprise a Peltier cooler, a heat pump, a heat exchanger, and/or other cooling/heating element. In certain embodiments, cooling element 1402 (such as a Peltier cooler) transfers heat from the side of cooling element 1402 that faces container 12 to the side of cooling element 1402 that faces a heat sink 1408. Cooling element 1402 creates heat flux from container 12 towards the heat sink 1408 and pumps heat from container 12 to the heatsink 1408. The cold side of cooling element 1402 connects to a cold element 1403 (such as a cold plate and/or cold block, e.g., with fins). The hot side of cooling element 1402 connects to the heat sink (1408). Cooling element 1402 can act as a cooling element or a heating element without departing from the scope of the invention. Thus, appliance 62 may either heat or cool container 12. Moreover, cooling element 1402 may be a made up of two or more individually actuatable/controllable cooling elements (such as a Peltier cooler) to provide different rates of heating or cooling.

In certain embodiments, cooling element 1402 provides thermoelectric cooling using a solid-state active heat pump that, with consumption of electrical energy, transfers heat from one side of the device to the other, for example, depending on the direction of the current. Such a device may make use of the Peltier effect to create a heat flux, and may be referred to as a Peltier device, Peltier cooler, Peltier heater, Peltier heat pump, thermoelectric heat pump, solid state refrigerator, thermoelectric cooler (TEC), and/or a thermoelectric battery. The device may comprise two different types of materials and may create the heat flux at the junction of the two different types of materials. Certain embodiments use a DC electric current flow through the device to bring heat from one side of the device to the other, so that one side gets cooler while the other gets hotter. Thus, the device may be used either for heating or for cooling. It may also be used as a temperature controller that either heats or cools. In an embodiment, the “hot” side is attached to a heat sink so that it remains at ambient temperature, while the cool side goes below room temperature. In some cases, multiple coolers can be cascaded together for lower temperature, however, the overall efficiency of a refrigeration cycle is ultimately limited by the difference between the desired (cold side) and ambient (hot side) temperature (the temperature of the heat sink). The higher the temperature difference (delta), the lower the maximum theoretical coefficient of performance (COP).

In certain embodiments (not shown), cooling element 1402, such as a Peltier device, directly contacts the surface of container 12 in order to cool container 12. In other embodiments, cooling element 1402 may cool a cold element 1403 that may be positioned between cooling element 1402 and container 12. As an example, cold element 1403 may comprise a cold plate that makes direct contact with container 12 and/or a cold block. In FIG. 14, the cold block portion of cold element 1403 is shown between cooling element 1402 and the cold plate portion of cold element 1403. The cold plate creates a large contact surface with container 12. The cold plate may be curved to get a better and larger contact with container 12. The cold block acts as a bridge between the cold plate and the cooling element 1402. Cold element 1403 may comprise fins, for example, in the cold block portion, the cold plate portion, or both. Air passes through the fins by forced convection. When passing by these fins, heat from warm air transfers to the fins (heat exchange), and the heat is pumped by the cooling element 1402 to the heat sink 1408. The heat sink 1408 gives away its heat to the colder outside air.

In certain embodiments, cold element 1403 introduces cool air into the chamber at point A. A fan 1404 provides air circulation 1406 of the cool air through the chamber. Air circulation 1406 may pass around the top portion of container 12 (including, for example, around the connector so that the first dispense is cool), the sides of container 12, and/or the bottom of container 12. Heat transfer from container 12 being cooled heats the air circulating in the chamber. The heated air returns to cold element 1403 at point B, where the air is cooled and heat is rejected via a heatsink 1408 and heatsink fan 1410 that exhausts heat to the ambient air outside of appliance 62. To facilitate air circulation 1406, cold element 1403 may comprise a channel (a separate chamber apart from the chamber that container 12 sits in) through which air flows. Fan 1404 creates a forced convection of air over the fins of cold element 1403, forcing the air to go over the fins. Warm air goes into cold element 1403 at point B and gives its heat to the cold fins. Cold air is created at point A. With fan 1404, the air is sucked out of the channel portion of cold element 1403 and forced over container 12. When cold air passes container 12, container 12 will give its heat to the cold air (heat exchange), so the air is heated up and becomes warm again. That warm air is then sucked in the channel portion of cold element 1403 (at point B) to get cooled down again.

In certain embodiments, appliance 62 may increase cooling by reducing the temperature of cooling element 1402 and/or increasing the fan speed of fan 1404, and appliance 62 may decrease cooling by increasing the temperature of cooling element 1402 and/or decreasing the fan speed of fan 1404. In certain embodiments, appliance may control cooling by cycling the cooling element 1402 on (to increase cooling) and off (to decrease cooling).

In certain embodiments, appliance 62 comprises temperature sensors 1412 surrounding the chamber. Examples of temperature sensors 1412 may include thermometers, thermistors, etc. In an embodiment, appliance 62 may include one or more temperature sensors that sense the temperature of the air within the chamber (such as temperature sensors 1412a and 1412b depicted in FIG. 14) and/or one or more temperature sensors that contact container 12 and sense the temperature of container 12 (such as temperature sensor 1412c depicted in FIG. 14). In certain embodiments, temperature sensor 1412c may be a sprung surface contact sensor adapted to measure the surface temperature of container 12. In general, a sprung surface contact sensor moves via a spring to contact a surface of container 12 when a container 12 is inserted in appliance 62. A sprung surface contact sensor may be mounted on a sprung arm. Prior to inserting container 12 in appliance 62, the sprung arm may be in an extended position. When container 12 is inserted in appliance 62, the sprung arm adjusts position (due to compression of a spring) to remain in contact with container 12's surface at its largest diameter (e.g., for a cylindrical surface). Additionally, certain embodiments may include a temperature sensor 1412 outside of the chamber in order to sense the ambient temperature. Ambient temperature can be used to help predict cooling time as well as to determine whether to increase or decrease the power provided to the cooling system.

Temperature sensors 1412 may be used to determine temperature information associated with the chamber (e.g., based on information from temperature sensors 1412a and/or 1412b) and/or container 12 (e.g., based on information from temperature sensor 1412c). Temperature sensors 1412 may be used for one or more purposes. One purpose of temperature sensors 1412 may include determining whether a problem has occurred with the cooling system. As an example, if the temperature sensors 1412 report the same temperature over a period of time during which the cooling system has been cooling, it may indicate that a problem with the cooling system. As another example, if temperature sensors 1412A and 1412B report different temperatures (and the difference is not within a tolerance), it may indicate a problem with air circulation in the chamber, which may indicate a problem with fan 1404.

Another purpose of one or more of the temperature sensors 1412 (temperature sensor 1412a, 1412b, and/or 1412c) may be to provide temperature information that appliance 62 uses when controlling the cooling system. For example, appliance 62 may increase cooling if the temperature information indicates that the temperature associated with chamber and/or container 12 exceeds a threshold, and appliance 62 may decrease cooling if the temperature information indicates that the temperature associated with chamber and/or container 12 falls below a threshold. The threshold(s) may be based on a target temperature, such as 10° C. or 15° C. for chilled wine. Certain embodiments customize the target temperature based on the particular wine. For example, appliance 62 may be configured with a target temperature for white wine and a target temperature for red wine. The target temperature may be further customized based on input from the user or based on information indicated by the container ID (e.g., the container ID may be associated with the user's temperature preferences or a target temperature that a wine expert recommends for a particular wine).

Another purpose of one or more of the temperature sensors 1412 (temperature sensor 1412a, 1412b, and/or 1412c) may be to provide temperature information that appliance 62 uses when determining an estimated cooling (or heating) time required to reach a target temperature. The following describes an example algorithm in which appliance 62 predicts an estimated cooling (or heating) time to reach a target temperature based at least in part on information obtained from one or more contact sensors. For purposes of the example, a contact sensor refers to a temperature sensor 1412 that contacts a surface of container 12 when container 12 is inserted in appliance 62 (such as a temperature sensor 1412c).

Certain embodiments for determining the estimated cooling (or heating) time required to reach the target temperature may begin with obtaining the target temperature. The target temperature may be obtained in any suitable manner. In certain embodiments, appliance 62 obtains a target temperature that has been stored so as to be associated with container 12. The target temperature may be stored in any suitable location, such as in memory of appliance 62, on a tag (e.g., RFID tag) or other memory coupled to container 12 and read by appliance 62, or on a network from which appliance 62 may retrieve the target temperature. Certain embodiments may store the target temperature in multiple locations, for example, to facilitate user's ability to view and change the target temperature or as backup in the event that the target temperature cannot be obtained from one of the locations. The target temperature may be associated with the container 12 in any suitable manner. As an example, the target temperature may be read directly from a tag (e.g., RFID tag) or other memory coupled to container 12. As another example, the target temperature may be associated with a unique identifier of the container 12, and appliance 62 may use the unique identifier to retrieve the target temperature from local memory or from a network. As another example, the target temperature may be associated with a particular type of wine such that appliance 12 may determine the type of wine in container 12 (e.g., based on reading an RFID tag, in an embodiment) and may use the type of wine to lookup the target temperature in local memory or retrieve the target temperature via a network. The type of wine may be described at any suitable level of granularity, such as broadly (red or white), or narrowly (some combination of color, region, varietal, vintage, label, and/or other details).

The target temperature may be based on a default value, such as a value recommended by a manufacturer or wine expert, or the target temperature may be configured by the user. As an example, the user may configure the target temperature via software running on a user device, such as user device 1902 described with respect to FIG. 19. As another example, the user may configure the target temperature by interacting with buttons, touchscreen menus, or other controls that may be included on a user interface of appliance 62.

Continuing with the description of the example algorithm for determining the estimated cooling (or heating) time to reach the target temperature, when container 12 is initially inserted in appliance 62 and the lid closed, appliance 62 records the current temperature from the contact sensor. Initially, the temperature sensed by the contact sensor corresponds to the air temperature within the chamber (as opposed to the surface temperature of container 12), because the contact sensor requires time to acclimate to the surface temperature of container 12. As an example, the chamber may be pre-cooled and the bottle may be at room temperature when first inserted in the chamber. The contact sensor will take time to acclimate to the warmer bottle temperature. As another example, the chamber may be ambient temperature (if pre-cooling is not used), and the bottle may be chilled (if it has been stored in a refrigerator). The contact sensor will take time to acclimate to the cooler bottle temperature. In some cases, the initial chamber temperature and the initial container 12 temperature may be relatively similar, so the contact sensor may acclimate relatively quickly. This can occur when the chamber has been pre-cooled and container 12 has been stored in a refrigerator, such that the initial chamber temperature and the initial container 12 temperature are both cool. Or, this can occur with the chamber has not been pre-cooled and container 12 has not been stored in a refrigerator, such that the initial chamber temperature and the initial container 12 temperature are both approximately ambient temperature.

Appliance 62 monitors the initial rate of change of the contact sensor as it acclimates to the surface temperature of container 12. Appliance 62 observes the changes in the measurements reported by the contact sensor over x duration (a duration that may be determined based on one or more predefined rules) before activating the cooling (or heating) system. This allows the appliance 62 to obtain more accurate information about the surface temperature of container 12, which in turn allows appliance 62 to make a more accurate determination whether to activate cooling, activate heating, or neither (temperature control may not yet be needed if container 12 is currently at the target temperature, within a tolerance). The value of x duration may vary, for example, depending on the target temperature, the current temperature of the container 12, and/or the current temperature of the chamber. In some cases, the value of x duration may be less than a minute, and in other cases the value of x duration may be several minutes. The value of x duration may also vary depending upon how full container 12 is and/or what the overall capacity of container 12 is.

Appliance 62 determines whether to initiate cooling or heating based on monitoring the contact sensor. Various scenarios are possible, for example, depending on the target temperature, the current temperature of the container 12, and/or the current temperature of the chamber. Examples of rules for determining when to activate cooling/heating (in other words, rules for determining the value of x duration) include the following:
If the initial temperature of the contact sensor is warmer than the target temperature, and the contact sensor becomes even warmer as it acclimates to the surface temperature of container 12, appliance 62 initiates cooling. Because the temperature of the contact sensor is moving away from the target temperature, appliance 62 recognizes that cooling will be needed and can initiate cooling fairly quickly (within a few seconds to a minute), without having to wait for the contact sensor to fully acclimate to the surface temperature of container 12. Or, as an alternative, certain embodiments simply hold off from heating if the initial temperature of the contact sensor is warmer than the target temperature, and the contact sensor becomes even warmer as it acclimates to the surface temperature of container 12.
Similarly, if the initial temperature of the contact sensor is cooler than the target temperature, and the contact sensor becomes even cooler as it acclimates to the surface temperature of container 12, appliance 62 initiates heating. Because the temperature of the contact sensor is moving away from the target temperature, appliance 62 recognizes that heating will be needed and can initiate heating fairly quickly (within a few seconds to a minute), without having to wait for the contact sensor to fully acclimate to the surface temperature of container 12. Or, as an alternative, certain embodiments simply hold off from cooling if the initial temperature of the contact sensor is cooler than the target temperature, and the contact sensor becomes even cooler as it acclimates to the surface temperature of container 12.
If the initial temperature of the contact sensor is warmer than the target temperature, and the contact sensor becomes cooler as it acclimates to the surface temperature of container 12, appliance may wait until a rate change of the temperature sensed by the contact sensor approaches zero before determining whether heating or cooling is needed. When the rate change approaches zero, it means that the contact sensor is substantially acclimated to the surface temperature of container 12, so the measurement from the contact sensor is sufficiently accurate to determine whether to initiate heating or cooling. This determination may be made fairly quickly in some cases, such as in less than a minute if the surface temperature of container 12 and the chamber temperature are about the same. This determination may take longer in other cases, such as a few minutes if the surface temperature of container 12 and the chamber temperature are far apart. Note that if the temperature measured by the contact sensor passes/overshoots the target temperature before the rate change approaches zero, it means the surface temperature of container 12 is cooler than the target temperature and heating can be initiated without having to wait for the rate change to approach zero.
Similarly, if the initial temperature of the contact sensor is cooler than the target temperature, and the contact sensor becomes warmer as it acclimates to the surface temperature of container 12, appliance may wait until a rate change of the temperature sensed by the contact sensor approaches zero before determining whether heating or cooling is needed. Note that if the temperature measured by the contact sensor passes/overshoots the target temperature before the rate change approaches zero, it means the surface temperature of container 12 is warmer than the target temperature and cooling can be initiated without having to wait for the rate change to approach zero.

By observing the contact sensor as it acclimates to the surface temperature of container 12 before initiating the cooling or heating, appliance 62 can more accurately determine whether cooling mode or heating mode is needed. This avoids using the wrong mode, which in turn avoids subjecting the wine to unnecessary temperature changes that may affect the flavor or shelf-life of the wine.

For purposes of the example, suppose that appliance 62 determines that cooling is required based on the current surface temperature of container 12 being warmer than the target temperature. Once the contact sensor has acclimated to the surface temperature of container 12 (e.g., as may be indicated by the rate of temperature change approaching zero), the estimated cooling time may be determined. Certain embodiments determine the estimated cooling time based at least in part on the current surface temperature of container 12 and the target temperature. For example, the current surface temperature of container 12 and the target temperature may be input as variables to a formula that determines the estimated cooling time to reach the target temperature. Certain embodiments base the formula on trend curves observed under various test conditions. In certain embodiments, the test conditions used to determine the trend curves may also be based on further variables, such as ambient temperature, air temperature in the chamber (e.g., based on measurements from temperature sensors 1412a and/or 1412b), fullness level of container 12 (the fullness may affect cooling time because air and liquid have different thermal properties), elapsed cooling time (how long the appliance has been running), rate of temperature change, and/or other suitable variables.

In certain embodiments, appliance 62 selects one of a plurality of formulas to use for calculating the estimated cooling time, for example, based on determining the trend curve for which the variables used to obtain the trend curve have values that most closely match the values of the current variables. The trend curves may be determined experimentally for containers have a particular quantity of liquid by testing different ambient temperatures and container starting temperatures. As an example, suppose the current surface temperature of container 12 is 23° C., the ambient temperature is 26° C., and the target temperature is 16° C. Using the trend curves of Table 2 below as an example, appliance 62 would select trend curve (curve J) and would use the formula associated with trend curve J to determine the estimated cooling time.

TABLE 2

| Trend Curve/ | Surface Temp. | Ambient Temp. | Target Temp. |
|---|---|---|---|
| Formula | (° C.) | (° C.) | (° C.) |
| A | 24 | 27 | 18 |
| B | 24 | 27 | 16 |
| C | 24 | 26 | 18 |
| D | 24 | 26 | 16 |
| E | 24 | 25 | 18 |
| F | 24 | 25 | 16 |
| G | 23 | 27 | 18 |
| H | 23 | 27 | 16 |
| I | 23 | 26 | 18 |
| J | 23 | 26 | 16 |
| K | 23 | 25 | 18 |
| L | 23 | 25 | 16 |
| M | 22 | 27 | 18 |
| N | 22 | 27 | 16 |
| O | 22 | 26 | 18 |
| P | 22 | 26 | 16 |
| Q | 22 | 25 | 18 |
| R | 22 | 25 | 16 |
| . . . | . . . | . . . | . . . |

Although Table 2 illustrates an example in which the trend curve variables include surface temperature of container 12 (e.g., as measured by the contact sensor), ambient temperature (e.g., as measured by an ambient temperature sensor of appliance 62), and target temperature, other embodiments may include fewer variables (e.g., certain embodiments omit ambient temperature) and/or additional variables (e.g., certain embodiments add chamber air temperature, fullness level of container 12, elapsed cooling time (how long the appliance has been running), rate of temperature change, and/or other suitable variables.

Although Table 2 illustrates examples in which the variables are varied in increments of 1° C., other embodiments may use different increments, such as 0.1° C., 0.5° C., 2° C., 3° C., or other suitable increment. Additionally, the increments can be the same or different for different types of variables. Similarly, certain embodiments may include trend curves for variable values higher and/or variable values lower than those shown in Table 2. For example, certain embodiments provide trend curves with variable values having a lower bound of 0° C. and an upper bound of 100° C. for any of the temperature variables (e.g., surface temperature, ambient temperature, target temperature). Other embodiments may use different lower bound and upper bound values (and the bounds used for one variable may be the same or different than the bounds used for another variable).

In certain embodiments, the trend curves may be updated based on machine learning. For example, each time appliance 62 runs the cooling or heating system, appliance 62 may provide a machine learning model with information, such as surface temperature of container 12, target temperature, ambient temperature, and/or values for other variables at a start time, at an end time when the target temperature was reached, and at intermediate times between the start time and the end time. The machine learning model may learn how appliance 62 performs overtime in order to update the trend curves. The updated trend curves may be used in determining updated formulas which may be used to determine estimated cooling time when similar conditions occur in the future.

In certain embodiments, an elapsed cooling time (how long the chamber has been cooling) can affect how long it takes to cool container 12 to the target temperature. Different trend curve options may be generated to take the elapsed cooling time into consideration. For example, in an embodiment, a container 12 that has been cooled from 25 degrees to 15 degrees may require less time to cool an additional 5 degrees, to reach a target temperature of 10 degrees, than a bottle that is being cooled from a starting temperature of 15 degrees to 10 degrees. The difference may be due to the different scenarios having different chamber temperatures (depending on how long the chamber has been cooling) and/or the different scenarios having a different delta between container 12's surface temperature and the liquid temperature within container 12 (the delta may depend on how long container 12 has been cooling in the chamber). Thus, the appliance may use the trend curve that best maps to the temperature change of container 12 given the current temperature, the target temperature, and how long container 12 has been cooling.

As described above, certain embodiments determine the estimated cooling time based on a trend curve that best corresponds to current conditions observed by appliance 62. In certain embodiments, appliance 62 may periodically check the cooling progress, determine whether the cooling progress maps more closely to a different trend curve, and update the remaining estimated cooling time accordingly. In this manner, appliance 62 may provide a more accurate estimate of the remaining cooling time in the event that the actual cooling behavior does not end up matching the original trend curve.

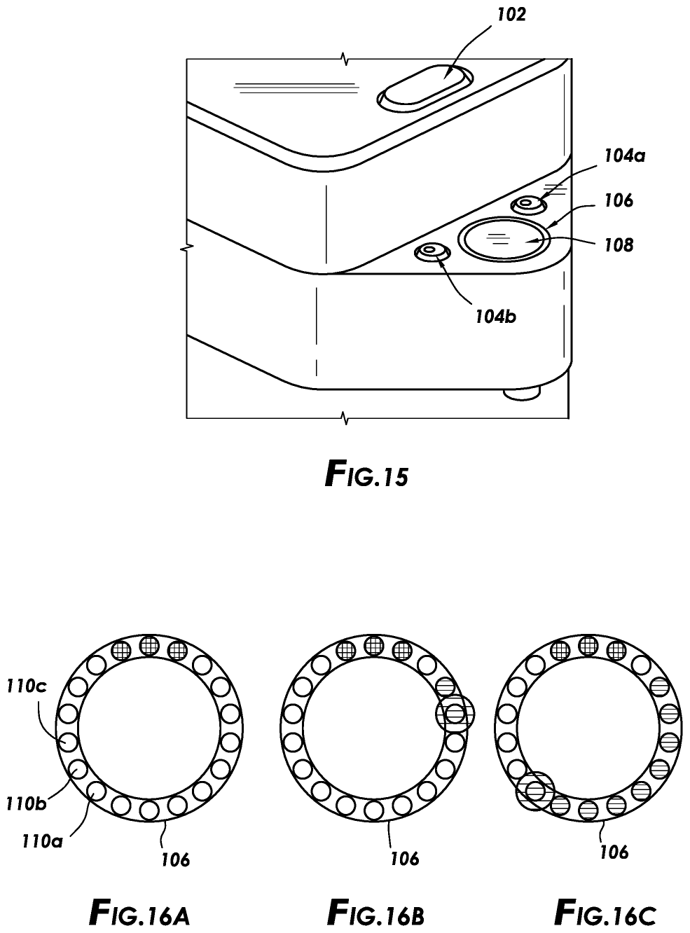

Appliance 62 activates cooling (or heating) in order to progress toward the target temperature. The estimated cooling (or heating) time may be displayed as a progress indicator on appliance 62's user interface (an example using indicator 106 is described below with respect to FIGS. 16A-C) and may be updated as the measurements from the contact sensor indicate progress towards the target temperature. Once appliance 62 has achieved the target temperature, it maintains the target temperature (within a tolerance on either side of the target temperature) by monitoring the measurements from the contact sensor and controlling cooling or heating accordingly. As an example, the tolerance may be plus-or-minus 0.5° C., plus-or-minus 1° C., or other suitable value. Certain embodiments control cooling by turning on cooling when the current temperature is outside of the tolerance of the target temperature and turning off cooling when the current temperature is within the tolerance of the target temperature. Other embodiments may provide more granular cooling settings (such as off, low, medium, and high settings). Similarly, heating may be controlled by on/off heating controls or by more granular heating settings, depending on the embodiment.

Although certain examples above have been described for determining estimated cooling time, analogous method may be used for determining estimated heating time, e.g., in the event that the contact sensor indicates that the current surface temperature of container 12 is cooler than the target temperature.

In certain embodiments, the cooling system may cool container 12 faster than if the user were to place container 12 in a refrigerator. For example, fan 1404 increases circulation of cool air around container 12, which may allow for cooling container 12 from approximately room temperature to approximately 10-15° C. in about an hour. By comparison a typical refrigerator would commonly require several hours to achieve similar cooling.

In certain embodiments, appliance 62 may further include a nozzle sensor 1414. In certain embodiments, nozzles sensor 1414 may comprise a presence sensor that detects whether dispensing conduit 38 is present in a dispensing path of appliance 62. In certain embodiments, appliance 62 may permit liquid to be dispensed from container 12 when nozzle sensor 1414 detects the presence of dispensing conduit 38, and appliance may prevent liquid from being dispensed from container 12 when nozzle sensor 1414 detects the absence of dispensing conduit 38. In certain embodiments, nozzle sensor 1414 may comprise a temperature sensor.

Certain embodiments include other information when determining the estimated cooling time, such as ambient temperature, air chamber temperature (based on information from temperature sensors 1412a and/or 1412b), fullness level of container 12 (because it may take longer to cool a partially-full container 12 than a full container 12 due to insulation properties associated with air in the partially-full container 12), elapsed cooling time, or other suitable information.

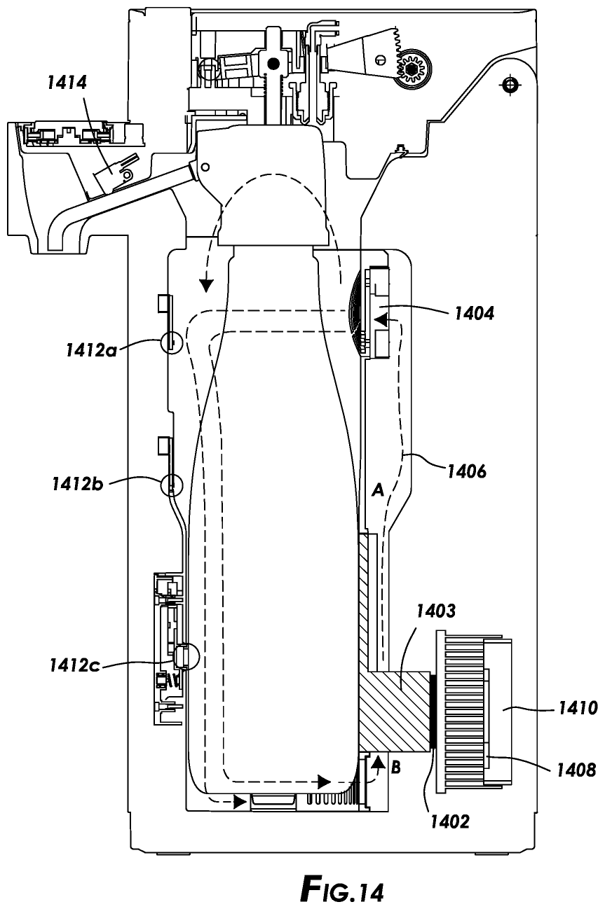

FIG. 15 illustrates example features of appliance 62, in accordance with certain embodiments. The features may include a release button 102, one or more control buttons 104 (e.g., a first control button 104a and a second control button 104b), an indicator 106, and/or a main button 108. Release button 102 may allow a user to open appliance 62 in order to insert or remove container 12. For example, pressing release button 102 may release a lid of appliance 62 such that an inner chamber of appliance 62 adapted to hold container 12 becomes accessible to the user.

A control button 104 may allow the user to dispense contents of container 12. In certain embodiments, appliance 62 comprises a first control button 104a configured to dispense a first amount (e.g., large pour) and a second control button 104b configured to dispense a second amount (e.g., small pour). In certain embodiments, appliance 62 may be initially configured with default values for the first amount and second amount, such as 8 ounces and 4 ounces, respectively. In certain embodiments, the user may replace the default values with preferred values for the first amount and/or the second amount based on the user's preferences. Those preferences could include a default large and small pour size and/or a large and small pour size associated with a particular type of wine (chardonnay) or brand of wine. When dispensing contents of container 12, appliance 62 may determine the amount dispensed based on any suitable information, such as dispense time (e.g., a large pour would have a longer dispense time than a small pour), flow meter measurement, scale measurement, or other suitable method.

In certain embodiments, appliance 62 may support more than one pour speed. For example, a control button 104 may support a fast pour speed and a slow pour speed. First control button 104a may be configured to use the fast pour speed, and second control button 104b may be configured to use the slow pour speed, or vice versa. Alternatively, first control button 104a and second control button 104b may be configured to use the same pour speed (both fast or both slow). In certain embodiments, appliance 62 may be initially configured with default values, such as setting each control button 104 to the slow pour speed. In certain embodiments, the user may replace the default values with preferred values for the pour speed used by the first control button 104a and/or the second control button 104b based on the user's preferences. As an example, some users may prefer a fast pour speed in order to dispense the wine more quickly or to aerate the wine, for example, when drinking a wine with high sulfate or tannin content. Other users may prefer a slow pour speed to avoid introducing air bubbles (aeration) or potential splashing of the wine. For example, certain users may prefer a slow pour speed for carbonated wines so that dispensing the wine does not introduce too much foam, which may result in sensory loss. The user may adjust the pour speed by interacting with the interface of appliance 62 (e.g., buttons, touchscreen with menu options, etc.), by interacting with user device 1902 (e.g., using an app, logging on to an account via a website, etc.), or via any other suitable interface or communication path. Although the preceding example describes two potential pour speeds (fast or slow), there could be more options between a minimum pour speed and a maximum pour speed without departing from the scope of the invention.

When dispensing contents of container 12, appliance 62 may control the pour speed based at least in part on the amount of pressure applied to container 12. In certain embodiments, appliance 62 controls the pressure based on feedback from one or more pressure sensors. In certain embodiments, appliance 62 may determine a recommended pressure for a wine, such as a default pressure setting, based on information obtained from service 1910 and/or saved in storage associated with container 12 (such as using a pressure level field in an RFID tag). Lower pressure may be used for a slower pour, and higher pressure may be used for a faster pour.

In certain embodiments, appliance 62 may associate a pressure setting with a pour speed setting. Thus, if the user changes the pour speed setting, appliance 62 adjusts the pressure setting accordingly higher or lower commensurate with the pour speed setting. If the user requests to increase the pour speed, appliance 62 may determine how much to increase the pressure. Similarly, if the user requests to decrease the pour speed, appliance 62 may determine how much to decrease the pressure. In certain embodiments, the configuration setting options available to the user may correspond to pour speeds suitable for a particular wine. For example, the pour speed options available for a carbonated wine may be selected so that the associated pressure is neither too low nor too high. Otherwise, if the pressure applied by appliance 62 is too low (e.g., below an equilibrium pressure), the carbon dioxide will come out of the wine and the wine will lose carbonation. The equilibrium pressure depends on the temperature; thus, the pressure may be adjusted in response to temperature changes in order to ensure that the pressure does not fall below the equilibrium pressure. If the pressure applied by appliance 62 is too high, the wine may pour too quickly and may introduce too much foam to the carbonated wine. In certain embodiments, the spout used to dispense carbonated wine may be designed to slow the pour speed so that the carbonated wine can be subjected to sufficiently high pressure to maintain carbonation without increasing the pour speed to a level that would introduce too much foam. For non-carbonated wines, higher pressure could be used for faster pour and/or aeration, or lower pressure could be used for slower pour without aeration.

In certain embodiments, appliance 62 may automatically increase pressure when the amount of liquid remaining in container 12 falls below a certain fullness level. Increasing the pressure may help to get more of the liquid out of container 12 when it gets near empty. For example, appliance 62 may use elapsed dispense time to estimate how much liquid remains in container 12 and may increase the pressure when the estimate falls below a threshold. In certain embodiments, the threshold may be configured to increase pressure based on less than 10% of the liquid remaining, less than 5% of the liquid remaining, less than 2% of the liquid remaining, less than 1% of the liquid remaining, or other suitable percentage. In certain embodiments, the threshold may be configured to increase pressure based on less than 200 ml of the liquid remaining, less than 100 ml of the liquid remaining, less than 50 ml of the liquid remaining, or other suitable amount. Other embodiments may use other thresholds.

Indicator 106 may provide a user with information about the contents of container 12. As an example, in an embodiment, appliance 62 is adapted to dispense a beverage from container 12. Indicator 106 may indicate a type of beverage, a temperature associated with appliance 62 (e.g., temperature of an inner chamber of appliance 62, temperature of container 12 held in appliance 62, a temperature of beverage dispensed by appliance 62, etc.), an amount of beverage remaining in container 12, and/or other suitable information, examples of which are further described below with respect to FIGS. 16A-C, 17A-C, and 18A-C.

Main button 108 may facilitate use of appliance 62. In certain embodiments, main button 108 may be a simple button, and the functionality invoked by pressing main button 108 may depend on when and how the user presses main button 108. For example, appliance 62 may interpret a short press, a long press, or a double-press differently, or appliance 62 may interpret pressing a certain portion (such as the left side of main button 108) differently than pressing another portion (such as the right side of main button 108). In other embodiments, main button 108 may display a menu that allows a user to read and select menu options.

In an embodiment, the user may press the main button 108 to cycle indicator 106 through various options. For example, one press of main button 108 may cause indicator 106 to display temperature information, the next press of main button 108 may cause indicator 106 to display fullness information, and so on.

In an embodiment, the user may press main button 108 to cause appliance 62 to save information about the current wine (e.g., label, vintage, etc.) to a list of favorite wines. For example, appliance 62 may communicate feedback to a service 1910 indicating that the user requested to save the wine to a list of favorite wines. The feedback may include a container ID associated with container 12 (e.g., RFID, bar code, QR code, etc., or portion thereof) or an identifier associated with the contents of container 12 (e.g., product identifier determined based on the container ID). Service 1910 may determine information about the wine based on the identifier and may save the information to the list of the user's favorite wines. In certain embodiments, service 1910 may categorize the user's favorite wines, for example, based on type of wine (e.g. red or white), region (e.g., Bordeaux, Burgundy, Piedmont, Calif., Argentina, etc.), variety (e.g., Cabernet Sauvignon, Merlot, Malbec, Chardonnay, Riesling, etc.), price, and/or other factors. Of course, the user might also request to save the wine to a list of wines that the user dislikes.

In an embodiment, the user may press main button 108 to change or store settings of appliance 62, such as preferred temperature, preferred pour size, preferred pour speed, etc.

Although the examples set forth above describe certain functionality for first control button 104a, second control button 104b, and main button 108, any suitable number and/or type of buttons may be used, and functionality may be shared or split among the different buttons in any suitable manner. As an example, in certain embodiments, control buttons 104 may be configured as selection buttons. A user may make a selection using a control button 104 and confirm the selection with the main button 108. Selections may be used to cycle through menu options, change or store settings of appliance 62 (such as preferred temperature, preferred pour size, preferred pour speed, etc.), and so on. Also, in some embodiments, the buttons will be softbuttons on a touchscreen display.

In an embodiment, control buttons 104a and 104b may be used to select pour size. The user presses first control button 104a to select a first pour size and presses main button 108 to proceed with dispensing the first pour size. For example, the main button 108 may be configured to dispense the first pour size when pressed at the same time as the first control button 104a or when pressed within a pre-determined amount of time of pressing the first control button 104a (such as within a few seconds). Similarly, in an embodiment, the user presses second control button 104b to select a second pour size and presses main button 108 to proceed with dispensing the second pour size. For example, the main button 108 may be configured to dispense the second pour size when pressed at the same time as the second control button 104b or when pressed within a pre-determined amount of time of pressing the second control button 104b (such as within a few seconds). If the user presses the main button 108 without pressing one of the control buttons 104 at the same time (or without pressing one of the control buttons 104 within a pre-determined amount of time before pressing main button 108), then main button 108 may be configured to free pour such that liquid is continuously dispensed for as long as the user presses main button 108.

In certain embodiments, control buttons 104 may be configured such that pressing a control button 104 on its own does not cause appliance 62 to dispense any liquid. For example, appliance 62 may be configured to require main button 108 to be pressed (either alone or in combination with control button 104) in order to dispense liquid. In this manner, control buttons 104 may be safely used for programming purposes or reading-out purposes with low risk of the user causing an unintended pouring action.

FIGS. 16A-C, 17A-C, and 18A-C illustrates an example of indicator 106. In the example of FIGS. 16A-C, 17A-C, and 18A-C, indicator 106 comprises a plurality of light emitting diodes (LEDs) 110 arranged in a circle. Indicator 106 may use different patterns to indicate different types of information to the user. Certain embodiments create the patterns by selectively turning certain LEDs 110 on or off, by color-coding LEDs 110, or both. Other embodiments may use other indicators. For example, although FIGS. 16A-C, 17A-C, and 18A-C illustrate indicator 106 as comprising a plurality of LEDs 110, other embodiments may use a different type of indicator (e.g., a different type of light source, a liquid-crystal display (LCD), a touchscreen, etc.). Similarly, although FIGS. 16A-C, 17A-C, and 18A-C illustrate indicator 106 using a circle arrangement, other embodiments may use a different arrangement (e.g., one or more circles, squares, rectangles, triangles, and/or bottle shapes, etc.). Any suitable pattern of illuminating and/or color-coding indicator 106 may be used.

FIGS. 16A-C illustrate an example of using indicator 106 to indicate temperature information. In certain embodiments, the closer the temperature of appliance 62's inner chamber gets to a target temperature, the more LEDs 110 indicator 106 illuminates. The LEDs 110 may be color-coded (e.g., a cool color, like blue, may be represent a cool temperature, and a warm color, like orange, may represent a warm temperature). Appliance 62 may determine temperature in any suitable manner, such as based on information obtained from a temperature sensor (thermometer, thermistor, etc.), or based on an amount of cooling (or heating) time that has elapsed.

In certain embodiments, appliance 62 supports a pre-cooling process. The pre-cooling process cools the inner chamber of appliance 62 before the user places container 12 in appliance 62. For example, the pre-cooling process may be used to prepare appliance 62 to chill a container 12 of wine. By pre-cooling appliance 62, appliance 62 may be ready to cool container 12 when the user places container 12 in appliance 62, which allows for faster cooling of container 12. FIG. 16A illustrates indicator 106 at the beginning of the pre-cooling process. In the example, indicator 106 illuminates three yellow LEDs 110 to indicate that pre-cooling process has been turned on. Indicator 106 turns off the other LEDs 110 to indicate the temperature of appliance 62's inner chamber is not yet cool. As an example, appliance 62 may determine that the inner chamber is not yet cool when the temperature of the inner chamber is at or above a first threshold, such as room temperature, or when the cooling has been turned on for less than a first amount of time.

FIG. 16B illustrates indicator 106 later in the pre-cooling process. In the example, indicator 106 illuminates three yellow LEDs 110 to indicate that pre-cooling process has been turned on and two blue lights to indicate the temperature of appliance 62's inner chamber has cooled to some extent. In the example of FIG. 16B, the most recently illuminated blue LED may be flashing to indicate cooling progress (as depicted by the circle around the applicable LED in FIG. 16B). As an example, appliance 62 may determine that the temperature is somewhat cool when the temperature of the inner chamber is between the first threshold and a second threshold, or when the cooling has been turned on for more than a first amount of time and less than a second amount of time.

FIG. 16C illustrates indicator 106 even later in the pre-cooling process. In the example, indicator 106 illuminates three yellow LEDs 110 to indicate that pre-cooling process has been turned on and nine blue LEDs 110 to indicate further cooling of appliance 62's inner chamber has occurred. As an example, appliance 62 may determine that to illuminate the nine blue LEDs when the temperature of the inner chamber is cooler than the second threshold, or when the cooling has been turned on for more than the second amount of time. In the example of FIG. 16C, the most recently illuminated blue LED may be flashing to indicate cooling progress (as depicted by the circle around the applicable LED in FIG. 16C). Indicator 106 may continue to illuminate additional blue LEDs 110 as the pre-cooling process continues in order to provide the user with a sense of the temperature of the inner chamber and/or time remaining in the pre-cooling process.

In certain embodiments, the user places container 12 in appliance 62 after the pre-cooling process. In certain embodiments, appliance 62 updates indicator 106 to indicate temperature information associated with container 12. This may require turning off certain LEDs 110 because, at the time when the user places container 12 in appliance 62, container 12 may be warmer than the pre-cooling temperature. The closer the temperature of container 12 gets to a target temperature, the more LEDs 110 indicator 106 illuminates.

As discussed above, other embodiments may use other types of indicators 106. Certain embodiments may include a display that provides a numeric representation and/or graphical representation of a current temperature, a target temperature, or both. For example, the display may illustrate temperature numerically in degrees Celsius and/or degrees Fahrenheit or graphically, such as displaying a snowflake, a thermometer, a color-coded design, etc. Appliance 62 may determine the current temperature based on information from one or more temperature sensors, an amount of cooling time that has elapsed, and/or other suitable information. As examples, appliance 62 may determine the target temperature based on default settings, settings that the user inputs via an interface of device 62 (such as using main button 108 or a menu option on a display screen), or based on information indicated by the container ID (e.g., the container ID may indicate the user's temperature preferences or a target temperature that a wine expert recommends for a particular wine).

Certain embodiments may include a display that provides a numeric representation of cooling time. The numeric representation of cooling time may indicate how long container 12 has been cooling, an estimate of how much cooling time remains in order to reach a target temperature, or both.

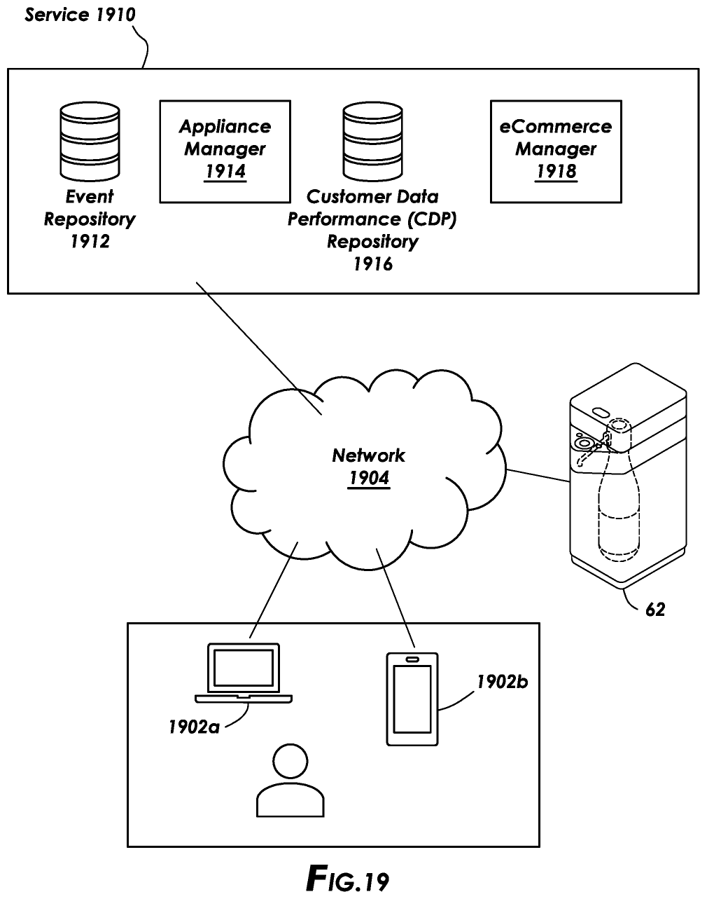

FIGS. 17A-C illustrate using indicator 106 to illustrate a type of contents of container 12. As an example, an appliance 62 configured to dispense wine may illuminate white LEDs 110 to indicate white wine (FIG. 17A), pink LEDs 110 to indicate rosé wine (FIG. 17B), and red LEDs 110 to indicate red wine (FIG. 17C). Certain embodiments may use another color, such as orange, to indicate a problem, for example, in response to determining that the contents of container 12 are out-of-date. In certain embodiments, in response to a user placing a container 12 in appliance 62, appliance 62 illuminates all of the LEDs 110 a particular color (e.g., white, pink, or red) for a relatively short time period (e.g., a time period in the range of 1 second to 1 minute). After that, appliance 62 may illuminate a subset of the LEDs 110 in order to indicate an amount of contents remaining in container 12, as further described with respect to FIGS. 18A-C. The subset of LEDs 110 may continue to be color-coded based on the contents of container 12.

As discussed above, other embodiments may use other types of indicators 106. Certain embodiments may include a display that provides a text representation and/or graphical representation of the type of wine. As an example, certain embodiments may display a text descriptor of the wine, like “red,” “white,” or “rosé.” As another example, certain embodiments may display a graphical descriptor of the wine, such as a graphic depicting a wine bottle or a wine glass, which may be color-coded red, white, or pink. Certain embodiments may display further details, e.g., in text and/or graphical form, such as label, vintage, region, type of grape, and/or other details. As described above, appliance 62 may determine such details based on a container ID, which may be obtained from an RFID, a QR code, a bar code, manual user input, etc.

FIGS. 18A-C illustrate using indicator 106 to illustrate an amount of contents remaining in container 12. In certain embodiments, the amount of contents remaining may be indicated based on lighting a number of LEDs proportional to the amount of contents remaining and/or based on using different colors of LEDs determined according to the amount of contents remaining, such as green for full, yellow for half full, red for a quarter full, and flashing or unilluminated for empty. In the example of FIGS. 18A-C, indicator 106 has been divide into six segments 108 to indicate the remaining volume. As illustrated, each segment comprises two LEDs 110a and 110b, and the six segments 108 are separated by LEDs 110c. In certain embodiments, LEDs 110c remain off for the purposes of FIGS. 18A-C in order to improve visibility of segments 108. In the example, a new, full bottle would illuminate all six segments 108 (FIG. 18A), a two-thirds full bottle would illuminate four of the six segments 108 (FIG. 18B), a half full bottle would illuminate three of the six segments 108 (FIG. 18C), and so on. Certain embodiments may flash the LEDs 110 on and off to indicate when container 12 becomes empty.

As discussed above, other embodiments may use other types of indicators 106. Certain embodiments may include a display that provides a text representation and/or graphical representation of the amount of wine. As an example, certain embodiments may display a text descriptor of the amount of wine, like “full” or “half-full.” As another example, certain embodiments may display a number indicating a percentage or fraction of the contents remaining (e.g., “25%” or “¼” of the contents remain) or the contents consumed (e.g., “75%” or “¾” of the contents have been consumed). As another example, certain embodiments may display a number of servings remaining in the bottle based on a standard pour size, a large pour size, and/or a small pour size. In certain embodiments, the standard pour size may correspond to a serving size (e.g., 5 ounces or other suitable value), the large pour size may correspond to a default setting or user-configured setting (e.g., 7 ounces or other suitable value), and the small pour size may correspond to a default or user-configured setting (e.g., 3 ounces or other suitable value).

As another example, certain embodiments may display a graphical descriptor of the amount of wine, such as a graphic depicting a wine bottle or a wine glass filled with a certain amount of wine (where the amount of wine depicted depends on the fullness of container 12). In certain embodiments, in addition to the wine bottle, wine glass, or other graphic depicting fullness, the same graphic may also depict the type of wine (e.g., using color-coding, such as that described with respect to FIGS. 17A-C).

In addition to providing information associated with the contents of container 12 (e.g., temperature, type of wine, fullness), certain embodiments may use indicator 106 to provide information associated with appliance 62. As an example, indicator 106 may light a certain color and/or pattern of LEDs to indicate whether a lock, such as a child lock, is locked or unlocked. Or, indicator 106 may display text (e.g., “locked” or “unlocked”) or a graphical depiction (e.g., a closed padlock or an open padlock) to indicate the status of a lock. As another example, indicator 106 may be used to indicate configuration settings of appliance 62, such as temperature settings, pour size settings, pour speed settings, etc.

In certain embodiments, the user may interact with appliance 62 to select the type of information indicated by indicator 106. As an example, indicator 106 may be associated with a button (such as main button 108) that the user presses to cycle through the different types of information. In an embodiment, the user may press the button once for indicator 106 to indicate temperature information, twice for indicator 106 to indicate the type of contents of container 12, three times for indicator 106 to indicate an amount of contents remaining in container 12, and four times to cycle back to temperature information. In another embodiment, the user may press and hold the button to cycle through the different types of information.

Certain embodiments of indicator 106 may include a combination of the examples described above. As an example, an embodiment may include a single LED to indicate the type of wine, and may further include one or more displays to indicate temperature and/or fullness in numerical, textual, and/or graphical form. In certain embodiments, appliance 62 may communicate the information indicated by indicator 106, such as the temperature described with respect to FIGS. 16A-C, the wine type described with respect to FIGS. 17A-C, the fullness described with respect to FIGS. 18A-C, a locked or unlocked status of appliance 62, configuration settings of appliance 62, and/or other suitable information via a network for display on a user device, as further described below with respect to FIGS. 19-25.

FIG. 19 illustrates a system that facilitates a user's use of appliance 62. In certain embodiments, the user may interact with a user device 1902 in order to communicate with appliance 62, for example, to configure appliance 62 and/or to obtain information from appliance 62, such as type of beverage, temperature associated with appliance 62, amount of beverage remaining in container 12, etc. In addition, or in the alternative, in certain embodiments, the user may interact with a user device 1902 in order to communicate with a service 1910 that facilitates use of appliance 62, for example, by recommending a type of wine that the user may wish to try and/or facilitating delivery of wine to the user. To facilitate the user device 1902's communication with appliance 62 and/or service 1910, certain embodiments configure the user device 1902 with an application (“app”), such as a phone app, mobile app, web app, or other app. In addition, or in the alternative, certain embodiments facilitate the user device 1902's communication with appliance 62 and/or service 1910 independently of the app. As an example, the user may interact with a web browser of the user device 1902 in order to login to a portal (such as a user account accessed via a website) that facilitates communication with or use of appliance 62 and/or service 1910.

Examples of a user device 1902 may include a smart phone, a mobile phone, a laptop, a tablet, a desktop computer, a personal digital assistant (PDA), etc. In certain embodiments, one or more users may use multiple user devices 1902, such as first user device 1902a and second user device 1902b, to communicate with appliance 62 and/or service 1910. As an example, it might be convenient for the user to use the first user device 1902a, such as the user's laptop, while at home and to use the second user device 1902b, such as the user's smartphone, while away from home, or vice versa.

Certain embodiments use service 1910 to maintain up-to-date information about the status of appliance 62 (e.g., beverage type, temperature, fullness of container 12, etc.) and/or the status of 1910 (e.g., current wine recommendations or offers, order status, delivery status, etc.). Service 1910 provides the up-to-date information to appliance 62, the first user device 1902a, and the second user device 1902b via network 1904 as may be needed. In this manner, when the user makes a change via the first user device 1902a, the change can be viewed (and further changes can be made) via the second user device 1902b. As an example, suppose that appliance 62 is configured with a target temperature of 67° F. The first user device 1902a and the second user device 1902b would both show the target temperature of 67° F. Suppose that the user interacts with the first user device 1902a to change the target temperature to 62° F. Certain embodiments send the new target temperature of 62° F. to service 1910. Service 1910 communicates the new target temperature of 62° F. to appliance 62. Appliance 62 confirms that it has updated the target temperature to 62° F. Service 1910 stores the current target temperature of 62° F. When the user next views the target temperature, whether from the first user device 1902a or the second user device 1902b, the target temperature of 62° F. is obtained from service 1910 (e.g., the user accesses a user account associated with service 1910 via an app or website available on both the first user device 1902a and the second user device 1902b).

In certain embodiments, the first user device 1902a may be associated with a first user and the second user device 1902b may be associated with a second user. As an example, the first user and the second user may be members of the same household, such as a husband and wife that both use appliance 62. Certain embodiments may allow the first user and the second user to be associated with the same user account. The first user may set up a first user profile in the user account, and the second user may set up a second user profile in the user account. Because the first user and the second user are associated with the same user account, they can each receive information about the status of appliance 62 (e.g., beverage type, temperature, fullness of container 12, etc.). Because the first user and the second user created separate user profiles, they can generate separate lists of favorite wines. For example, if the first user prefers red wine, the first user can interact the first user device 1902a to identify favorite red wines to be associated with the first user profile. Service 1910 may then recommend red wines to the first user. If the second user prefers white wine, the second user can interact the second user device 1902b to identify favorite white wines to be associated with the second user profile. Service 1910 may then recommend white wines to the second user. In certain embodiments, appliance 62 may allow a user to provide feedback that identifies the wine currently within appliance 62 as a favorite, for example, by pressing main button 108. In certain embodiments, appliance 62 may include one or more buttons, touchscreen menu options, or other interface that allows the user to configure whether to associate such feedback with the first user profile or the second user profile. In other embodiments, the feedback may simply be associated with a default user profile, such as the first user profile. Certain embodiments may allow the first user and/or the second user to change the default user profile to which feedback obtained from appliance 62 applies. For example, the first user device 1902a and/or the second user device 1902b may display menu options for changing the default user profile to which feedback obtained from appliance 62 applies.

Service 1910 may be implemented using any suitable computing system. As an example, service 1910 may comprise a web site hosted via one or more servers or other suitable hardware. In certain embodiments, components of service 1910 may include one or more repositories (such as event repository 1912 and customer data performance (CDP) repository 1916 shown in FIG. 19 and further described below) and/or one or more services managers (such as appliance manager 1914 and eCommerce manager 1918 shown in FIG. 19 and further described below). A repository may store data used by service 1910. A service manager may perform functionality of one or more aspects of service 1910. Any two or more components of service 1910 may be integrated in the same apparatus, or the components may be distributed among different apparatuses. Components of service 1910 may be associated with one or more entities (e.g., enterprises, businesses, companies, etc.). As an example, appliance manager 1914 may be associated with a first entity, such as a supplier of appliance 62, and eCommerce manager 1918 may be associated with a second entity, such as a sales and marketing company.

The user device, appliance 62, and/or service 1910 may communicate via a network 1904. In certain embodiments, the network may comprise all or a portion of one or more of the following: a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of any of the preceding.

The network 1904 may facilitate communication between the user device 1902 and appliance 62 (e.g., to allow the user to configure appliance 62 or obtain information from appliance 62), between the user device 1902 and service 1910 (e.g., to allow the user to obtain product recommendations from service 1910 or to initiate purchase of product via service 1910), and/or between appliance 62 and service 1910 (e.g., appliance 62 may provide information to service 1910, such as type of wine or amount of wine remaining in container 12, and service 1910 may use the information to make recommendations to the user via the user device).

In certain embodiments, the user may customize appliance 62 by configuring settings of appliance 62 based on the user's preferences. One or more options may be available to configure the settings of appliance 62. One option allows the user to configure the settings by interacting with the user device 1902. For example, the user device 1902 accesses an app or website that allows the user to view and change the settings. The user device 1902 may send appliance 62 the changes that the user makes to the settings and/or the user device 1902 may send service 1910 the changes that the user makes to the settings so that service 1910 can relay the changes to appliance 62. In addition, or in the alternative, appliance 62 may comprise an interface, such as an LCD panel or one or more buttons, that allow the user to change the settings directly on appliance 62.

Examples of settings include temperature preferences, pour size preferences, pour speed settings, lock preferences, and on/off preferences. A setting for a temperature preference may indicate a temperature that the user prefers for wine. Certain embodiments allow the user to configure different temperatures for different types of wine. Suppose the user configures a temperature of 10° C. for white wine and a temperature of 15° C. for red wine. Appliance 62 may determine whether it holds white wine or red wine, for example, based on an identifier associated with container 12, and may chill the wine to the configured temperature for that type of wine. Certain embodiments may allow the user to customize the temperature with further granularity (such as based on a varietal, vintner, vintage, etc.) or based on other factors (such as season, ambient temperature, time of day, etc.).

A setting for a pour size preference may be used to configure a control button 104. The user could configure first control button 104a to dispense a first amount (e.g., 8 ounces) and second control button 104b to dispense a second amount (e.g., 4 ounces). Certain embodiments allow the user to configure different pour sizes for different types of wine. As an example, the user may decide to configure larger pour sizes for a dinner wine and smaller pour sizes for a dessert wine. Certain embodiments enable the user to configure a free pour option for a control button 104. The free pour option dispenses wine for as long as the user presses the control button 104 so that the user can dispense any amount of wine that the user wants.

A setting for a pour speed preference may be used to configure a control button 104. The user could configure each control button 104 to dispense at a fast pour speed or a slow pour speed. Certain embodiments allow the user to configure different pour speeds for different types of wine. As an example, the user may decide to configure a faster pour speed for non-carbonated wine and a slower pour speed for carbonated wine. Certain embodiments enable the user to configure a pour speed for a free pour option.

A setting for a lock preference enables the user to lock or unlock appliance 62. When locked, appliance 62 may be prevented from dispensing the wine. The user may opt to lock the device when not in use, for example, to prevent a child from dispensing wine, and to unlock the device when in use. Locking the device, for example, may cause the pressing of one or more control buttons to have no effect.

A setting for an on/off preference enables the user to schedule when to turn appliance 62 on or off. As an example, the user may schedule appliance 62 to turn on prior to a planned use of appliance 62 (e.g., to pre-cool appliance 62) and to turn off after a planned use of appliance 62 (e.g., to conserve energy).

In certain embodiments, the user interacts with the user device 1902 to communicate with service 1910, which may allow the user to order containers 12, track previous orders, contact customer service, obtain notifications (e.g., push messages with information of interest from service 1910 or members of a community associated with service 1910, etc.).

Service 1910 may provide discovery information to let the user know types of products and promotions available. Service 1910 may allow the user to join a community to share information about products, recommend food and wine pairings, invite others to join the community, etc. Service 1910 may further allow the user to order wine and track the progress of the order, such as when the order has been shipped or delivered. Service 1910 may allow the user to provide feedback whether the user liked a particular wine. The feedback can be used in making recommendations to the user. Service 1910 can recommend wines similar to those that the user liked and avoid recommending wines similar to those that the user did not like. In certain embodiments, service 1910 maintains a user's purchase history and associated feedback so the user can view wines that they have tried and whether the user liked the wine.

In certain embodiments, service 1910 receives information from appliance 62 and uses the information to provide information or recommendations to the user. As an example, the information received from appliance 62 may indicate when container 12 has less than a certain amount of freshness (e.g., when the wine is near or past its freshness date) or has less than a certain amount of wine remaining (e.g., when container 12 is empty or half-empty, etc.). Service 1910 may use this information to determine that the user is almost out of a particular wine and may recommend the same wine and/or a similar wine for the user to purchase. Appliance 62 may provide service 1910 with further details about the user's consumption of the wine so that service 1910 can further customize a recommendation to the user. The information may indicate which user drank the wine, when the user drank the wine (e.g., service 1910 may detect that the user drinks a special wine at a holiday), how frequently the user drinks a particular type of wine or how long it takes the user to finish a bottle of a particular type of wine (which may be an indicator of how much the user likes that type of wine and whether to recommend the same wine or similar wines), how frequently the user changes the type of wine (e.g., which may indicate if the user prefers red wine, white wine, or both). In certain embodiments, service 1910 may provide the user with information about calories consumed based on the consumption information obtained from appliance 62.

In certain embodiments, service 1910 determines one or more products to recommend to a user (such as one or more types of wine to recommend to a user) based on consumption habits associated with the user, buying habits associated with the user, or both. The consumption habits may be determined based on information received from appliance 62, such as information indicating a type of wine consumed by the user and when the user opened a bottle of the wine, dispensed a serving of the wine, switched to a bottle of a different wine, switched back to the bottle of the wine, emptied the bottle of the wine, inserted a new bottle of the same type of wine, etc. The buying habits may be determined based on purchases that the user makes through service 1910. Examples of buying habits may include information about the types of wines the user purchases, when the user purchases wine (which may include information about types and/or quantities of wine purchased), how frequently the user purchases wine (which may include information about types and/or quantities of wine purchased), and so on. Certain embodiments may correlate buying habits and consumption habits, for example, to determine whether the user is running low on wine. Thus, if the user purchased twelve bottles of wine and the user has consumed ten bottles of wine, service 1910 may remind the user to purchase more wine. In summary, based on consumption habits, buying habits, or both, service 1910 recommends wines to purchase.

The recommended wines may be the same or similar to types of wines that the user has purchased and/or consumed and/or provided positive feedback for in the past. Certain embodiments may use machine learning to determine a similar type of wine. For example, machine learning may determine wines with certain shared characteristics, such as red or white, varietal, region, price range, flavour notes (such as fruity, floral, spicy, herb, earthy, mineral, oak, tannin levels, sweetness, dryness, acidity, alcohol content, body, etc.), and so on. In addition, or in the alternative, machine learning may determine similar wines based on information obtained from other users based on consumption habits, purchasing habits, feedback, social media, or other information associated with other users. For example, if the user likes wines a, b, and c, machine learning may determine other users that liked wines a, b, and c, may determine another wine that those other users also tended to like, such as wine d, and may recommend wine d to the user.

In certain embodiments, network 1904 comprises the Internet and a local area network (LAN) associated with the user's premises. Devices associated with the LAN may include appliance 62 and one or more networking devices, such as access points, routers, etc. Appliance 62 may communicate with the Internet via the one or more networking devices. In an embodiment, appliance 62 is configured to send and receive signals to a router associated with the LAN. The router sends and receives signals from a gateway at the edge of the Internet. In certain embodiments, the gateway may comprise an Internet-of-Things hub. The gateway may perform functionality, such as protocol conversion or address changes, to facilitate communication between the LAN and devices on the Internet. Within the LAN, a connection between appliance 62 and the router may be wired or wireless. In an embodiment, the connection between appliance 62 and the router comprises a wireless connection that uses a Wi-Fi protocol (such as a protocol based on an IEEE 802.11 standard), however, other wireless protocols could be used.

Network 1904 may communicate signals between appliance 62 and service 1910. As an example, signals communicated from appliance 62 to service 1910 may include events indicating status information associated with appliance 62. Examples may include events indicating temperature information, pressure information, dispense information (such as an amount of wine dispensed), information indicating the current level of fullness of container 12 (for example, in fraction form, percentage form, number of dispenses remaining, number of ml (or other units) remaining, etc.), information indicating whether appliance 62 is open or closed, information indicating whether a container 12 has been inserted in appliance 12, information identifying a container ID (such as a serial number of the bottle) or associated with a container ID of container 12, information indicating the type of wine in appliance 62 (such as type (color, varietal, region, vintage, etc.), manufacturer, brand name, or other information), information indicating whether a container 12 has been removed from appliance 62, information indicating whether a child-lock is locked or unlocked, current values of configuration settings, and so on. In certain embodiments, appliance 62 sends the events to a repository associated with 1910, such as event repository 1912. Event repository 1912 may comprise any suitable server, database, etc. In an embodiment, event repository 1912 may be implemented using an SQL server. Event repository 1912 may save the events and/or communicate the events to appliance manager 1914, CDP repository 1916, and/or eCommerce manager 1918.

In certain embodiments, appliance 62 communicates one or more events to service 1910 at regular time intervals, such as every 30 seconds, 60 seconds, 90 seconds, 180 seconds, or other suitable time interval. In certain embodiments, appliance 62 communicates one or more events to service 1910 in response to determining a status change, such as a temperature change of at least a pre-determined amount, a pressure change of at least a pre-determined amount, a change in the fullness of the bottle, a change in open/closed status, container insertion or removal, a change in locked/unlocked status, etc. By sending events at regular time intervals and/or in response to determining a status change, service 1910 may be kept up-to-date with respect to the status of appliance 62.

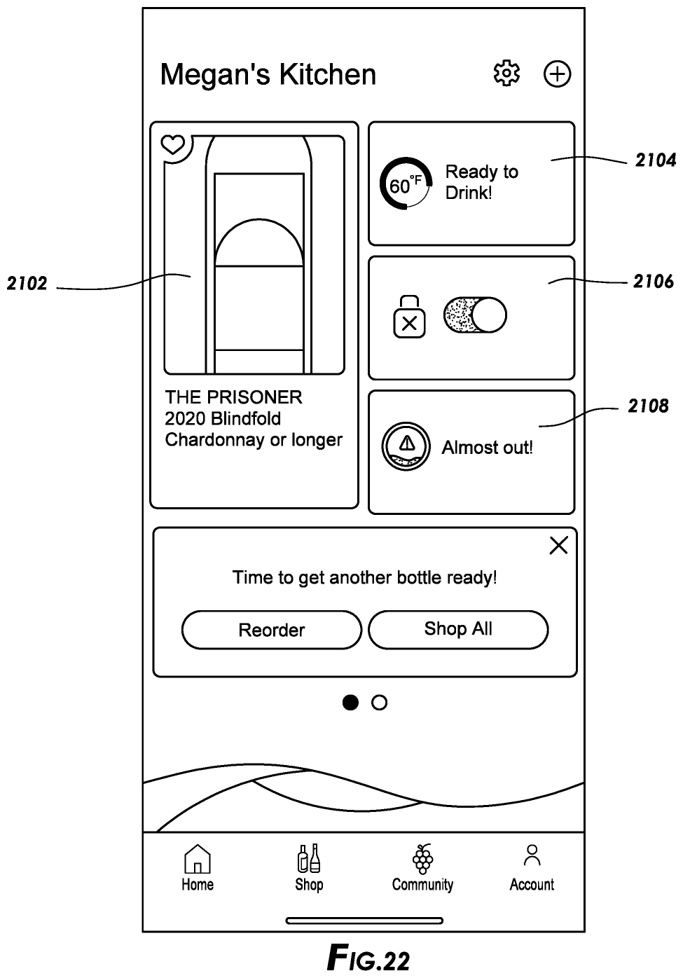

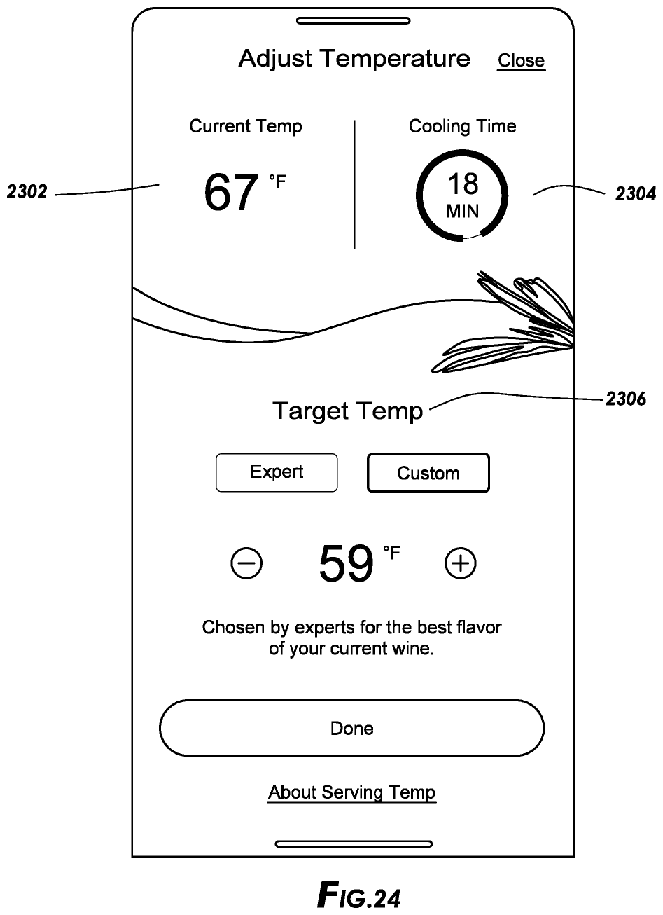

In certain embodiments, event repository 1912 may process events received from appliance 62. Processing the events may include running any suitable algorithms or analytics on the events. For example, event repository 1912 may run an algorithm that predicts cooling time required for appliance 62 to cool the wine to a target temperature. Event repository 1912 may then communicate the cooling time to appliance 62 and/or user device 1902. Appliance 62 may indicate cooling time to the user, for example, using indicator 106 as described with respect to FIGS. 16A-16C. User device 1902 may indicate cooling time to the user, for example, via a graphical user interface, such as the graphical user interface shown in FIG. 21 (e.g., temperature indicator 2104) or FIG. 23 (e.g., cooling time indicator 2304).

Appliance manager 1914 may receive status information and/or configuration settings associated with appliance 62 from event repository 1912. The status information and/or configuration settings may comprise or may be based on the events that event repository 1912 received from appliance 62. Appliance manager 1914 may send status information and/or configuration settings to user device 1902. As an example, the status information may indicate that the bottle is almost empty. Based on that information, the user may opt to order more wine. The status information may include information about the type of the wine in appliance 62. For example, the event that appliance 62 sends event repository 1912 may include a container ID of a container 12 currently inserted in appliance 62, and event repository 1912 or appliance manager 1914 may determine the type of wine based on the container ID. Thus, if the user likes the wine, the user may use that information to order the same type of wine. Appliance manager 1914, eCommerce manager 1918, or another software application may send a query to a user as to whether they would like to order another bottle. That query could be sent (a) every time a bottle reaches a certain threshold of emptiness, (b) only when the bottle reaches a certain threshold of emptiness (which could be completely empty) and the user has less than X bottles of the particular brand of wine in their inventory. That X figure could be configurable by a user. For example, the user might buy 10 bottles of wine at a time and the user could configure the app to prompt them to order more wine when 3 bottles of that type are remaining. The user could also ask not to be prompted to order more wine. Application manager 1914, eCommerce manager 1918, or another software application can keep track of the consumption of wine via the user's appliance 62 and provide an “inventory” to the user of all types of wine that the user has remaining on the premises. Because some bottles could be given to other people as gifts, for example, the user would be able to manually adjust their wine inventory to reflect disposal of a bottle that was never put into the appliance.

With respect to configuration settings, application manager 1914 may provide user device 1902 with information such as target temperature setting, pour size setting, pour speed setting, locked/unlocked setting, and so on. The user may review the settings using user device 1902. If the user decides to change any of the configuration settings, the user may input instructions to change the configuration settings via user device 1902. User device 1902 may send the instructions to application manager 1914. Application manager 1914 may communicate the instructions to appliance 62. Appliance 62 may confirm that the instructions have been received and applied, for example, by communicating an event to event repository 1912 indicating current configuration settings. Event repository 1912 may communicate the current configuration settings to application manager 1914, and application manager 1914 may communicate the current configuration settings to user device 1902 to be displayed to the user.

CDP repository 1916 may store data used to facilitate sales and marketing. In certain embodiments, CDP repository 1916 includes some or all of the events that event repository 1912 receives from appliance 62 and/or information based on the events. As an example, event repository 1912 may store events for a relatively short time, such as one week, two weeks, or one month, in order to support the user's use of appliance 62, such as viewing status information of appliance 62, viewing and/or changing settings of appliance 62, etc. The data stored in event repository 1912 may also be used to troubleshoot any problems associated with appliance 62. CDP repository 1916 may store/archive the data for a relatively longer period of time, such as one year, two years, or unlimited time period, in order to support sales and marketing to the user. For example, CDP repository 1916 may use data collected over a longer term to facilitate determining trends and preferences of the user over time. CDP repository 1916 may include data from other sources, such as marketing resources, sales resources, social media sites, user device 1902, and so on. CDP repository 1916 may provide data to eCommerce manager 1918. The eCommerce manager 1918 may analyse the data, for example, to predict when the user may be ready to purchase more wine and what type of wine the user will want to purchase. The eCommerce manager 1918 may send recommendations, promotions, or other marketing to user device 1902 based on the analysis. The eCommerce manager 1918 may also manage sales, for example, by tracking order status, delivery status, etc. Additionally, in certain embodiments, eCommerce manager 1918 may use trend information or other analytics to facilitate on-trade uses (such as monitoring wine turn-over, stock keeping, inventory planning, etc., for example, to ensure that manufactures supply quantities of inventory that meet the demands of users of service 1910).

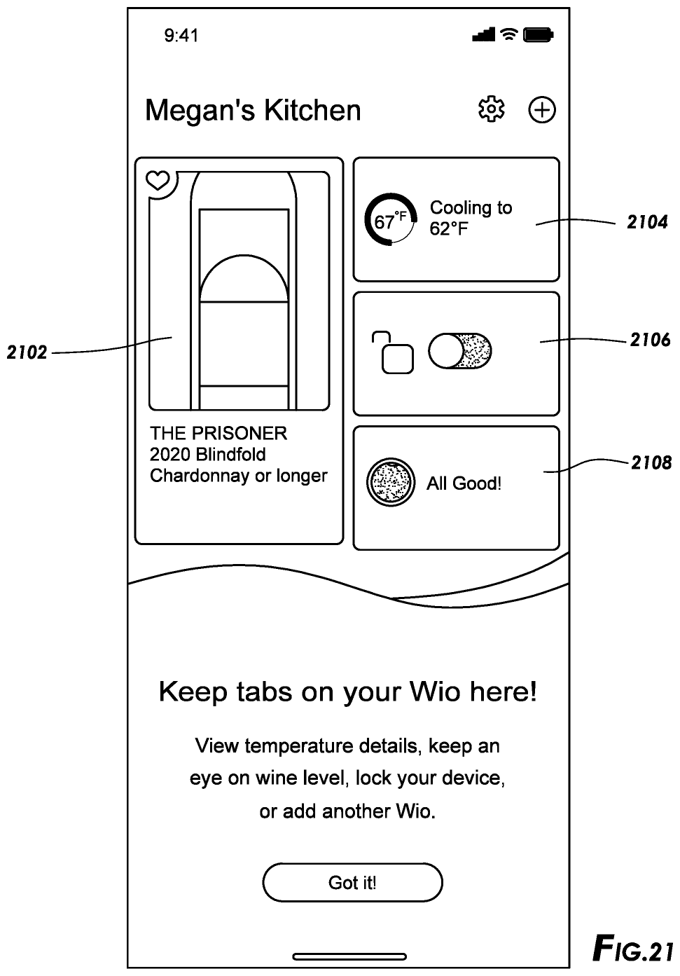

FIG. 20 depicts an example of an apparatus 2000 that may be used, for example, to implement functionality of appliance 62, user device 1902, or service 1910. In this example, the apparatus 2000 includes processing circuitry 2002, one or memories 2003, and one or more interfaces 2005.

The processing circuitry 2002 may include one or more processors, such as one, two, or more processors of the same or different types. Examples of a processor may include a general-purpose processor, an integrated circuit, a server, other programmable logic device, a conventional processor, a microprocessor, a controller, a microcontroller, a state machine, or any combination thereof. Further examples of a processor may include a computer, computing device, user device, and the like.

The memory 2003 is accessible by the processing circuitry 2002 via a link 2004 so that the processing circuitry 2002 can read information from and write information to the memory 2003. In one example, the processing circuitry 2002 processes input received via interface 2005 and stores the result in the memory 2003. In one example, the processing circuitry 2002 processes information from the memory 2003 and communicates the result as output via interface 2005. Memory may be integral with or separate from the processors. Examples of the memory 2003 include RAM, flash, ROM, EPROM, EEPROM, registers, disk storage, or any other form of storage medium. The memory 2003 may store instructions that when executed by the processing circuitry 2002 implement one or more embodiments disclosed herein. Memory 2003 may be a non-transitory computer-readable medium that stores instructions, which when executed by a computer, cause the computer to perform one or more of the methods or functionalities discussed herein.

As one example, in certain embodiments, appliance 62 includes processing circuitry 2002 comprising a microcontroller. Functionality of the microcontroller may include determining and sending events to service 1910. For example, the microcontroller may receive information from sensors associated with appliance 62. Examples of information received from sensors may include temperature information, pressure information, dispense information (such as an amount of wine dispensed), information indicating whether appliance 62 is open or closed, information indicating whether a container 12 has been inserted in appliance 12, information identifying a container ID or associated with a container ID of container 12, information indicating whether a container 12 has been removed from appliance 62, information indicating whether a child-lock is locked or unlocked, and so on. The microcontroller may determine events based at least in part on the information received from the sensors and may send the events to service 1910. Functionality of the microcontroller or other processing circuitry 2002 of appliance 62 may include applying algorithms, user commands, configuration settings, etc., for example, in order to control the pressure and dispense wine according to the temperature, pour size, and/or pour speed preferences of the user.

In certain embodiments, appliance 62 includes one or more interfaces 2005 that support wireless communication, such as a radio frequency (RF) interface or an infrared interface. In certain embodiments, the RF interface is a Wi-Fi interface (e.g., an interface based on an IEEE 802.11 standard). The Wi-Fi interface communicates with an access point or router within wireless communication range of appliance 62. The access point or router facilitates connection to a network 1904, such as the Internet, so that appliance 62 may communicate with service 1910. In addition, or in the alternative, appliance 62 may include other types of RF interfaces, such as a Bluetooth interface or a 3GPP-based interface (e.g., LTE, NR, etc.). In certain embodiments, interface 2005 facilitates direct communication between appliance 62 and a device proximate to appliance 62 (without necessarily having to send the communication via network 1904). As an example, in certain embodiments, appliance 62 may comprise a Bluetooth interface that facilitates peer-to-peer communication with user device 1902 located proximate to appliance 62. As another example, in certain embodiments, appliance 62 may comprise an infrared interface or other interface that facilitates communication with a handheld remote, such as remote used to configure or operate appliance 62.

FIGS. 21-25 depict examples of information presented via a graphical user interface of a user device, such as user device 1902, in accordance with embodiments of the invention. The information presented via the graphical user interface may include information about a wine currently loaded in appliance 62. User device 1902 may obtain such information from appliance 62, for example, as described above with respect to FIG. 19.

FIG. 21 illustrates a graphical user interface that provides the user with information about a wine or other liquid currently loaded in appliance 62. The graphical user interface includes a description 2102, a temperature indicator 2104, a lock indicator 2106, and a fullness level indicator 2108.

In the example of FIG. 21, the description 2102 indicates a type of wine (e.g., chardonnay), a vintage (e.g., 2020), a name (e.g., The Prisoner), and an image of the wine label. Other embodiments may add, remove, or rearrange information describing the wine. Certain embodiments associate user feedback with description 2102. For example, FIG. 21 depicts a feedback button (e.g., heart icon) that the user can select to add the particular wine to a list of the user's favorite wines. Service 1910 may use this feedback when recommending wines to the user. In certain embodiments, user can select or deselect the feedback button to change the status from favorite to neutral. Either option may be configured as the default setting. A default setting of favorite would add the wine to the user's favorite wines unless the user de-selected the feedback button to change the status to neutral. A default setting of neutral would not include the wine on the user's favorite wines unless the user selected the feedback button to change the status to favorite.

In certain embodiments, the user may click on description 2102 to receive more information about the wine. Examples include ratings from different wine rating services and/or other customers, current retail price from one or more distributors, information about the wine from the manufacturer, such as nutritional information, information about the characteristics of the wine (e.g., flavour profile), shelf-life, expiration date, and/or other suitable information.

Temperature indicator 2104 indicates a temperature associated with the wine. In the example, temperature indicator 2104 indicates the current temperature of the wine (e.g., 67° F.) and the target temperature of the wine (e.g., 62° F.).

Lock indicator 2106 indicates whether appliance 62 is locked or unlocked. FIG. 21 illustrates an example where appliance 62 is locked. Lock indicator 2106 may also include a switch that allows the user to lock and unlock appliance 62. A user may opt to lock appliance 62 when not in use, for example, to prevent a child from dispensing wine. The user may opt to unlock appliance 62 when the user wants to dispense wine. In certain embodiments, a lock/unlock feature controls whether appliance 62 can dispense liquid. In certain embodiments, a lock/unlock feature controls whether appliance 62 can be opened, for example, to insert or remove container 12. In certain embodiments, appliance 62 may include multiple types of lock/unlock features, for example, to control both dispensing and opening of appliance 62.

Fullness level indicator 2108 indicates a fullness or amount of contents remaining in container 12. In the example of FIG. 21, fullness level indicator 2108 depicts a circle that that is substantially filled with shading in a first color (e.g., pink), instead of a second color (e.g., white), to indicate that container 12 is full or nearly full.

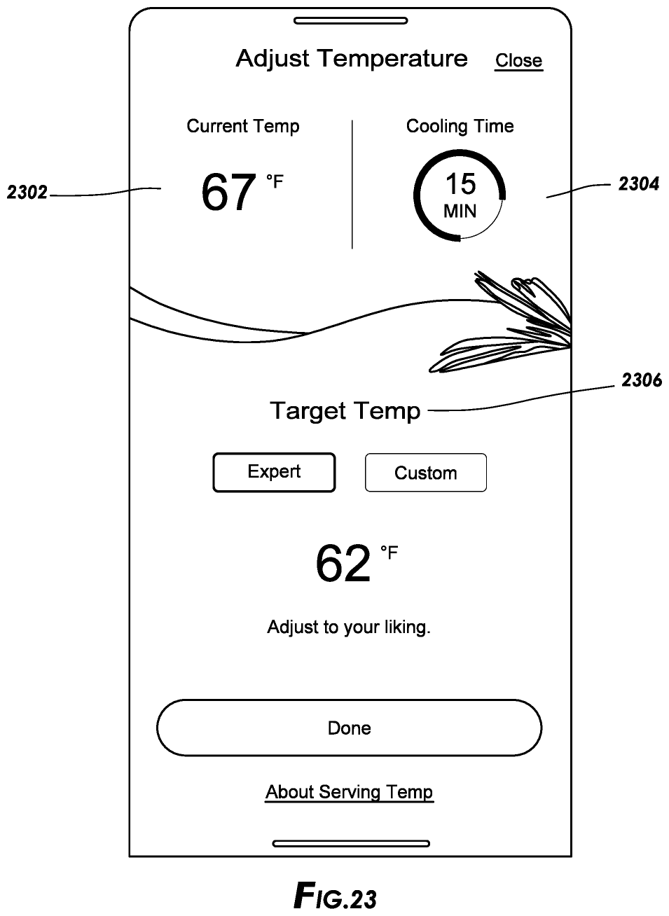

FIG. 22 illustrates a graphical user interface similar to that of FIG. 21. In FIG. 22, the information has been updated based on updated information received from appliance 62 (e.g., via network 1904). Because FIG. 21 and FIG. 22 describe the same bottle of wine, albeit at different points in time, the graphical user interface displays the same description 2102 in both figures.

In FIG. 22, the temperature indicator 2104 indicates a temperature associated with the wine. In the example, temperature indicator 2104 indicates the current temperature of the wine (e.g., 60° F.). In the example, the current temperature corresponds to the target temperature. Thus, temperature indicator 2104 omits the information about the target temperature and how long it will take to reach the target temperature. Instead, temperature indicator 2104 indicates that the wine is ready to drink.

In FIG. 22, lock indicator 2106 indicates that appliance 62 is locked. The user may unlock appliance 62 by sliding the switch on the user interface to the unlocked position. This action will be communicated to the appliance 62 by service 1910 in some embodiments. Appliance 62 would then cause one or more buttons that were previously disabled to now be enabled.

In FIG. 22, fullness level indicator 2108 indicates that container 12 is almost empty. For example, fullness level indicator 2108 depicts a circle in which the shading in the first color (e.g., pink) has been substantially replaced by shading in the second color (e.g., white). Additionally, fullness level indicator 2108 includes a warning sign and text stating that the bottle is almost out of wine. In response to the amount of remaining wine falling below a threshold, the graphical user interface may display an option for the user to reorder the same wine or to shop for other wine.

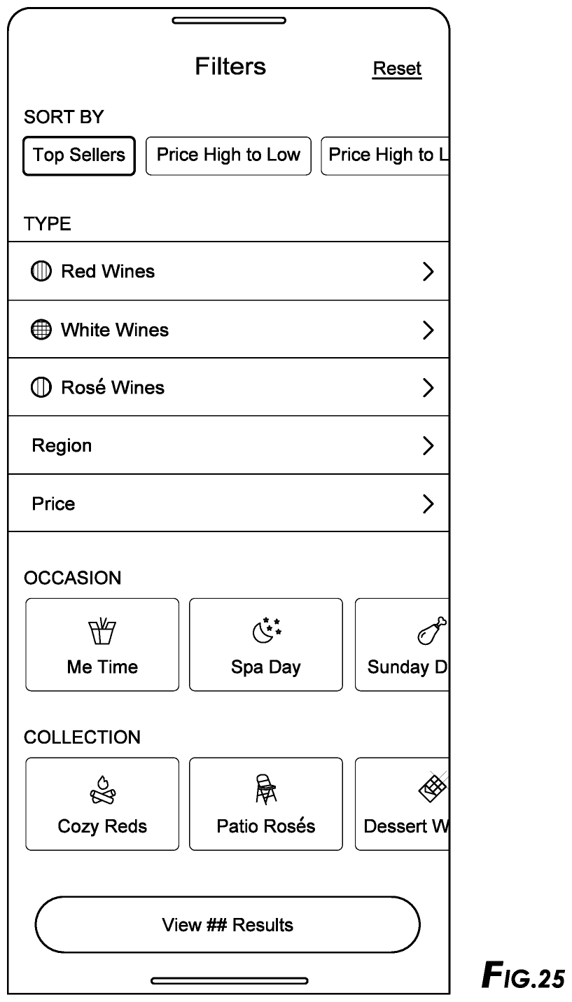

FIGS. 23-24 illustrate examples in which the graphical user interface allows the user to view and modify configuration settings of appliance 62. Settings configured via the graphical user interface may be communicated to appliance 62 via a network, for example, as described with respect to FIG. 19.

In the example of FIGS. 23-24, the user may view and modify temperature settings. FIGS. 23 and 24 include a current temperature indicator 2302, a cooling time indicator 2304, and a target temperature indicator 2306. In both figures, the current temperature indicator 2302 indicates a current temperature of 67° F. In FIG. 23, the target temperature indicator 2306 indicates that the target temperature has been set to 62° F. based on a recommendation from a wine expert. The cooling time indicator 2304 indicates that to get from the current temperature of 67° F. to the target temperature of 62° F. will take 15 minutes. In certain embodiments, the user may decide to override the expert's recommended target temperature based on the user's own preferences. For example, FIG. 24 shows the target temperature indicator 2306 as indicating that the target temperature has been set to 59° F. based on a custom setting selected by the user. The cooling time indicator 2304 is updated based on the new target temperature. In particular, the cooling time indicator 2304 indicates that to get from the current temperature of 67° F. to the new target temperature of 62° F. will take 15 minutes.

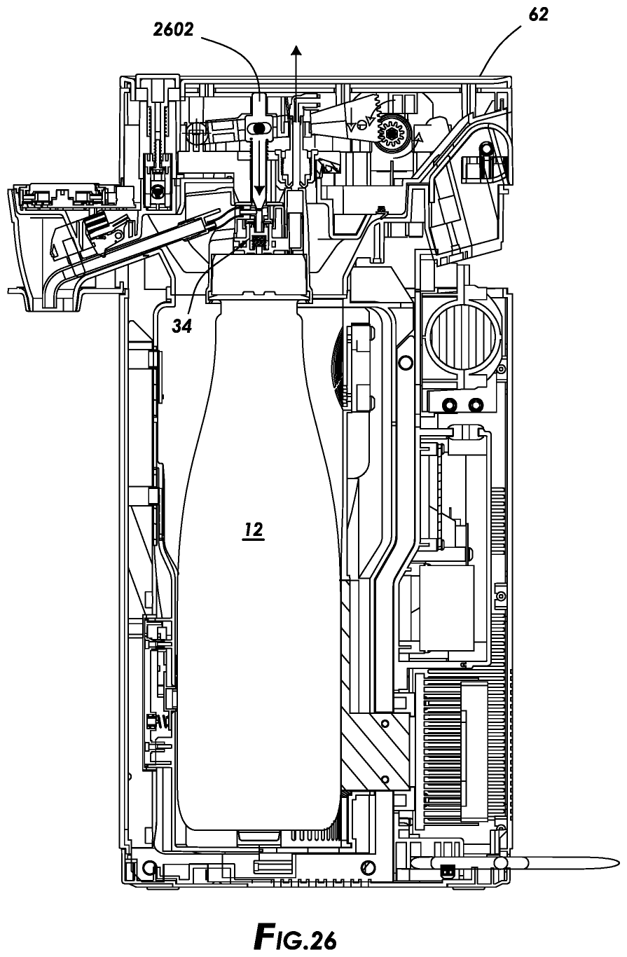

FIG. 25 illustrates an example of a graphical user interface that facilitates shopping for a wine. The graphical user interface includes filters that allow the user to find a wine that meets the user's preferences. Examples of filters include type (e.g., red wine, white wine, rosé wine), region, price, and so on. The user can opt to sort search results by top sellers, customer ratings, price (high to low, or low to high), relevance, or other suitable criteria.

As shown in FIG. 25, certain embodiments group wines based on occasions that may be of interest to the user. Examples of occasions may include a holiday, birthday, anniversary, graduation, or other occasion (e.g., “me time,” “spa day,” “Sunday dinner,” etc.). Occasions can include occasions that are pre-defined by service 1910 and/or occasions that are added by the user. The wines associated with a particular occasion may include recommendations that service 1910 curates based on information from wine experts, information from other customers, and/or information from the user. As an example, if the user has a favorite wine for an anniversary, the user may save that wine so as to be associated with the anniversary. In certain embodiments, the user may save a date associated with the occasion so that service 1910 prompts the user sufficiently in advance of that occasion to order the user's preferred wine for that occasion. In certain embodiments, the user can associate multiple wines with an occasion and/or quantities associated with each wine. For example, if the user hosts an annual event, the user may keep track of the types of wine served at the event and the number of bottles of each type of wine.

As shown in FIG. 25, certain embodiments group wine based on collection, such as “cozy reds,” “patio rosés,” “dessert wines,” etc. Collections can include collections that are pre-defined by service 1910 and/or collections that are added by the user. The wines associated with a particular collection may include recommendations that service 1910 curates based on information from wine experts, information from other customers, and/or information from the user.

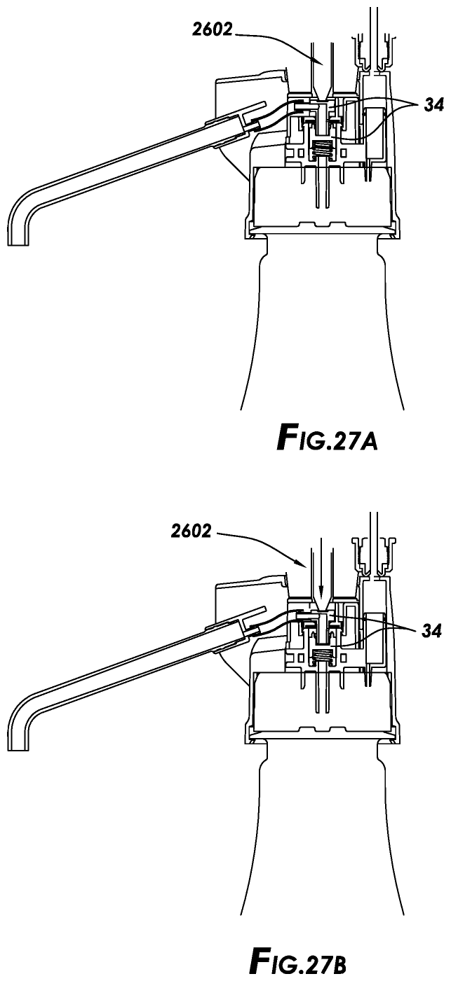

FIG. 26 depicts an example of dispense valve activation, in accordance with embodiments of the invention. In certain embodiments, appliance 62 may include an actuator 2602 that actuates a valve 34 of a connector 10 of container 12 in order to dispense a beverage. FIGS. 27A and B depict examples of valve components when container 12 is loaded in appliance 62 such that actuator 2602 may actuate the valve 34. As described above with respect to FIG. 7, valve 34 may be spring loaded so when no force is applied it is closed, as shown in FIG. 27A, and when force is applied it is open, as shown in FIG. 28B. When activated, actuator 2602 may apply the force to open valve 34.

The following is a numbered list of examples identifying particular combinations of the techniques disclosed above. The present disclosure is not limited to the following combinations as the following combinations are only examples. The techniques and options discussed above can be combined in any suitable manner.

### Examples

1. A connector for dispensing a liquid from a container, the connector comprising:

a main body connectable to the container;

a subassembly being movable relative to the main body between an inactivated position and an activated position,

the subassembly comprising inner and outer hollow piercing members,

wherein, when the main body is connected to the container and the subassembly is moved from the inactivated position to the activated position, the inner hollow piercing member is arranged to pierce a seal of an inner cavity of the container, and the outer piercing member is arranged to pierce a seal of an outer cavity of the container.

2. The connector of example 1 wherein the movement of the subassembly between the inactivated position to the activated position is a linear movement.

3. The connector of example 1 or example 2 wherein the connector comprises a locking mechanism operable to lock the subassembly in the activated position once it has been moved from the inactivated position to the activated position.

4. The connector of example 3 wherein the locking mechanism comprises a latch arrangement; wherein the subassembly comprises one of:

i) a latch receiving portion configured, as the subassembly moves from the inactivated position to the activated position, to receive a latch arm of the main body or container; or

ii) a latch arm configured, as the subassembly moves from the inactivated position to the activated position, to be received in a latch arm receiving portion of the main body or container.

5. The connector of any preceding example wherein the inner hollow piercing member defines a liquid outflow conduit within, suitable for conveying a liquid contained in the inner cavity of the container.

6. The connector of any preceding example wherein the connector further comprises a valve configured to selectively permit or substantially prevent fluid flow between the inner cavity of the container and a dispensing conduit.

7. The connector of example 6, wherein the valve comprises a valve chamber and a valve member movable within the valve chamber, the valve chamber in fluid communication with the inner cavity of the container and the dispensing conduit, and the valve member movable between: i) a closed position in which fluid flow from the inner cavity of the container to the dispensing conduit is substantially prevented, and ii) an open position in which fluid flow from the inner cavity of the container to the dispensing conduit is permitted.

8. The connector of example 7, wherein the movement of the valve member between the closed position and the open position is linear.

9. The connector of any of examples 5 to 8 wherein the valve further comprises an air inlet,

wherein when the valve substantially prevents fluid flow between the inner cavity of the container and the dispensing conduit then the air inlet is open and allowing air into the dispensing conduit, and when the valve permits fluid flow between the inner cavity of the container and the dispensing conduit then the air inlet is blocked and prevents the liquid from entering the air inlet.

10. The connector of example 9 when dependent on example 7 or example 8, wherein the air inlet adjoins the valve chamber, and wherein, when the valve member is in the closed position, the air inlet is open allowing air into the dispensing conduit, and, when the valve member is in the closed position the air inlet is blocked by the valve member preventing liquid from entering the air inlet.

11. The connector of example 7, or examples 8 to 10 when dependent on example 6, wherein the valve member is biased towards the closed position and actuatable to the open position by application of an external force.

12. The connector of example 11 wherein the valve member is actuatable to the open position and the subassembly is movable to the actuated position separately.

13. The connector of any preceding example wherein the main body forms part of a housing that houses the subassembly.

14. The connector of example 13, when dependent on any of examples 5 to 11, wherein the housing houses the valve.

15. The connector of example 5 or any of examples 6 to 14 when dependent directly or indirectly on example 5, wherein the dispensing conduit comprises: i) an inlet adjoining the valve and arranged to receive fluid from the valve; and ii) an outlet,

wherein the dispensing conduit is movable between first and second configurations, a height of the outlet relative to the inlet being greater in the second configuration than the first.

16. The connector of any preceding example wherein the outer hollow piercing member defines a gas inflow conduit within which is suitable for providing gas to the outer cavity of the container.

17. A liquid dispense arrangement for selectively dispensing liquid from a container the arrangement comprising:

i) a liquid outflow conduit configured to receive and convey liquid from the container;

ii) a dispensing conduit configured to dispense liquid from the container to a location outside of the container, the dispensing conduit having an outlet end configured to dispense liquid from the liquid dispense arrangement; and

iii) a valve positioned between the liquid outflow conduit and the dispensing conduit,

wherein the valve comprises a valve chamber, and a valve member movable within the valve chamber, the valve chamber fluidly connected to the liquid outflow conduit and the dispensing conduit, and the valve member movable between: i) a closed position in which fluid flow from the liquid outflow conduit to the dispensing conduit via the valve chamber is substantially prevented, and ii) an open position in which fluid flow from the liquid outflow conduit to the dispensing conduit via the valve chamber is permitted;

the valve further comprising an air inlet adjoining the valve chamber, and wherein, when the valve member is in the closed position, then the air inlet is open allowing air into the dispensing conduit, and, when the valve member is in the open position then the air inlet is blocked by the valve member preventing liquid from entering the air inlet.

18. The liquid dispense arrangement of example 17, further comprising a housing which houses at least a portion of the liquid outflow conduit, at least a portion of the dispensing conduit and the valve.

19. The liquid dispense arrangement of example 17 or example 18, wherein the dispensing conduit comprises a portion located between the valve and the outlet end, said portion, in use, being located at a greater height than the outlet end, such that when the valve member is in the closed position and air is permitted into the dispensing conduit via the air inlet, liquid in the dispense conduit flows out of outlet in response to gravity.

20. The liquid dispense arrangement of example 19, wherein, in use, the outlet is the lowest portion of the dispensing conduit such that, when the valve member is in the closed position and air is permitted into the dispensing conduit via the air inlet, substantially all the liquid in the dispensing conduit flows out of outlet in response to gravity.

21. A kit of parts comprising;

a container having inner and outer cavities, each having a sealed opening;

and a connector according to any of examples 1 to 16, wherein the main body of the connector is connected to the container via the connection portion.

22. A kit of parts comprising;

a container having a liquid containing cavity;

and a liquid dispense arrangement according to any of examples 17 to 20, wherein the liquid dispense arrangement is mounted to the container such that the liquid outflow conduit is placeable in fluid flow communication with a liquid containing cavity of the container.

23. A container assembly comprising:

a container having a liquid containing cavity, the liquid containing cavity containing a beverage; and

a connector according to any of examples 1 to 16, wherein the main body of the connector is connected to the container via the connection portion.

24. A container assembly comprising:

a container having a liquid containing cavity, the liquid containing cavity containing a beverage; and

a liquid dispense arrangement according to any of examples 17 to 20, wherein the liquid dispense arrangement is mounted to the container such that the liquid outflow conduit is placeable in fluid flow communication with the liquid containing cavity of the container.

25. An appliance, the appliance comprising:

a plurality of walls defining a chamber adapted to receive a container assembly; and

an actuator adapted to actuate a valve to selectively permit fluid flow between a liquid containing cavity of the container assembly and a dispensing conduit.

26. The appliance of example 25, wherein the container assembly that the chamber is adapted to receive comprises a container having the liquid containing cavity and a connector according to any of examples 1 to 16.

27. The appliance of example 25, wherein the container assembly that the chamber is adapted to receive comprises a container having the liquid containing cavity and a liquid dispense arrangement according to any of examples 17 to 20.

28. The appliance of example 25, wherein the container assembly that the chamber is adapted to receive comprises a container having the liquid containing cavity, and wherein the valve that the actuator is adapted to actuate is positioned in a neck of the container.

29. The appliance of example 25, wherein the container assembly that the chamber is adapted to receive comprises a connector and a container, the container having the liquid containing cavity, and wherein the valve that the actuator is adapted to actuate is positioned in the connector.

30. The appliance of example 25, wherein the valve that the actuator is adapted to actuate connects to the dispensing conduit.

31. The appliance of example 25, wherein the valve that the actuator is adapted to actuate connects adjacent to an outlet end of the dispensing conduit.

32. The appliance of example 25, wherein the valve that the actuator is adapted to actuate connects adjacent to an end of the dispensing conduit opposite an outlet end of the dispensing conduit.

33. The appliance of any of examples 25-32, wherein the container assembly comprises the dispensing conduit.

34. The appliance of any of examples 25-33, wherein the dispensing conduit comprises a disposable conduit adapted to selectively attach and detach to the container assembly.

35. The appliance of any of examples 25-32, wherein the appliance comprises the dispensing conduit, the dispensing conduit adapted to selectively attach and detach to the container assembly to receive the liquid from the container assembly.

36. An appliance, comprising:

a plurality of walls defining a chamber adapted to receive a container;

a dispenser adapted to dispense contents from the container; and

processing circuitry configured to:

determine information associated with the container; and

communicate the information associated with the container.

37. The appliance of example 36, wherein the information associated with the container is communicated to a user interface of the appliance.

38. The appliance of any of examples 36-37, wherein the information associated with the container is communicated to a user device via a network.

39. The appliance of any of examples 36-38, wherein the information associated with the container is communicated to a service via a network.

40. The appliance of any of examples 36-39, wherein the information associated with the container indicates a type of contents within the container.

41. The appliance of any of examples 36-40, wherein the information associated with the container indicates a fullness level of the container.

42. The appliance of example 41, wherein the processing circuitry is further configured to determine the fullness level of the container based at least in part on an elapsed dispense time associated with the container.

43. The appliance of example 41, wherein the processing circuitry is further configured to determine the fullness level of the container based at least in part on a measurement by a flow meter.

44. The appliance of example 41, wherein the processing circuitry is further configured to determine the fullness level of the container based at least in part on a measurement by a scale.

45. The appliance of any of examples 36-44, wherein the information associated with the container indicates a temperature associated with the container.

46. The appliance of example 45, wherein the processing circuitry is further configured to determine the temperature associated with the container based at least in part on an air temperature measurement obtained by one or more temperature sensors within the chamber.

47. The appliance of any of examples 45-46, wherein the processing circuitry is further configured to determine the temperature associated with the container based at least in part on a surface temperature measurement sensed by a temperature sensor positioned in the chamber and in contact with a surface of the container.

48. The appliance of any of examples 36-47, wherein the information associated with the container indicates an estimated time for a temperature associated with the container to reach a target temperature.

49. The appliance of any of examples 36-48, wherein the appliance further comprises a cooling system and the processing circuitry is further configured to determine an estimated time for the cooling system to cool the container to a target temperature, the estimated time based at least in part on the target temperature and a current temperature sensed by one or more temperature sensors within the chamber.

50. The appliance of any of examples 36-49, wherein the appliance further comprises a cooling system and the processing circuitry is further configured to control the cooling system to provide cooling when a current temperature exceeds a target temperature, the current temperature based on an air temperature within the chamber, a surface temperature of the container, or both.

51. The appliance of any of examples 36-50, the appliance further comprising a ledge adapted to suspend the container within the chamber.

52. The appliance of example 52, wherein the ledge is adapted to extend in response to the container being inserted in the chamber and retract in response to the container being removed from the chamber.

53. The appliance of example 52, wherein the ledge is fixed so as to remain stationary in response to the container being inserted or removed from the chamber.

54. The appliance of any of examples 36-53, wherein the processing circuitry is further configured to communicate events to a service via a network, the events comprising the information associated with the container.

55. The appliance of example 54, wherein the processing circuitry is configured to communicate the events to the service via the network periodically according to a pre-determined time interval.

56. The appliance of any of examples 36-55, wherein the processing circuitry determines at least a portion of the information associated with the container based on obtaining stored information associated with the container.

57. The appliance of example 56, wherein the stored information is associated with an identifier of the container.

58. The appliance of any of examples 56-57, wherein at least a portion of the stored information is obtained from a tag coupled to the container.

59. The appliance of any of examples 56-58, wherein at least a portion of the stored information is obtained from memory of the appliance.

60. The appliance of any of examples 56-59, wherein at least a portion of the stored information is obtained via a network.

61. The appliance of any of examples 56-60, wherein the stored information comprises at least one of: a container identifier; a radio frequency identifier; a closure identifier; a batch fill identifier; a filling date; a product type; a target temperature; a recommended pressure level; a recommended pour size; a product expiry; a staleness date; an open or closed indicator indicating whether the container was previously opened; a volume of liquid remaining in the container; a number of dispenses that have been made; a product type identifier; and/or a recommended shelf-life.

62. The appliance of any of examples 56-61, wherein the processing circuitry is further configured to update the stored information associated with the container.

63. The appliance of example 62, wherein the processing circuitry is further configured to determine that the container has been removed and re-inserted in the appliance and, in response, obtain the updated stored information associated with the container and update the information communicated by the appliance based at least in part on the updated stored information.

64. The appliance of any of examples 36-63, wherein the processing circuitry is further configured to:

determine status information associated with the appliance; and

communicate the status information associated with the appliance.

65. The appliance of example 64, wherein the status information associated with the appliance indicates whether the appliance is locked or unlocked.

66. The appliance of any of examples 36-65, the processing circuitry further configured to:

receive user input indicating one or more configuration settings; and

configure the appliance based on the user input.

67. The appliance of example 66, wherein at least one of the configuration settings indicates a target temperature.

68. The appliance of any of examples 66-67, wherein at least one of the configuration settings indicates a pour size.

69. The appliance of any of examples 66-68, wherein at least one of the configuration settings indicates a pour speed.

70. The appliance of any of examples 66-69, wherein at least one of the configuration settings indicates to lock or unlock the appliance.

71. The appliance of any of examples 66-70, wherein at least one of the configuration settings depends on a type of contents within the container.

72. The appliance of example 71, wherein the at least one of the configuration settings that depends on the type of contents within the container comprises a target temperature, the target temperature set to a first target temperature in response to determining that the container contains red wine and to a second target temperature in response to determining that the container contains white wine.

73. The appliance of any of examples 66-72, wherein at least a portion of the user input is received via a user interface of the appliance.

74. The appliance of any of examples 66-73, wherein at least a portion of the user input is received via a network.

74b. The appliance of any of examples 66-74, wherein the processing circuitry is further configured to:

receive user feedback associated with a type of wine contained in the container, the user feedback received via a user interface of the appliance; and

communicate the user feedback to a service that recommends types of wine to the user, the feedback communicated to the service via a network.

75. A non-transitory computer readable medium comprising instructions that, when executed by processing circuitry of a user device, cause the user device to perform actions comprising:

receiving information associated with a container inserted in an appliance; and

communicating the information associated with the container to a user via a user interface.

76. The non-transitory computer readable medium of example 75, wherein the information associated with the container indicates a type of contents within the container.

77. The non-transitory computer readable medium of example 76, wherein the information associated with the container indicates a type of wine contained in the container, the information about the type of wine comprising one or more of: color, region, varietal, vintage, and/or label.

78. The non-transitory computer readable medium of any of examples 75-77, wherein the information associated with the container indicates a fullness level of the container.

79. The non-transitory computer readable medium of any of examples 75-78, wherein the information associated with the container indicates a current temperature associated with the container.

80. The non-transitory computer readable medium of any of examples 75-79, wherein the information associated with the container indicates a target temperature associated with the container.

81. The non-transitory computer readable medium of any of examples 75-80, wherein the information associated with the container indicates an estimated time for a temperature associated with the container to reach a target temperature.

82. The non-transitory computer readable medium of any of examples 75-81, wherein the information associated with the container indicates a staleness date or an expiration date associated with contents of the container.

83. The non-transitory computer readable medium of any of examples 75-82, wherein the actions further comprise determining status information associated with the appliance and communicating the status information associated with the appliance.

84. The non-transitory computer readable medium of example 83, wherein the status information associated with the appliance indicates whether the appliance is locked or unlocked.

85. The non-transitory computer readable medium of any of examples 75-84, the actions further comprising:

receiving user input indicating one or more configuration settings; and

communicating the configuration settings to the appliance.

86. The non-transitory computer readable medium of example 85, wherein at least one of the configuration settings is communicated to the appliance via a network.

87. The non-transitory computer readable medium of example 85 or 86, wherein at least one of the configuration settings is communicated to the appliance via peer-to-peer communication with the appliance.

88. The non-transitory computer readable medium of any of examples 85-87, wherein at least one of the configuration settings indicates a target temperature.

89. The non-transitory computer readable medium of any of examples 85-88, wherein at least one of the configuration settings indicates a pour size.

90. The non-transitory computer readable medium of any of examples 85-89, wherein at least one of the configuration settings indicates a pour speed.

91. The non-transitory computer readable medium of any of examples 85-90, wherein at least one of the configuration settings indicates to lock or unlock the appliance.

92. The non-transitory computer readable medium of any of examples 85-91, wherein at least one of the configuration settings indicates a type of contents to which the configuration setting applies.

93. The non-transitory computer readable medium of any of examples 85-92, wherein the one or more configuration settings comprise:

a first target temperature configured for red wine; and

a second target temperature configured for white wine.

94. The non-transitory computer readable medium of any of examples 75-93, wherein at least a portion of the information associated with the container is received via a network.

95. The non-transitory computer readable medium of example 94, wherein at least a portion of the information received via the network is received from a service configured to interface between the user device and the appliance, the service communicatively coupled to the user device and the appliance via the network.

96. The non-transitory computer readable medium of any of examples 75-95, wherein at least a portion of the information associated with the container is received via peer-to-peer communication with the appliance.

97. The non-transitory computer readable medium of any of examples 75-95, wherein the actions further comprise:

receiving a recommendation to order wine from a service that determines the recommendation to order wine based at least in part on past use of the appliance, the recommendation received via a network.

98. The non-transitory computer readable medium of example 97, wherein the actions further comprise:

receiving user feedback associated with a type of wine contained in the container, the user feedback received via a user interface of the user device; and

communicating the user feedback to the service via the network;

wherein the recommendation to order wine is based at least in part on the user feedback associated with the type of wine contained in the container.

99. The non-transitory computer readable medium of any of examples 75-98, the actions further comprising:

communicating one or more recommended configuration settings to the user via the user interface.

100. The non-transitory computer readable medium of example 99, wherein at least one of the one or more recommended configuration settings is received from a service via a network.

101. A non-transitory computer readable medium comprising instructions that, when executed by processing circuitry of a service, cause the service to perform actions comprising:

receiving information from an appliance via a network, the information received from the appliance indicating information associated with wine dispensed by the appliance; and

communicating a recommendation to order wine to a user device, the information communicated via the network, the recommendation based at least in part on the information received from the appliance.

102. The non-transitory computer readable medium of example 101, wherein the recommendation to order wine is based at least in part on the information received from the appliance indicating that a container from which the wine is dispensed contains less than a pre-determined amount of wine.

103. The non-transitory computer readable medium of any of examples 101-102, wherein the recommendation to order wine is based at least in part on determining that a number of bottles in a user's inventory has fallen below a threshold.

104. The non-transitory computer readable medium of any of examples 101-103, wherein the recommendation to order wine is based at least in part on determining a user pattern of ordering a certain wine for a recurring event, determining that a next instance of the recurring event will occur within a pre-determined time period, and determining to recommend the certain wine.

105. The non-transitory computer readable medium of example 104, wherein the recurring event is an annual event.

106. The non-transitory computer readable medium of any of examples 101-105, wherein the actions further comprise:

receiving user feedback associated with a type of wine dispensed by the appliance;

wherein the recommendation to order wine is based at least in part on the user feedback associated with the type of wine, the recommendation recommending the same or similar type of wine in response to the user feedback indicating that the user liked the type of wine or a different type of wine in response to the user feedback indicating that the user did not like the type of wine.

107. The non-transitory computer readable medium of example 106, wherein the feedback is received from the user device via the network.

108. The non-transitory computer readable medium of example 106, wherein the feedback is received from the appliance via the network.

109. The non-transitory computer readable medium of any of examples 101-108, wherein the actions comprise using artificial intelligence to determine the recommendation to order wine.

110. The non-transitory computer readable medium of any of examples 101-109, the actions further comprising:

receiving information associated with a container inserted in the appliance, the information received from the appliance via the network; and

communicating the information associated with the container inserted in the appliance to the user device, the information communicated to the user device via the network.

111. The non-transitory computer readable medium of example 110, wherein the information associated with the container indicates a type of contents within the container.

112. The non-transitory computer readable medium of example 111, wherein the information associated with the container indicates a type of wine contained in the container, the information about the type of wine comprising one or more of: color, region, varietal, vintage, and/or label.

113. The non-transitory computer readable medium of any of examples 110-112, wherein the information associated with the container indicates a fullness level of the container.

114. The non-transitory computer readable medium of any of examples 110-113, wherein the information associated with the container indicates a current temperature associated with the container.

115. The non-transitory computer readable medium of any of examples 110-114, wherein the information associated with the container indicates a target temperature associated with the container.

116. The non-transitory computer readable medium of any of examples 110-115, wherein the information associated with the container indicates an estimated time for a temperature associated with the container to reach a target temperature.

117. The non-transitory computer readable medium of any of examples 110-116, wherein the information associated with the container indicates a staleness date or an expiration date associated with contents of the container.

118. The non-transitory computer readable medium of any of examples 110-117, wherein the actions further comprise receiving status information associated with the appliance and communicating the status information associated with the appliance to the user device.

119. The non-transitory computer readable medium of example 118, wherein the status information associated with the appliance indicates whether the appliance is locked or unlocked.

120. The non-transitory computer readable medium of any of examples 110-119, the actions further comprising:

receiving, from the user device, user input indicating one or more configuration settings; and

communicating, to the appliance, instructions to configure the appliance according to the configuration settings received from the user.

121. The non-transitory computer readable medium of example 120, wherein at least one of the configuration settings indicates a target temperature.

122. The non-transitory computer readable medium of any of examples 120-121, wherein at least one of the configuration settings indicates a pour size.

123. The non-transitory computer readable medium of any of examples 120-122, wherein at least one of the configuration settings indicates a pour speed.

124. The non-transitory computer readable medium of any of examples 120-123, wherein at least one of the configuration settings indicates to lock or unlock the appliance.

125. The non-transitory computer readable medium of any of examples 120-124, wherein at least one of the configuration settings indicates a type of contents to which the configuration setting applies.

126. The non-transitory computer readable medium of any of examples 120-125, wherein the one or more configuration settings comprise:

a first target temperature configured for red wine; and

a second target temperature configured for white wine.

127. The non-transitory computer readable medium of any of examples 120-125

receiving, from the appliance, current configuration settings being used by the appliance; and

communicating the current configuration settings to the user device for presentation to the user.

128. The non-transitory computer readable medium of any of examples 101-127, further comprising:

obtaining recommended configuration settings for the appliance, the recommended configuration settings based on recommendations from a manufacturer or expert; and

communicating the recommended configuration settings to the appliance or the user device for presentation to the user.

129. An appliance, comprising:

a plurality of walls defining a chamber adapted to receive a container;

a dispenser adapted to dispense contents from the container; and

a ledge adapted to suspend the container within the chamber.

130. The appliance of example 129, wherein the ledge is adapted to extend in response to the container being inserted in the chamber and retract in response to the container being removed from the chamber.

131. The appliance of example 129, wherein the ledge is fixed so as to remain stationary in response to the container being inserted or removed from the chamber.

For purposes of example and explanation, certain embodiments above have been discussed with reference to wine (including, without limitation, sparkling wine). In other embodiments, container 12 may contain and/or appliance 62 may dispense other types of liquids. Examples of other types of liquids include other beverages, such as beer, carbonated beverages, water, juices, sweetened beverages, fruit juices, etc., or a non-beverage liquid, such as ketchup, mayonnaise, sauce, pudding, lotion, cream, unguent, oil, toothpaste, etc. Thus, the embodiments described above may be modified for other types of liquids. For example, an indicator or display of appliance 62 and/or a graphical user interface of a user device 1902 may depict a temperature, type, fullness level, and/or other information associated with any suitable liquid.

The present invention has been described above purely by way of example. Modifications in detail may be made to the present invention within the scope of the claims as appended hereto. Furthermore, it will be understood that the invention is in no way to be limited to the combination of features shown in the examples described herein. Features disclosed in relation to one example can be combined with features disclosed in relation to a further example.

The invention has been described in relation to the dispensing of beverage. It will be appreciated that the invention may equally be applied to the dispensing of any liquid.

1. A connector for dispensing a liquid from a container, the connector comprising:
a main body connectable to the container;
a subassembly being movable relative to the main body between an inactivated position and an activated position,
the subassembly comprising inner and outer hollow piercing members,
wherein, when the main body is connected to the container and the subassembly is moved from the inactivated position to the activated position, the inner hollow piercing member is arranged to pierce a seal of an inner cavity of the container, and the outer piercing member is arranged to pierce a seal of an outer cavity of the container.

2. The connector of claim 1 wherein the movement of the subassembly between the inactivated position to the activated position is a linear movement.

3. The connector of claim 1 wherein the connector comprises a locking mechanism operable to lock the subassembly in the activated position once it has been moved from the inactivated position to the activated position.

4. The connector of claim 3 wherein the locking mechanism comprises a latch arrangement; wherein the subassembly comprises one of:
i) a latch receiving portion configured, as the subassembly moves from the inactivated position to the activated position, to receive a latch arm of the main body or container; or
ii) a latch arm configured, as the subassembly moves from the inactivated position to the activated position, to be received in a latch arm receiving portion of the main body or container.

5. The connector of claim 1 wherein the inner hollow piercing member defines a liquid outflow conduit within, suitable for conveying a liquid contained in the inner cavity of the container.

6. The connector of claim 1 wherein the connector further comprises a valve configured to selectively permit or substantially prevent fluid flow between the inner cavity of the container and a dispensing conduit.

7. The connector of claim 6, wherein the valve comprises a valve chamber and a valve member movable within the valve chamber, the valve chamber in fluid communication with the inner cavity of the container and the dispensing conduit, and the valve member movable between: i) a closed position in which fluid flow from the inner cavity of the container to the dispensing conduit is substantially prevented, and ii) an open position in which fluid flow from the inner cavity of the container to the dispensing conduit is permitted.

8. The connector of claim 7, wherein the movement of the valve member between the closed position and the open position is linear.

9. The connector of claim 6 wherein the valve further comprises an air inlet,
wherein when the valve substantially prevents fluid flow between the inner cavity of the container and the dispensing conduit then the air inlet is open and allowing air into the dispensing conduit, and when the valve permits fluid flow between the inner cavity of the container and the dispensing conduit then the air inlet is blocked and prevents the liquid from entering the air inlet.

10. The connector of claim 7, wherein the valve further comprises an air inlet,
wherein when the valve substantially prevents fluid flow between the inner cavity of the container and the dispensing conduit then the air inlet is open and allowing air into the dispensing conduit, and when the valve permits fluid flow between the inner cavity of the container and the dispensing conduit then the air inlet is blocked and prevents the liquid from entering the air inlet, and
wherein the air inlet adjoins the valve chamber, and wherein, when the valve member is in the closed position, the air inlet is open allowing air into the dispensing conduit, and, when the valve member is in the closed position the air inlet is blocked by the valve member preventing liquid from entering the air inlet.

11. The connector of claim 7, wherein the valve member is biased towards the closed position and actuatable to the open position by application of an external force.

12. The connector of claim 11 wherein the valve member is actuatable to the open position and the subassembly is movable to the actuated position separately.

13. The connector of claim 1, wherein the main body forms part of a housing that houses the subassembly.

14. The connector of claim 6, wherein the main body forms part of a housing that houses the subassembly and wherein the housing houses the valve.

15. The connector of claim 6, wherein the dispensing conduit comprises: i) an inlet adjoining the valve and arranged to receive fluid from the valve; and ii) an outlet,
wherein the dispensing conduit is movable between first and second configurations, a height of the outlet relative to the inlet being greater in the second configuration than the first.

16. The connector of claim 1, wherein the outer hollow piercing member defines a gas inflow conduit within which is suitable for providing gas to the outer cavity of the container.

17. A liquid dispense arrangement for selectively dispensing liquid from a container the arrangement comprising:
i) a liquid outflow conduit configured to receive and convey liquid from the container;
ii) a dispensing conduit configured to dispense liquid from the container to a location outside of the container, the dispensing conduit having an outlet end configured to dispense liquid from the liquid dispense arrangement; and
iii) a valve positioned between the liquid outflow conduit and the dispensing conduit,
wherein the valve comprises a valve chamber, and a valve member movable within the valve chamber, the valve chamber fluidly connected to the liquid outflow conduit and the dispensing conduit, and the valve member movable between: i) a closed position in which fluid flow from the liquid outflow conduit to the dispensing conduit via the valve chamber is substantially prevented, and ii) an open position in which fluid flow from the liquid outflow conduit to the dispensing conduit via the valve chamber is permitted;
the valve further comprising an air inlet adjoining the valve chamber, and wherein, when the valve member is in the closed position, then the air inlet is open allowing air into the dispensing conduit, and, when the valve member is in the open position then the air inlet is blocked by the valve member preventing liquid from entering the air inlet.

18. The liquid dispense arrangement of claim 17, further comprising a housing which houses at least a portion of the liquid outflow conduit, at least a portion of the dispensing conduit and the valve.

19. The liquid dispense arrangement of claim 17, wherein the dispensing conduit comprises a portion located between the valve and the outlet end, said portion, in use, being located at a greater height than the outlet end, such that when the valve member is in the closed position and air is permitted into the dispensing conduit via the air inlet, liquid in the dispensing conduit flows out of outlet in response to gravity.

20. The liquid dispense arrangement of claim 19, wherein, in use, the outlet is the lowest portion of the dispensing conduit such that, when the valve member is in the closed position and air is permitted into the dispensing conduit via the air inlet, substantially all the liquid in the dispensing conduit flows out of outlet in response to gravity.

21. A kit of parts comprising;
a container having inner and outer cavities, each having a sealed opening; and
a connector, the connector comprising:
a main body connectable to the container; and
a subassembly being movable relative to the main body between an inactivated position and an activated position, the subassembly comprising inner and outer hollow piercing members, wherein, when the main body is connected to the container and the subassembly is moved from the inactivated position to the activated position, the inner hollow piercing member is arranged to pierce a seal of an inner cavity of the container, and the outer piercing member is arranged to pierce a seal of an outer cavity of the container;
wherein the main body of the connector is connected to the container via the connection portion.

22. A kit of parts comprising;
a container having a liquid containing cavity; and
a liquid dispense arrangement, the liquid dispense arrangement comprising:
i) a liquid outflow conduit configured to receive and convey liquid from the container;
ii) a dispensing conduit configured to dispense liquid from the container to a location outside of the container, the dispensing conduit having an outlet end configured to dispense liquid from the liquid dispense arrangement; and
iii) a valve positioned between the liquid outflow conduit and the dispensing conduit,
wherein the valve comprises a valve chamber, and a valve member movable within the valve chamber, the valve chamber fluidly connected to the liquid outflow conduit and the dispensing conduit, and the valve member movable between: i) a closed position in which fluid flow from the liquid outflow conduit to the dispensing conduit via the valve chamber is substantially prevented, and ii) an open position in which fluid flow from the liquid outflow conduit to the dispensing conduit via the valve chamber is permitted;
the valve further comprising an air inlet adjoining the valve chamber, and wherein, when the valve member is in the closed position, then the air inlet is open allowing air into the dispensing conduit, and, when the valve member is in the open position then the air inlet is blocked by the valve member preventing liquid from entering the air inlet;
wherein the liquid dispense arrangement is mounted to the container such that the liquid outflow conduit is placeable in fluid flow communication with a liquid containing cavity of the container.
